(19) United States
(12) Patent Application Publication
(10) Pub. No.: US 2007/0238700 A1
(43) Pub. Date: Oct. 11, 2007

(54) N-PHENYL-1,1,1-TRIFLUOROMETHANESULFONAMIDE HYDRAZONE DERIVATIVE COMPOUNDS AND THEIR USAGE IN CONTROLLING PARASITES

(76) Inventors: Kevin Norman Winzenberg, Camberwell (AU); Adam Gerhard Meyer, Richmond (AU); Qi Yang, Wheelers Hill (AU); Andrew Geoffrey Riches, Richmond (AU)

Correspondence Address: SCHERING-PLOUGH CORPORATION;PATENT DEPARTMENT (K-6-1, 1990), 2000 GALLOPING HILL ROAD, KENILWORTH, NJ, 07033-0530, US

(21) Appl. No.: 11/695,226

(22) Filed: Apr. 2, 2007

Related U.S. Application Data
(60) Provisional application No. 60/790,839, filed on Apr. 10, 2006.

(51) Int. Cl. A01N 43/56; A01N 55/00; A01N 43/00; A01N 43/40

(52) U.S. Cl. 514/63; 514/212.01; 514/317; 514/406; 514/408; 514/602; 540/611; 546/229; 548/577; 548/377.1; 556/422; 564/92

(57) ABSTRACT

Novel N-phenyl-1,1,1-trifluoromethanesulfonamide compounds useful for controlling endo and/or ectoparasites in the environment are provided, together with methods of making the same, and methods of using the inventive compounds to treat parasite infestations in vivo and ex vivo.

### CROSS-REFERENCE TO RELATED APPLICATIONS

This application is a non-provisional application that claims priority under 35 U.S.C. § 119(e) of provisional applications U.S. Ser. No. 60/790,839 filed Apr. 10, 2006, the contents of which are hereby incorporated by reference in its entirety.

### BACKGROUND OF THE INVENTION

1. Field of the Invention

The present invention relates to the new N-phenyl-1,1,1-trifluoromethanesulfonamide hydrazone and nonhydrazone derivatives useful as parasiticides, compositions containing the compounds, and methods of treatment using the compounds, especially to control animal parasites, e.g., ecto- and endoparasites such as fleas, acaridae, helminths, and nematodes. The invention also relates to the use of a combination of a parasiticide of this invention and one or more additional parasiticides or other agents useful in killing parasites.

2. Background

The control of animal parasites is essential, especially in the areas of production and companion animals. Existing methods of treatment are being compromised due to growing resistance to current commercial parasiticides, such as the benzimidazoles and ivermectins. The discovery of more effective ways to control animal parasites is therefore imperative.

N-phenyl-1,1,1-trifluoromethanesulfonamide hydrazone derivatives have been reported in the patent literature.

U.S. Pat. No. 3,639,474 claims compounds selected from 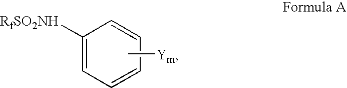
or a metal, ammonium or organic salt thereof,
wherein:

Rf is a perfluoroalkyl group containing one to four carbon atoms, each Y is selected from alkyl, alkanoylamido, halo, haloalkyl, nitro, alkoxy, N-alkylcarbamyloxy, alkanoyl semicarbazone, alkylsulfonyl, alkylsulfinyl, alkylthio, amino, alkylamino, alkylsulfamido, hydroxy, hydroxyalkyl, carboalkoxy, sulfamoyl, dialkylamino, carbamoyl, alkanoyl, haloalkanoyl, haloalkanoylamido, cyano, aldehydro, alkanoyl, oxime, carbamoylmethylamino, haloalkylthio, haloalkylsulfinyl, haloalkylsulfonyl, carboxyalkyl, haloalkoxy, carboalkoxymethylamino, mercapto, alkylsulfonato, haloalkylsulfonato, and carboalkoxyamino and m is 1-5, provided that all of the Y groups together contain not more than about twenty carbon atoms, at feast one of the Y groups contains a heteroatom selected from oxygen, sulfur nitrogen, and halogen, no single Y contains more than six carbon atoms and at least one Y is other than alkyl, halo, haloalkyl and hydroxy. It is disclosed that the compounds of Formula A are useful as herbicides and plant growth regulators.

U.S. Pat. No. 5,340,837 discloses compounds selected from 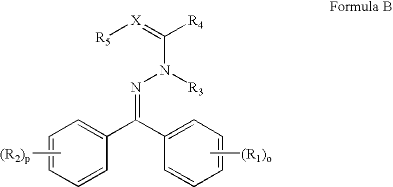
wherein:

each o and p, independently of the other, is 0, 1, 2, 3, 4 or 5, the radicals R₁ being the same or different when o is greater than 1 and the radicals R₂ being the same or different when p is greater than 1;

each of R₁ and R₂, independently of the other, is selected from the group consisting of C₁-C₄alkyl, halo-C₁-C₄alkyl, halogen, —NO₂, —OH, C₁-C₄alkoxy, halo-C₁-C₄alkoxy, C₁-C₄alkylthio, halo-C₁-C₄alkylthio, —O—S(═O)—R₆, —O—S(═O)₂—R₆, phenoxy or —N(R₁₁)SO₂R₁₂ and the two substituents R₁ bonded to vicinal carbon atoms of the phenyl ring and/or two substituents R₂ bonded to vicinal carbon atoms of the phenyl ring are, independently of one another, together —Y-Z-Y—;

R₃ is hydrogen, C₁-C₄alkyl or halo-C₁-C₄alkyl;

R₄ is hydrogen, C₁-C₄alkyl or halo-C₁-C₄alkyl; unsubstituted phenyl or naphthyl or mono- or di-substituted phenyl or naphthyl, the substituents being selected from the group consisting of halogen, C₁-C₄alkyl or halo-C₁-C₄alkyl; C₁-C₄alkoxy, halo-C₁-C₄alkoxy, C₁-C₄alkylthio, halo-C₁-C₄alkylthio, —NO₂ and —CN;

R₅ is —S—R₇, —S(═O)—R₇, —S(═O)₂—R₇, —NO₂, —CN, —C(═O)—R₈ or —C(═O)—OR₈;

R₆ is C₁-C₈alkyl, or halo-C₁-C₈alkyl or phenyl;

R₇ is C₁-C₈alkyl; C₃-C₆cycloalkyl, halo-C₁-C₈alkyl, unsubstituted or mono- or di-substituted phenyl, the substituents being selected from the group consisting of halogen, C₁-C₄alkyl, halo-C₁-C₄alkyl; C₁-C₄alkoxy, halo-C₁-C₄alkoxy, C₁-C₄alkylthio, halo-C₁-C₄alkylthio, —NO₂ and —CN, benzyl or unsubstituted or mono-or di-substituted amino, the substituents being selected from the group consisting of C₁-C₄alkyl, halo-C₁-C₄alkyl and phenyl;

R₈ is C₁-C₈alkyl, halo-C₁-C₈alkyl, unsubstituted or mono- or di-substituted phenyl, the substituents being selected from the group consisting of halogen, C₁-C₄alkyl, halo-C₁-C₄alkyl; C₁-C₄alkoxy, halo-C₁-C₄alkoxy, C₁-C₄alkylthio, halo-C₁-C₄alkylthio, —NO₂ and —CN;

X is N; each Y, independently of the other, is O or S;

Z is methylene, eth-1,2-ylene, halomethylene or haloeth-1,2-ylene;

R₁₁ is hydrogen, C₁-C₄alkyl or halo-C₁-C₄alkyl; and

R₁₂ is C₁-C₄alkyl, halo-C₁-C₄alkyl, unsubstituted or mono- or di-substituted phenyl, the substituents being selected from the group consisting of halogen, C₁-C₄alkyl, halo-C₁-C₄alkyl; C₁-C₄alkoxy, halo-C₁-C₄alkoxy, C₁-C₄alkylthio, halo-C₁-C₄alkylthio, —NO₂ and —CN;

or, where appropriate, a tautomer thereof, or a salt thereof or a salt of a tautomer;

with the proviso (A) that, in compounds of Formula B in free form wherein each of o and p is O, R₄ is hydrogen and X is N, R₃ is other than hydrogen when R₅ is methanesulfonyl, unsubstituted phenylsulfonyl or 4-methylphenylsulfonyl. These compounds are useful for the control of insects.

JP 6,345,743 claims compounds selected from 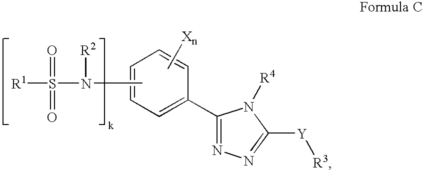
wherein:

R¹=alkyl, halo alkyl, mono or di lower allyl amino, phenyl, benzyl, furyl or thienyl;

R²═H, R¹SO₂, lower alkyl, lower alkoxy lower alkyl, lower alkylthio, lower alkyl, lower alkylsulfonyl lower alkyl, lower alkenyl or lower alkynyl;

k=1 or 2;

R³═H, lower alkyl, lower halo alkyl, lower alkoxy lower alkyl, lower alkylthio lower alkyl, lower alkylsulfonyl lower alkyl, cyano lower alkyl, lower alkenyl, lower halo, alkenyl, lower alkynyl, phenyl, benzyl, aliphatic acyl or lower alkylsulfonyl;

Y═O or S(O)ₘ;

m=0-2;

R⁴═H, lower alkyl, lower halo alkyl, cycloalkyl or lower alkoxy lower alkyl;

X=halogen lower alkyl, lower alkoxy lower alkyl, lower alkoxy, lower halo, alkoxy, lower alkylthio, lower halo alkylthio, lower alkylsulfonyl, CN, or NO₂;

n=0-3.

X is halo, lower alkyl. The compounds of Formula C are claimed as herbicides.

JP 11,060,562 claims compounds selected from 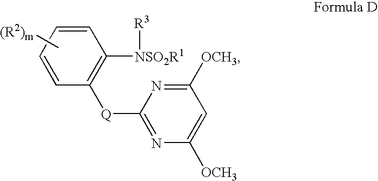
wherein:

R¹ is (optionally) halo or CN substituted alkyl or (optionally) halo substituted alkenyl;

R² is either hydrogen, halo, (optionally) substituted alkoxy or (optionally) substituted alkyl;

R³ is either, hydrogen, (optionally) substituted alkyl, benzyl, acyl, alkoxycarbonyl, (optionally) substituted carbamoyl, (optionally) substituted thiocarbamoyl or —SO₂R¹;

Q is either —CH(NR⁴R⁵) or C(═NR⁶) [R⁴, R⁵ and R⁶ is either hydrogen, (optionally) substituted alkyl, alkenyl, alkynyl, cycloalkyl, (optionally) substituted phenyl, acyl, alkoxycarbonyl, (optionally) substituted carbamoyl, (optionally) substituted thiocarbamoyl, —SO₂R¹, NR⁷R⁸, or —OR⁹. R⁴ and R⁵, connected through a nitrogen atom, may form a nitrogen-containing heterocyclic group which possesses one or more heteroatoms]; and m is 1 to 4. These compounds have been said to show herbicidal activity.

JP 11,180,964 claims compounds selected from 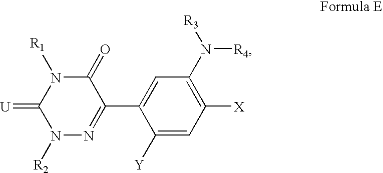
wherein:

R₁ and R₂═H, 1-4C alkyl, 2-4C alkenyl, 2-4C alkynyl or 1-4C haloalkyl;

U═O or S;

X=halogen or cyano;

Y═H, or halo;

R₃ and R₄═H, 1-6C alkyl, 2-6C alkenyl, 2-6C alkynyl, 3-6C cycloalkyl, 1-6C haloalkyl, 2-6C haloalkenyl, 2-6C haloalkynyl 2-6C alkoxyalkyl, 2-5C cyanoalkyl, 1-3C alkyl with phenyl as a substituent, 1-3C alkyl with 3-6 membered hetero ring (containing 1-2 O, S and/or N atoms) as a substituent, 2-7C alkylcarbonyl, 2-7C alkenylcarbonyl, 4-7C cycloalkylcarbonyl, 2-7C haloalkylcarbonyl, 2-7C alkoxycarbonyl, 2-7C alkenyloxycarbonyl, 4-7C cycloalkoxycarbonyl, 2-7C haloalkoxycarbonyl, 1-6C alkylsulfonyl, 2-6C alkenylsulfonyl, 3-6C cycloalkylsulfonyl, 1-6C haloalkylsulfonyl or —CH(R₈)—CO-A-R₉; A=O, S or —N(R₁₀)—, R₁₀═H or 14C alkyl); R₈═H or 14C alkyl; R₉═H, 1-6C alkyl, 2-6C alkenyl, 2-6C alkynyl, 3-6C cycloalkyl, 1-6C haloalkyl, 2-6C alkoxyalkyl, 2-5C cyanoalkyl, 3-7C acyloxyalkyl, 3-8C alkoxycarbonylalkyl, phenyl, 1-3C alkyl with phenyl as a substituent, 3-6 membered hetero ring (with 1-2 O, S and/or N atoms), or 1-3C alkyl with a 3-6 membered hetero ring (with 1-2 O, S and/or N atoms) as a substituent; when A=—N(R₁₀)—, then R₉ and R₁₀ can form a 5-6 membered hetero ring (containing 1-2 N atoms and 0-1 O atoms); and R₆, R₇═H, 1-6C alkyl, 2-6C alkenyl, 2-6C alkynyl, 3-6C cycloalkyl, 1-6C haloalkyl, phenyl, 1-3C alkyl with phenyl as a substituent, 3-6 membered hetero ring (with 1-2 O, S and/or N atoms), or 1-3C alkyl with a 3-6 membered hetero ring (with 1-2 O, S and/or N atoms), 2-7C alkoxycarbonyl, 2-7C alkenyloxycarbonyl, 1-7C cycloalkoxycarbonyl or 2-7C haloalkoxycarbonyl; R₆+R₇=3-7C membered ring; when R₃—R₇ and R₉=phenyl, then 1-3C alkyl (with phenyl as substituent), 3-6 membered hetero ring (containing 1-2 O, S and/or N atoms), or 1-3C alkyl with 3-6 membered hetero ring as a substituent, the phenyl group and the hetero ring group can contain 1-3 halo, 1-4C alkyl, trifluoromethyl, 1-4C alkoxy, 2-5C acyloxy, 1-4C alkylthio, 1-4C alkylsulfonyl, nitro, cyano or 2-5C alkoxycarbonyl as substituents. The compounds of Formula E are disclosed as herbicides.

U.S. Pat. No. 5,281,571 claims compounds selected from 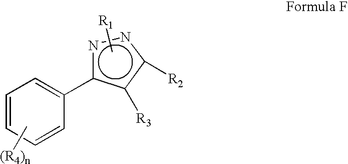
wherein R₁ is independently C₁₋₈ alkyl; C₃₋₈ cycloalkyl, cycloalkenyl, cycloalkylalkyl, or cycloalkenylalkyl; C₂₋₈ alkenyl or alkynyl; benzyl; wherein the above members may be optionally substituted with halogen, amino, nitro, cyano, hydroxy, alkoxy, alkylthio, 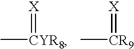
YR₁₀, or NR₁₁R₁₂;
R₂ is C₁₋₅ haloalkyl;
R₃ is halogen;
R₄ is hydrogen or an R₁ member, thioalkyl, alkoxyalkyl or polyalkoxyalkyl, carbamyl, halogen, amino, nitro, cyano, hydroxy, C₁₋₁₀ heterocyle containing 1-4 O, S(O)ₘ and/or NR₁₈ heteroatoms, C₆₋₁₂ aryl, aralkyl or alkaryl, 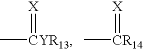
YR₁₅ or NR₁₆R₁₇;
X is O, S(O)ₘ, NR₁₉ or CR₂₀R₂₁;
Y is O, S(O)ₘ or NR₂₂;
R₈₋₂₂ are hydrogen or one of the R₄ members;
m is 0-2 and
n is 1-5.
Compounds of Formula F are herbicides.

US 2004/0138255A1 discloses the compound, 2,5-bis(4-trifluoromethylsulfonylaminophenyl)-1,3,4-oxadiazole which is claimed to be useful as a phosphate mimic that modulates the activity of protein tyrosine enzymes.

FR 1,579,473 discloses the compound 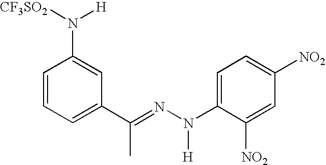
which is claimed to have antimicrobial, antiinflammatory, and plant growth regulatory activity.

In the general area of insecticidal and acaricidal control, Japanese Laid-open Patent 57-156407A discloses compounds selected from 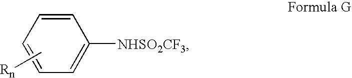
wherein;

R is selected from alkyl, alkoxyalkyl, haloalkyl, haloalkoxy, alkylcarbonyl, alkoxycarbonyl or halo; and

n is 1 to 5.

A pesticidal composition which comprises the ester 2-methoxycarbonyl-4-chlorotrifluoromethanesulfonanilide (Formula H) as an active ingredient is disclosed in U.S. Pat. No. 6,177,465 and U.S. Pat. No. 6,333,022. Examples of the pests controlled by the composition include insects and Acarina such as indoor mites, fleas, cockroaches and so on. The composition is said to be very effective for controlling house dust mites.

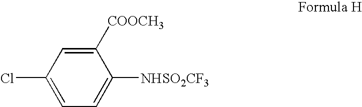

In spite of the foregoing, there remains a longstanding need in the art to provide improved compounds and methods for controlling insects and Acarina.

The citation of any reference herein should not be construed as an admission that such reference is available as “prior art” to the instant application.

### SUMMARY OF THE INVENTION

Accordingly, the present invention provides N-phenyl-1,1,1-trifluoromethanesulfonamide derivatives, both hydrazone and nonhydrazone, that are effective anti-parasite agents.

In one embodiment, the invention provides N-phenyl-1,1,1-trifluoromethanesulfonamide compounds selected from the group consisting of 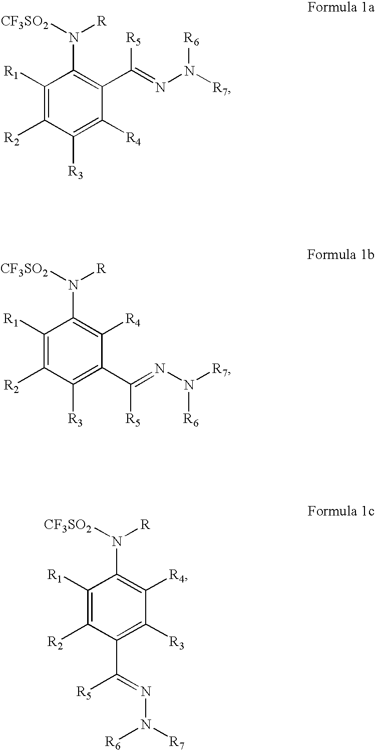
and combinations thereof, or a pharmaceutically acceptable salt thereof or a solvate thereof, wherein,

R for Formulas 1a, 1b and 1c is independently selected from the group including hydrogen, alkyl, alkenyl, alkynyl, arylalkyl, cycloalkylalkyl, heterocyclylalkyl, heteroarylalkyl, hydroxyalkyl, alkoxyalkyl, aryloxyalkyl, cyanoalkyl, alkylcarbonylalkyl, cycloalkylcarbonylalkyl, arylcarbonylalkyl, heterocyclylcarbonylalkyl, heteroarylcarbonylalkyl, alkoxycarbonylalkyl, alkylaminocarbonylalkyl, trialkylsilylalkyl, trialkoxysilylalkyl, dialkoxyphosphonatoalkyl, heterocyclyloxyalkyl, heteroaryloxyalkyl, alkylcarbonyloxyalkyl, arylcarbonyloxyalkyl, heterocyclylcarbonyloxyalkyl, heteroa rylcarbonyloxyalkyl, alkoxycarbonyloxyalkyl, aryloxycarbonyloxyalkyl, heterocyclyloxycarbonyloxyalkyl, heteroaryloxycarbonyloxyalkyl, alkylaminocarbonyloxyalkyl, arylaminocarbonyloxyalkyl, heterocyclylaminocarbonyloxyalkyl, heteroarylaminocarbonyloxyalkyl, alkylcarbonylaminoalkyl, arylcarbonylaminoalkyl, heterocyclycarbonylaminoalkyl, heteroarylcarbonylaminoalkyl, alkylsulfonylalkyl, arylsulfonylalkyl, heterocyclylsulfonylalkyl, heteroarylsulfonylalkyl, alkanoyl, aroyl, heterocycloyl, heteroaroyl, alkoxycarbonyl, aryloxycarbonyl, heterocyclyloxycarbonyl, heteroaryloxycarbonyl, N-alkyl carbamoyl, N-aryl carbamoyl, N-heterocyclyl carbamoyl, N-heteroaryl carbamoyl, N-alkyl thiocarbamoyl, N-aryl thiocarbamoyl, N-heterocyclyl thiocarbamoyl, N-heteroaryl thiocarbamoyl, alkylsulfonyl, arylsulfonyl, heterocyclylsulfonyl and heteroarylsulfonyl; and wherein,

R₁-R₄ are independently selected from hydrogen, cyano, nitro, halo and the following optionally substituted moieties: alkyl, cycloalkyl, aryl, heterocyclyl, heteroaryl, alkoxy, cycloalkoxy, aryloxy, heteroaryloxy, heterocyclyloxy, haloalkyl, haloalkoxy; and wherein,

R₅ is selected from hydrogen, halogen, cyano and the following optionally substituted moieties: alkyl, n-alkenyl, alkynyl, cycloalkyl, cycloalkenyl, cycloalkylalkyl, cycloalkenylalkyl, aryl, heteroaryl, arylalkyl, heterocyclyl, haloalkyl, haloalkenyl and haloalkynyl, and optionally excluding compounds of Formula B and Formula D, as set forth above, and also optionally providing that, when the compound is according to Formula 1a, the heteroaryl substituent is not 4,6-dimethoxypyrimidin-2-yl, and wherein,

R₆ and R₇ are independently selected from hydrogen and the following optionally substituted moieties: alkyl, q-alkenyl (wherein q is an integer greater than one, or an integer ranging from 2 to about 25, or preferably from 2 to about 10), alkynyl, cycloalkyl, cycloalkenyl, cycloalkylalkyl, cycloalkenylalkyl, aryl, arylalkyl, arylalkenyl, heterocyclyl, heterocyclylalkyl, heteroaryl, heteroarylalkyl, heteroarylalkenyl, alkanoyl, aroyl, heterocycloyl, heteroaroyl, cyanoalkyl, alkoxyalkyl, cycloalkoxyalkyl, aryloxyalkyl, alkylthioalkyl, cycloalkylthioalkyl, arylthioalkyl, alkylsulfinylalkyl, cycloalkylsulfinylalkyl, arylsulfinylalkyl, alkylsulfonylalkyl, cycloalkylsulfonylalkyl, arylsulfonylalkyl, haloalkyl, haloalkenyl, haloalkynyl, alkanoyl, aroyl, heterocycloyl, heteroaroyl, alkoxycarbonyl, aryloxycarbonyl, heterocyclyloxycarbonyl, heteroaryloxycarbonyl, N-alkyl carbamoyl, N-aryl carbamoyl, N-heterocyclyl carbamoyl, N-heteroaryl carbamoyl, N-alkyl thiocarbamoyl, N-aryl thiocarbamoyl, N-heterocyclyl thiocarbamoyl, N-heteroaryl thiocarbamoyl, alkylsulfonyl, arylsulfonyl, heterocyclylsulfonyl and heteroarylsulfonyl.

A preferred aspect of this embodiment of the invention provides a N-phenyl-1,1,1-trifluoromethanesulfonamide compound of Formula 1a wherein, R is selected from the group including hydrogen and the following optionally substituted moieties: alkyl, alkenyl, alkynyl, arylalkyl, cycloalkylalkyl, heterocyclylalkyl, heteroarylalkyl, hydroxyalkyl, alkoxyalkyl, aryloxyalkyl, cyanoalkyl, alkylcarbonylalkyl, cycloalkylcarbonylalkyl, arylcarbonylalkyl, heterocyclylcarbonylalkyl, heteroarylcarbonylalkyl, alkoxycarbonylalkyl;

R₁, R₂ and R₄ are hydrogen;

R₃ is chlorine or hydrogen;

R₅ is methyl;

R₆ is alkyl,

R₇ is

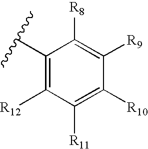

wherein R₈-R₁₂ are independently selected from the following: hydrogen, cyano, halo and the following optionally substituted moieties: alkyl, cycloalkyl, aryl, heterocyclyl, heteroaryl, alkoxy, cycloalkoxy, aryloxy, heteroaryloxy, heterocyclyloxy, haloalkyl, haloalkoxy.

In a second embodiment, the invention provides for a N-phenyl-1,1,1-trifluoromethanesulfonamide hydrazone compound of Formula 1a, Formula 1b and Formula 1c wherein R₅ and R₆ together are part of the same fused heterocyclic or heteroaryl ring, that is substituted or unsubstituted, with the proviso that the heterocyclic or heteroaryl ring is not any of the following substituents: a heterocyclic or heteroaryl substituent including 4H-1,2,4-triazol-2-yl, 3,5(2H,4H)-dioxo-1,2,4-triazin-6-yl, 5(4H-oxo-3(2H-thioxo-1,2,4-triazin-6-yl, 4-halo-1H-pyrazol-3-yl and 4-halo-2H-pyrazol-3-yl.

In a preferred aspect of this particular embodiment, the invention provides a compound selected from

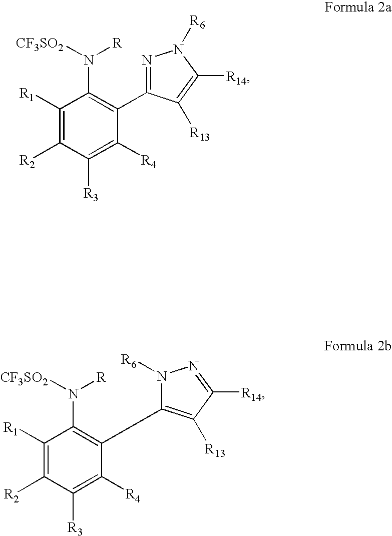

wherein R, R₁-R₄, and R₆ are defined as for Formula 1a, supra, and R₁₃ and R₁₄ are independently selected from the following: hydrogen, formyl, carboxyl, cyano, hydroxy, amino, nitro, thiol, halo and the following optionally substituted moieties: alkyl, alkenyl, alkynyl, cycloalkyl, cycloalkenyl, aryl, heterocyclyl, heteroaryl, alkanoyl, aroyl, heterocycloyl, heteroaroyl, alkoxycarbonyl, aryloxycarbonyl, heterocyclyloxycarbonyl, heteroaryloxycarbonyl, alkylaminocarbonyl, arylaminocarbonyl, heterocyclylaminocarbonyl, heteroarylaminocarbonyl, alkoxy, alkenyloxy, cycloalkoxy, cycloalkenyloxy, alkoxyalkoxy, aryloxy, heterocyclyloxy, alkanoate, aryloate, heterocyclyloate, heteroaryloate, alkylsulfonate, arylsulfonate, heterocyclylsulfonate, heteroarylsutfonate, alkylamino, alkenylamino, arylamino, heterocyclylamino, heteroarylamino, alkylcarbonylamino, arylcarbonylamino, heterocyclylcarbonylamino, heteroarylcarbonylamino, alkylthio, alkenylthio, cycloalkylthio, cycloalkenylthio, arylthio, heterocyclylthio, heteroarylthio, alkylsulfinyl, alkenylsulfinyl, cycloalkylsulfinyl, cycloalkenylsulfinyl, arylsulfinyl, heterocyclylsulfinyl, heteroarylsulfinyl, alkylsulfonyl, alkenylsulfonyl, cycloalkylsulfonyl, cycloalkenylsulfonyl, arylsulfonyl, heterocyclylsulfonyl, heteroarylsutlonyl, haloalkyl, haloalkenyl, haloalkynyl, haloalkoxy, haloalkenyloxy, haloalkylsulfonate haloalkylcarbonylamino, haloalkylthio, haloalkylsulfinyl, and haloalkylsulfonyl.

In a third embodiment, the invention provides N-phenyl-1,1,1-trifluoromethanesulfonamide compounds selected from the group of compounds including a trifluoromethylsulfonanilide of Formula 1a, Formula 1b and Formula 1c wherein R₆ and R₇ together are part of the same heterocyclic ring that is substituted or unsubstituted.

In a preferred aspect of this embodiment, the invention provides a N-phenyl-1,1,1-trifluoromethanesulfonamide compound selected from the group including 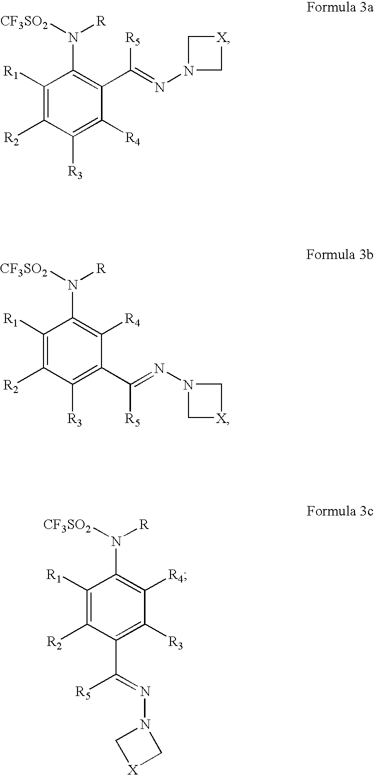
wherein:

R and R₁-R₅ are defined as for Formula 1a, Formula 1b and Formula 1c, supra; and wherein,

X is selected from the group including CH₂CH₂, CH₂CH₂CH₂, CH₂OCH₂ and CH₂CH₂CH₂CH₂.

In another preferred aspect of this embodiment, the invention provides a N-phenyl-1,1,1-trifluoromethanesulfonamide compound from the group including 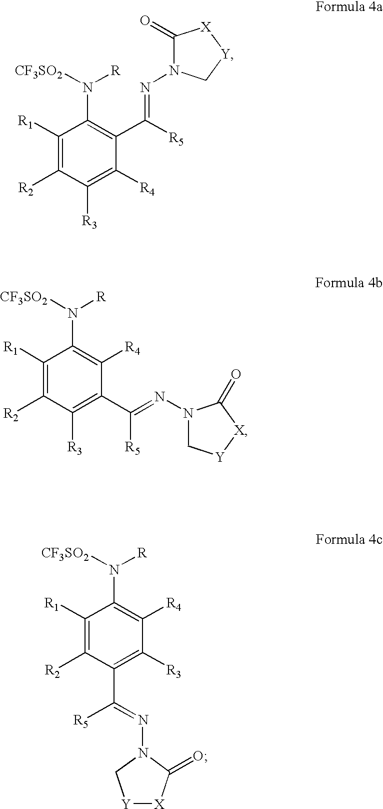
and wherein, R and R₁-R₅ are defined as for Formula 1a, Formula 1b and Formula 1c, supra; and wherein,

X is chosen from the group including oxygen, NR₁₅, CH₂, and C═O;

Y is chosen from the group including CH₂, CH₂CH₂ and C═O; and

R₁₅ selected from the following: hydrogen, and the following optionally substituted moieties: alkyl, alkenyl, alkynyl, cycloalkyl, cycloalkenyl, aryl, heterocyclyl, heteroaryl.

In a fourth embodiment the invention provides for the 234 compounds enumerated by Table 20 infra.

More particularly preferred compounds of the invention are compounds 9, 20-28, 30, 34-36, 38, 39, 41, 43, 48, 49, 51, 54, 55, 59, 62, 63, 65, 70-77, 81, 82, 96, 99, 100, 105, 116, 120, 125-127, 129, 130, 131 203, 211, 215, 221, 222 and 224 of Table 20, provided hereinbelow (Example 34).

In a fifth embodiment, the invention provides for compositions for delivering the above-described compounds. The inventive compositions comprise an effective amount of the inventive compound or a combination of the inventive compounds, to be employed, together with a suitable carrier. When the inventive compound is employed in the field, in order to treat the ground, structures, plants, animal care facilities, and the like, the composition will comprise a solid or liquid formulation.

In addition, although the inventive compounds are preferred over previously known agents, in certain optional embodiments they are contemplated to be employed in combination, simultaneously or sequentially, with other art-known agents or combinations of such art-known agents employed for killing or controlling various types of pests. These include, for instance, the organophosphate pesticides, e.g., dicrotophos, terbufos, dimethoate, dimethoate, diazinon, disulfoton, trichlorfon, azinphos-methyl, chlorpyrifos, malathion, oxydemeton-methyl, methamidophos, acephate, ethyl parathion, methyl parathion, mevinphos, phorate, carbofenthion, phosalone, to name but a few such compounds. These also include combinations with carbamate type pesticides, including, e.g., carbaryl, carbofuran, aldicarb, molinate, methomyl, carbofuran, etc., as well as combinations with the organochlorine type pesticides. These further include, for instance, combinations with the biological pesticides, including repellents, the pyrethrins (as well as synthetic variations thereof, e.g., allethrin, resmethrin, permethrin, tralomethrin), and nicotine, e.g., often employed as an acaricide. Other contemplated combinations with other miscellaneous pesticides, e.g., bacillus thuringensis, chlorobenzilate, copper compounds, e.g., copper hydroxide, cupric oxychloride sulfate, cyfluthrin, cypermethrin, dicofol, endosulfan, esenfenvalerate, fenvalerate, lambda-cyhalothrin, methoxychlor and sulfur. Combinations with cyclodienes, difluorobenzuron, ryania, and/or older art-known anti-helminth agents, such as, fenbendazole, KT-199, ivermectin, albendazole, etc., are also contemplated.

Solid compositions according to the invention include, for example, a powdered carrier into which an effective amount and concentration of at least one compound according to the invention is admixed. Such solid compositions optionally further include stabilizers, preservatives, coloring agents, perfumes, additional art-known active agents selected to provide synergistic anti-parasite killing activity, and/or agents selected to complement the parasite killing spectrum of the inventive compound or compounds.

Liquid compositions according to the invention include, for example, one or more optional liquid solvents, diluents or carriers that are polar, e.g., based on water, alcohol, or other polar solvent, or a solvent or carrier that is nonpolar, e.g., an organic solvent or the like. An effective amount and concentration of at least one compound according to the invention is admixed, dispersed, emulsified, or dissolved in the liquid carrier. Such liquid compositions optionally further include emulsifiers, detergents, anti-foaming agents, stabilizers, preservatives, coloring agents, perfumes, additional art-known active agents selected to provide synergistic anti-parasite killing activity, and/or agents selected to complement the parasite killing spectrum of the inventive compound or compounds. Such optional diluents or carriers are selected for compatibility with the selected inventive compound, as well as for environmental compatibility and safety, while allowing for administering the inventive compound or compounds into an area or location of interest, at concentrations effective for the intended purpose.

More preferably, the invention provides for a pharmaceutical composition for treatment of animals infected with parasites that comprises a therapeutically effective dosage amount of the N-phenyl-1,1,1-trifluoromethanesulfonamide compound of Formula 1a, Formula 1b, Formula 1c, Formula 2a, Formula 2b, Formula 3a, Formula 3b, Formula 3c, Formula 4a, Formula 4b and Formula 4c and/or combinations thereof, and a pharmaceutically acceptable excipient. Optionally, additional active agents, such as anti-infective, antiparasite, antiinflammatory or nutritional agents are contemplated to be included in the inventive pharmaceutical composition, as described in greater detail hereinbelow. The pharmaceutical composition is contemplated to be administered to animals for in vivo treatment by any suitable art known route, including, e.g., oral, parenteral, topical, and/or rectal, routes of administration.

In a solid form, the pharmaceutical composition includes pharmaceutically acceptable excipients, and carriers, and is prepared as a powder that is optionally dispensed in soluble capsules for oral ingestion, in any art-known tableted form. A solid composition according to the invention is also optionally formulated into a patch for transdermal administration. In a liquid form, the pharmaceutical composition is provided, together with any optional pharmaceutically acceptable excipients, and carriers, in solution and/or in suspension in a pharmaceutically acceptable liquid composition for administration orally, by infusion or injection and/or by spray or inhalation, and the like.

In a sixth embodiment, the invention provides for methods for killing parasites, both ex vivo, e.g., in the environment, as well as methods of treating a parasite infestation in animals, comprising administering to an animal in need of such treatment an effective amount of a N-phenyl-1,1,1-trifluoromethanesulfonamide hydrazone compound as described above for Formula 1a, Formula 1b, Formula 1c, Formula 2a, Formula 2b, Formula 3a, Formula 3b, Formula 3c, Formula 4a, Formula 4b and Formula 4c and/or combinations thereof.

Preferably, the above methods and compositions are applied to arthropod and/or helminth parasites. In a further preferred optional embodiment of the invention there are provided methods of preventing or treating parasite infestation in crop plants, stored grain or other stored plant or agricultural products, and people or animals, comprising administering a parasite-suppressive or parasite killing amount of at least one inventive compound or combinations thereof, into an environmental area where parasites of interest are present, or may become present. By “administering” in this context is meant contacting environmental materials or surfaces, including plants and external surfaces (e.g., fur or hides) of animals, with amounts of the inventive compound or with a selected mixture or combination of more than one of the inventive compounds that is effective to kill, suppress and/or repel one or more parasites of interest.

Compositions that include solutions, emulsifications, suspensions and dry forms of the inventive compound(s) are discussed supra. The process of administering such compositions in the environmental context can be achieved by methods well known in the art. These include spraying, brushing, dipping, rinsing, washing, dusting, using art-known equipment, in a selected area. The selected area to be treated optionally includes plants, e.g., crops, and/or animals. In a particular embodiment, a composition comprising a compound of the invention is placed on a minor portion of the outer surface of an animal, generally as a line or spot on the animal's back (e.g., as a pour-on application) and the compound migrates over the whole external surface of the animal to protect the animal [see, U.S. Pat. No. 6,492,419 B1, the contents of which are hereby incorporated by reference in their entireties].

Environmental areas contemplated to be treated in this way include, e.g., fields, orchids, gardens and the like, buildings and their environs, including landscaping; storage facilities, transport or fixed storage that contains or analogous structures and structural components, such as walls, floors, roofs, fences, windows and window screens, and the like. Animal living spaces are also included, e.g., animal pens, chicken coops, corals, barns and the like. Human homes and other human residential, business or commercial and educational facilities are also contemplated to be treated or contacted with the inventive compounds or compositions thereof as described above.

These and other aspects of the present invention will be better appreciated by reference to the following drawings and Detailed Description.

### BRIEF DESCRIPTION OF THE DRAWINGS

FIG. 1 illustrates Reaction Scheme 1 for preparing a compound of Formula 1a from a starting compound of Formula 6a through step A, nitration, step B, reduction, and further steps indicated in the FIG. 1, in which 1a′ is a compound of Formula 1a wherein R is H, “RY” is an electrophilic reagent, wherein Y is a leaving group as defined hereinbelow.

FIG. 2 illustrates Reaction Scheme 2 for preparing a hydrazine of Formula 10, where X is halogen.

FIG. 3 illustrates Reaction Scheme 3 for preparing a compound of Formula 6a from a compound of Formula 13.

FIG. 4 illustrates Reaction Scheme 4 for preparing a compound of Formula 8a from a compound of Formula 15.

FIG. 5 illustrates Reaction Scheme 5 for preparing a compound of Formula 7a from a compound of Formula 17.

FIG. 6 illustrates Reaction Scheme 6 for preparing a compound of Formula 2a and/or Formula 2b from a compound of Formula 9a.

FIG. 7 illustrates Reaction Scheme 7 for preparing a hydrochloride salt of Formula 10 (wherein R⁷ is cycloalkyl or heterocyclyl), in which C is an alicyclic ketone or heterocyclic ketone, D indicates the reaction is conducted with microwave heating.

FIG. 8 illustrates Reaction Scheme 8 for preparing a compound of Formula 2a (wherein R₁₃, R₁₄ are H) through oxidation of compound 27 (a compound of Formula 1a wherein R⁵ and R⁶ are linked to form a pyrazoline ring and R⁷ is aryl), in which E is a Jones' reagent, F is reduction and G is oxidation.

FIG. 9 illustrates Reaction Scheme 9 for preparing a compound of Formula 1a (wherein R⁴ and R⁵ are linked to form a ring).

### DETAILED DESCRIPTION OF THE INVENTION

The invention provides new N-phenyl-1,1,1-trifluoromethanesulfonamide hydrazone derivatives useful as parasiticides, and compositions containing these derivatives. The invention provides methods of treating and/or preventing endo- and/or ectoparasite infestations of animals, as well as methods of killing or suppressing such parasites by contacting such parasites with compositions comprising N-phenyl-1,1,1-trifluoromethanesulfonamide hydrazone derivatives.

In order to more fully appreciate the description of the invention, the following definitions are provided. As used herein, the following terms are employed as defined below, unless otherwise indicated.

The use of singular terms for convenience in the description is in no way intended to be so limiting. Thus, for example, reference to “a parasite” includes reference to one or more of such parasites. The use of plural terms is also not intended to be limiting, unless otherwise specified. For example, phrases such as, “N-phenyl-1,1,1-trifluoromethanesulfonamide hydrazone compounds” refers to any N-phenyl-1,1,1-trifluoromethanesulfonamide hydrazone compound identified herein, includes a single such compound alone, or a combination of two or more such compounds, unless otherwise specified.

As used herein, the term, “approximately,” is used interchangeably with the term “about” and generally signifies that a value is within twenty percent of the indicated value, unless otherwise indicated.

As used herein, the term, “therapeutically effective dosage amount,” refers to an amount of the inventive compound effective to treat or prevent an infection or infestation by a susceptible parasite in an animal.

As used herein, the term, “prophylactically effective amount,” refers to the amount of the inventive N-phenyl-1,1,1-trifluoromethanesulfonamide hydrazone derivatives, that when administered to an animal or fish results in a sufficient plasma concentration of the compound to significantly reduce the likelihood and/or extent of an infection or infestation due to parasites that are susceptible to that compound. A prophylactically-effective amount of an inventive compound of the present invention may also be used subsequent to the administration of an earlier antiparasitic regimen to maintain a reduced level (or elimination) of a population of parasites in the animal or fish. A prophylactically-effective amount also refers to that amount of a composition comprising the inventive compound that will prevent parasites from accumulating in a susceptible organism in sufficient quantity to cause an infection or infestation. The prophylactically effective amount is measured in plasma for in vivo administration, and for eternal administration, is measured by the levels of the inventive compound present in the environment and/or on the external surfacses of an animal (e.g., fur or feathers) fathers, for ex vivo applications.

“Metaphylaxis” is the timely mass medication of an entire group of animals to eliminate or minimize an expected outbreak of disease, e.g. in one or more animals at high risk of infection. In one particular embodiment, high risk calves are light weight, commingled, long haul cattle with unknown health histories.

A hydrazone is one of a class of compounds with the formula of 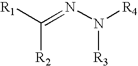
wherein R₁, R₂, R₃ and R₄ are independently either a hydrogen atom or a substituted carbon atom.

In this specification “optionally substituted” means that a functional group is either substituted or unsubstituted, at any available position. Substitution can be with one or more functional groups selected from, e.g., alkyl, alkenyl, alkynyl, aryl, cycloalkyl, cycloalkylalkyl, cycloalkenyl, alkylcycloalkyl, alkylcycloalkenyl, arylcycloalkyl, arylcycloalkenyl, halo, cyano, nitro, haloalkyl, haloalkenyl, haloalkynyl, haloaryl, halocycloalkyl, halocycloalkenyl, hydroxy, alkoxy, cycloalkoxy, alkenyloxy, aryloxy, haloalkoxy, haloalkenyloxy, haloaryloxy, halocycloalkyloxy, heterocyclyl, heterocyclylalkyl, heteroarylalkyl, heterocyclyloxy, heterocyclylamino, heterocyclylalkyl, heterocyclyloxyalkyl, heterocyclylthioalkyl, haloheterocyclyl, haloheterocyclylalkyl, haloheterocyclyloxyalkyl, haloheterocyclylthioalkyl, nitroaryl, nitroheterocyclyl, amino, alkylamino, dialklamino, alkenylamino, alkynylamino, arylamino, acyl, alkenylacyl, arylacyl, acylamino, alkylsulphonyloxy, alkoxycarbonyl, alkylthio, alkylsulphonyl, arylthio, arylsulphonyl, aminosulphonyl, dialkylaminosulphonyl, cyanoalkyl, alkylcarbonylalkyl, cycloalkylcarbonylalkyl, arylcarbonylalkyl, heterocyclylcarbonylalkyl, heteroarylcarbonylalkyl, alkoxycarbonylalkyl, alkylaminocarbonylalkyl, trialkylsilylalkyl, trialkoxysilylalkyl, dialkoxyphosphonatoalkyl, and any other art-known substituents.

“Alkyl” whether used alone, or in compound words such as alkoxalkyl, alkoxyalkoxyalkyl, alkoxy, alkylthio, alkylamino, alkylcarbonyloxyalkyl, dialkylamino or haloalkyl, represents straight or branched chain hydrocarbons ranging in size from one to about 20 carbon atoms, or more. Thus alkyl moieties include, without limitation, moieties ranging in size, for example, from one to about 10 carbon atoms or greater, e.g., methyl, ethyl, n-propyl, iso-propyl and/or butyl, pentyl, hexyl, and higher isomers, including, e.g. those straight or branched chain hydrocarbons ranging in size from about 11 to about 20 carbon atoms, or greater. Preferably, an alkyl group ranges in size from 1 to about 6 carbons.

“Alkenyl” whether used alone, or in compound words such as alkenyloxy or haloalkenyl, represents straight or branched chain hydrocarbons containing at least one carbon-carbon double bond, including, without limitation, moieties ranging in size from two to about 6 carbon atoms or greater, such as, methylene, ethylene, 1-propenyl, 2-propenyl, and/or butenyl, pentenyl, hexenyl, and higher isomers, including, e.g., those straight or branched chain hydrocarbons ranging in size, for example, from about 2 to about 20 carbon atoms, or greater. Preferably, an alkenyl ranges in size from 2 to about 6 carbons.

“Alkynyl” whether used alone, or in compound words such as alkynyloxy, represents straight or branched chain hydrocarbons containing at least one carbon-carbon triple bond, including, without limitation, moieties ranging in size from, e.g., two to about 6 carbon atoms or greater, such as, ethynyl, 1-propynyl, 2-propynyl, and/or butynyl, pentynyl, hexynyl, and higher isomers, including, e.g., those straight or branched chain hydrocarbons ranging in size from, e.g., about 6 to about 20 carbon atoms, or greater. The preferred size is from 1 to about 6 carbons.

“Aryl” whether used alone, or in compound words such as arylalkyl, aryloxy or arylthio, represents. (i) an optionally substituted mono- or polycyclic aromatic carbocyclic moiety, e.g., of about 6 to about 20 carbon atoms, such as phenyl, naphthyl or fluorenyl; or, (ii) an optionally substituted partially saturated polycyclic carbocyclic aromatic ring system in which an aryl and a cycloalkyl or cycloalkenyl group are fused together to form a cyclic structure such as a tetrahydronaphthyl, indenyl or indanyl ring. The preferred number of carbons in an aryl group ranges from 6 to about 10.

“Heteroaryl” whether used alone, or in compound words means an aromatic monocyclic or multicyclic ring system comprising about 5 to about 14 ring atoms, preferably about 5 to about 10 ring atoms, in which one or more of the ring atoms is an element other than carbon, for example nitrogen, oxygen or sulfur, alone or in combination. Preferred heteroaryls contain about 5 to about 6 ring atoms. The “heteroaryl” can be optionally substituted by one or more “ring system substituents” which may be the same or different, and are as defined herein. The prefix aza, oxa or thia before the heteroaryl root name means that at least a nitrogen, oxygen or sulfur atom respectively, is present as a ring atom. A nitrogen atom of a heteroaryl can be optionally oxidized to the corresponding N-oxide. Non-limiting examples of suitable heteroaryls include pyridyl, pyrazinyl furanyl, thienyl, pyrimidinyl, pyridone (including N-substituted pyridones), isoxazolyl, isothiazolyl, oxazolyl, thiazolyl, pyrazolyl, furazanyl, pyrrolyl, pyrazolyl, triazolyl, 1,2,4-thiadiazolyl, pyrazinyl, pyridazinyl, quinoxalinyl, phthalazinyl, oxindolyl, imidazo[1,2-a]pyridinyl imidazo[2,1-b]thiazolyl, benzofurazanyl, indolyl, azaindolyl, benzimidazolyl, benzothienyl, quinolinyl, imidazolyl, thienopyridyl, quinazolinyl, thienopyrimidyl, pyrrolopyridyl, imidazopyridyl, isoquinolinyl, benzoazaindolyl, 1,2,4-triazinyl, benzothiazolyl and the like. The term “heteroaryl” also refers to partially saturated heteroaryl moieties such as, for example, tetrahydroisoquinolyl, tetrahydroquinolyl and the like.

“Cycloalkyl” represents a mono- or polycarbocyclic ring system of varying sizes, e.g., from about 3 to about 20 carbon atoms, e.g., cyclopropyl, cyclobutyl, cyclopentyl, cyclohexyl or cycloheptyl. The term cycloalkyloxy represents the same groups linked through an oxygen atom such as cyclopentyloxy and cyclohexyloxy. The term cycloalkylthio represents the same groups linked through a sulfur atom such as cyclopentylthio and cyclohexylthio. The preferred number of carbons in a cycloalkyl group ranges from 3 to about 7.

“Alkylcycloalkyl” denotes alkyl substitution on a cycloalkyl moiety. Examples include 4-methylcyclohexyl and isopropylcyclopentyl. The preferred number of carbons in an alkylcycloalkyl group ranges from about 4 to about 12.

The term “acyl,” means an H—C(O)—, alkyl-C(O)— or cycloalkyl-C(O)—, group in which the various groups are as described herein. The bond to the parent moiety is through the carbonyl. “Acyl”, whether used alone or in compound words such as alkenylacyl and arylacyl, denotes the radical formed after removing the hydroxyl group from an organic acid. Acyl includes: alkanoyl, aroyl, heteroaroyl.

“Alkanoyl” means the group RCO where R is alkyl. Examples include formyl, acetyl, propionyl, and the different butyryl, valeryl, caproyl and higher isomers.

“Aroyl” means an acyl group derived from an aromatic acid.

“Heteroaroyl” means the group RCO where R is heteroaryl. Preferred acyl groups contain from 1 to about 10 carbons.

The term, “carbamoyl” denotes the group R₂N—CO wherein R is H, alkyl, aryl, heteroaryl or heterocyclyl. Examples include N-methylcarbamoyl, and N,N-dimethylcarbamoyl.

“Thiocarbamoyl” denotes a group R₂N—CS where R is H, alkyl, aryl, heteroaryl or heterocyclyl. Examples include N-methylthiocarbamoyl, and N,N-dimethylthiocarbamoyl.

The term “halo”, either alone or in compound words such as “haloalkyl”, denotes fluorine, chlorine, bromine or iodine. Further, when used in compound words such as “haloalkyl” the alkyl may be partially halogenated or fully substituted with halogen atoms which may be the same or different. Examples of haloalkyl include CH₂CH₂F, CF₂CF₃ and CH₂CHFCl. Examples of “haloalkenyl” include Cl₂C═CHCH₂ and CF₃CH₂CH═CHCH₂. Examples of “haloalkynyl” include HC≡CCHCl, CF₃C≡C, CCl₃C≡C and FCH₂C≡CCH₂. Examples of “haloalkoxy” include CF₃O, CCl₃CH₂O, CF₂CH₂CH₂O and CF₃CH₂O. Examples of “haloalkylthio” include CCl₃S, CF₃S, CCl₃CH₂S and CH₂ClCH₂ClCH₂CH₂S. Examples of “haloalkylsulfonyl” include CF₃SO₂, CCl₃SO₂, CF₃CH₂SO₂ and CF₃CF₂SO₂.

“Heterocyclyl” denotes a group comprising a 3 to 10 membered, preferably 5 to 8 membered, ring containing one to three hetero atoms such as oxygen, nitrogen or sulfur, which ring may be substituted and/or carry fused rings. Examples of such groups include, pyrrolidinyl, morpholinyl, thiomorpholinyl, or fully or partially hydrogenated thienyl, furanyl, pyrrolyl, thiazolyl, oxazoyl, oxazinyl, thiazinyl, pyridinyl and azepinyl. The heterocyclyl group may be aromatic in which case it may be referred to herein as a “heteroaryl” group. Examples of heteroaryl include pyridyl, furanyl, thienyl, pyrrolyl, pyrazoyl, benzthiazolyl, indolyl, benzofuranyl, benzothiophenyl, pyrazinyl, quinoyl, pyrimidinyl.

“Alkoxy” denotes an alkyl group linked to the rest of the molecule via an oxygen atom, for example methoxy, ethoxy, n-propoxy, iso-propyloxy, and the different butyloxy, pentyloxy, hexyloxy and higher isomers. The preferred number of carbons in an alkoxy group ranges from 1 to about 6.

“Alkenyloxy” denotes straight chain or branched alkenyloxy moieties. Examples of alkenyloxy include CH₂═CHCH₂O, (CH₃)₂C═CHCH₂O, (CH₃)CH═C(CH₃)CH₂O and CH₂C═CHCH₂CH₂O. The preferred number of carbons in an alkenyloy group ranges from 2 to 6.

“Aryloxy” denotes an aryl group linked to the rest of the molecule via an oxygen atom, for example phenoxy. “Aryloxyalkyl” denotes aryloxy substitution on alkyl. “Alkyloxyaryl” denotes alkoxy substitution on aryl.

“Arylalkoxy” denotes aryl substitution on an alkoxy group, e.g. benzyloxy and 2-phenylethoxy.

“Alkoxycarbonyl” denotes a group ROC═O where R is alkyl. Examples of “alkoxycarbonyl” include CH₃C(═O), CH₃CH₂C(═O), CH₃CH₂CH₂C(═O), (CH₃)₂CHOC(═O) and the different butoxy-, pentoxy-, hexyloxycarbonyl and higher isomers. The preferred range of carbons for an alkoxycarbonyl group is from 2 to about 8.

“Alkylthio” denotes alkyl groups linked to the rest of the molecule via a sulfur atom, for example methylthio, ethylthio, n-propylthio, iso-propylthio, and the different butylthio, pentylthio, hexylthio and higher isomers.

“Sulfonyl” represents an —SO₂R group that is linked to the rest of the molecule through a sulfur atom.

“Alkylsulfonyl” represents an —SO₂-alkyl group in which the alkyl group is as defined supra.

“Arylsulfonyl” represents an —SO₂-aryl group in which the aryl group is as defined supra.

“Heterocyclylsulfonyl” represents an —SO₂R group wherein R is heterocyclyl.

“Heteroarylsulfonyl” represents an —SO₂R group wherein R is heteroaryl.

“Phenylsulfanyl” denotes a S-Ph group that is linked to the rest of the molecule via a sulfur atom.

“Sulfinyl” represents an —SOR group that is linked to the rest of the molecule through a sulfur atom.

“Phenylsulfinyl” represents an —SO-Ph group that is linked to the rest of the molecule through a sulfur atom.

“Phenylsulfonyl” represents an —SO₂-Ph group that is linked to the rest of the molecule through a sulfur atom

“Phenylamino” represents an —NR₁₀-Ph group, wherein R₁₀ is hydrogen or alkyl which is linked to the rest of the molecule through a nitrogen atom.

“Cyano” represents a —CN moiety.

“Cyanoalkyl” represents an alkyl group that contains a cyano substituent.

“Heterocyclylalkyl” denotes a heterocyclyl substitution on an alkyl moiety.

“Heteroarylalkyl” denotes a heteroaryl substitution on an alkyl moiety.

“Hydroxyalkyl” denotes an alkyl group that contains an alcohol substituent.

“Alkoxyalkyl” denotes an alkoxy substitution on an alkyl moiety.

“Aryloxyalkyl” denotes an aryloxy substitution on an alkyl moiety.

“Alkylcarbonylalkyl” denotes an acyl substitution on an alkyl moiety, in which the acyl group is a alkyl-C(O)—.

“Cycloalkylcarbonylalkyl” denotes acyl substitution on an alkyl moiety, in which the acyl group is a cycloalkyl-C(O)—.

“Arylcarbonylalkyl” denotes an aroyl substitution on an alkyl moiety.

“Heterocyclylcarbonylalkyl” denotes an acyl substitution on an alkyl moiety, in which the acyl group is a heterocyclyl-C(O)—.

“Heteroarylcarbonylalkyl” denotes an acyl substitution on an alkyl moiety, in which the acyl group is a heteroaryl-C(O)—.

“Alkoxycarbonylalkyl” denotes an alkyl group that contains an alkoxycarbonyl substituent.

“Alkylaminocarbonylalkyl” denotes an alkyl group that contains the “carbamoyl” group R₂N—CO— wherein R is alkyl.

“Trialkylsilylalkyl” denotes an alkyl group that contains the substituent R₃Si— wherein R is alkyl.

“Trialkoxysilylalkyl” denotes an alkyl group that contains the substituent (RO)₃Si— wherein R is alkyl.

“Dialkoxyphosphonatoalkyl” denotes an alkyl group that contains the substituent (RO)₂P(═O)— wherein R is alkyl.

“Heterocyclyloxyalkyl” denotes an alkyl group that contains the substituent R—O— wherein R is heterocyclyl.

“Heteroaryloxyalkyl” denotes an alkyl group that contains the substituent R—O— wherein R is heteroaryl.

“Alkylcarbonyloxyalkyl” denotes an alkyl group that contains the substituent R(CO)—O— wherein R is alkyl.

“Arylcarbonyloxyalkyl” denotes an alkyl group that contains the substituent R(CO)—O— wherein R is aryl.

“Heterocyclylcarbonyloxyalkyl” denotes an alkyl group that contains the substituent R(CO)—O— wherein R is heterocycyl.

“Heteroarylcarbonyloxyalkyl” denotes an alkyl group that contains the substituent R(CO)—O— wherein R is heteroaryl.

“Alkoxycarbonyloxyalkyl” denotes an alkyl group that contains the substituent RO(CO)O— wherein R is alkyl.

“Aryloxycarbonyloxyalkyl” denotes an alkyl group that contains the substituent RO(CO)O— wherein R is aryl.

“Heterocyclyloxycarbonyloxyalkyl” denotes an alkyl group that contains the substituent RO(CO)O— wherein R is heterocyclyl.

“Heteroaryloxycarbonyloxyalkyl” denotes an alkyl group that contains the substituent RO(CO)O— wherein R is heteroaryl.

“Alkylaminocarbonyloxyalkyl” denotes an alkyl group that contains the substituent R₂N(CO)O— wherein at least one R is alkyl.

“Arylaminocarbonyloxyalkyl” denotes an alkyl group that contains the substituent R₂N(CO)O— wherein at least one R is aryl.

“Heterocycylaminocarbonyloxyalkyl” denotes an alkyl group that contains the substituent R₂N(CO)O— wherein at least one R is heterocycyl.

“Heteroarylaminocarbonyloxyalkyl” denotes an alkyl group that contains the substituent R₂N(CO)O— wherein at least one R is heteroaryl.

“Alkylcarbonylaminoalkyl” denotes an alkyl group that contains the substituent R(CO)NH— wherein R is alkyl.

“Arylcarbonylaminoalkyl” denotes an alkyl group that contains the substituent R(CO)NH— wherein R is aryl.

“Heterocyclylcarbonylaminoalkyl” denotes an alkyl group that contains the substituent R(CO)NH— wherein R is heterocycyl.

“Heteroarylcarbonylaminoalkyl” denotes an alkyl group that contains the substituent R(CO)NH— wherein R is heteroaryl.

“Alkylsulfonylalkyl” represents an alkyl group that contains an alkylsulfonyl substituent.

“Arylsulfonylalkyl” represents an alkyl group that contains an arylsulfonyl substituent.

“Heterocyclylsulfonylalkyl” denotes an alkyl group that contains the substituent R(SO₂)— wherein R is heterocyclyl.

“Heteroarylsulfonylalkyl” denotes an alkyl group that contains the substituent R(SO₂)— wherein R is heteroaryl.

“Aryloxycarbonyl” denotes a group ROC═O where R is aryl.

“Heterocyclyloxycarbonyl” denotes a group ROC═O where R is heterocyclyl.

“Heteroaryloxycarbonyl” denotes a group ROC═O where R is heteroaryl.

“Heterocyclsulfonyl” denotes the group RSO₂— wherein R is heterocyclyl.

“Heteroarylsulfonyl” denotes the group RSO₂— wherein R is heteroaryl.

“Heteroaryloxy” denotes a heteroaryl group linked to the rest of the molecule via an oxygen atom.

“Heterocyclyloxy” denotes a heterocyclyl group linked to the rest of the molecule via an oxygen atom.

“Cycloalkenylalkyl” denotes an alkyl group that contains a cycloalkenyl substituent.

“Heterocycylalkyl” denotes an alkyl group that contains a heterocyclyl substituent.

“Heteroarylalkenyl” denotes an alkenyl group that contains a heteroaryl substituent.

“Heterocycloyl” means the group RCO where R is heterocycyl.

“Alkylthioalkyl” denotes an alkyl group that contains a thioalkyl substituent.

“Cycloalkylthioalkyl” denotes an alkyl group that contains a thiocycloalkyl substituent.

“Arylthioalkyl” denotes an alkyl group that contains an arylthio substituent.

“Alkylsulfinylalkyl” denotes an alkyl group that contains an alkylsulfinyl substituent.

“Cycloalkylsulfinylalkyl” denotes an alkyl group that contains a cycloalkylsulfinyl substituent.

“Arylsulfinylalkyl” denotes an alkyl group that contains an arylsulfinyl substituent.

“Alkylsulfonylalkyl” denotes an alkyl group that contains an alkylsulfonyl substituent.

“Cycloalkylsulfinylalkyl” denotes an alkyl group that contains an cycloalkylsulfonyl substituent.

“Arylsulfonylalkyl” denotes an alkyl group that contains an arylsulfonyl substituent.

“Aryloxycarbonyl” means the group RO(CO)— wherein R is aryl.

“Heterocyclyloxycarbonyl” means the group RO(CO)— wherein R is heterocyclyl.

“Heteroaryloxycarbonyl” means the group RO(CO)— wherein R is heteroaryl.

The term, “prodrug” as used herein refers to a compound which is convertible in use, e.g., on an environmental surface and/or in vivo, by metabolic means or other processes (e.g., by hydrolysis) to one of the compounds of the invention, e.g., a compound of Formula 1a, 1b, 1c. For example, derivatization of a compound of the invention wherein R is hydrogen, is contemplated to provide a compound convertible by hydrolysis in vivo to the parent molecule. In certain optional embodiments, delivery of the active compound in prodrug form achieves improved delivery of the inventive compound by improving its physicochemical/pharmacokinetic properties, e.g., by enhancing systemic absorption, delaying clearance or breakdown, in vivo. A discussion of prodrugs is provided in Higuchi and Stella, Pro-drugs as Novel Delivery Systems, 14 of the A.C.S. Symposium Series (1987); and in Bioreversible Carriers in Drug Design, Edward B. Roche, ed., American Pharmaceutical Association and Pergamon Press (1987).

The term parasite, “infestation” refers to the presence of parasites in numbers that pose a risk to humans or animals. The presence can be in the environment, e.g., on plants, in animal bedding, on the skin or fur of an animal, etc. When the infestation that is referred to is within an animal, e.g., in the blood or other internal tissues, the term infestation is also intended to be synonymous with the term, “infection,” as that term is generally understood in the art, unless otherwise stated.

An “effective amount,” is the amount or quantity of a compound according to the invention that is required to alleviate or reduce parasite numbers in a sample of such parasites, and/or to reduce the numbers of such parasites in and/or on an animal, and/or to inhibit the development of parasite infestation in or on an animal, in whole or in part. This amount is readily determined by observation or detection of the parasite numbers both before and after contacting the sample of parasites with the compound, directly and/or indirectly, e.g., by contacting articles, surfaces, foliage, or animals with the compound. For an in vivo administration of the compound according to the invention, an effective amount is synonymous with a, “pharmaceutically effective amount,” which is the dose or amount that treats or ameliorates symptoms and/or signs of parasite infection or infestation by the treated animal. This later amount is also readily determined by one of ordinary skill in the art, e.g., by observing or detecting changes in clinical condition or behavior of treated animals, as well as by observing or detecting relative changes in parasite numbers after such treatment. Whether the compound is applied in vivo or ex vivo, the treatment is effective when the parasite count is reduced, after a first application or administration, by an amount ranging from 5% to about 100%. Alternatively, the reduction in parasite count ranges from about 10% to about 95%, relative to the parasite count in an equivalent untreated sample.

Compounds of this invention can exist as one or more stereoisomers. The various stereoisomers include enantiomers, diastereomers and geometric isomers. Those skilled in the art will appreciate that one stereoisomer may be more active than the other(s). In addition, the skilled artisan would know how to separate such stereoisomers. Accordingly, the present invention comprises mixtures, individual stereoisomers, and optically active mixtures of the compounds described herein.

For example, although Formulas 1a, 1b, 1c, 3a, 3b, 3c, 4a, 4b and 4c have been drawn as the anti(E)-isomers, it should be understood that the compounds of the present invention may also exist as syn(Z)-isomers, or mixtures thereof and therefore, such isomers or mixtures thereof are clearly included within the present invention.

Certain compounds of the present invention will be acidic in nature and can form pharmaceutically acceptable metal, ammonium and organic amine salts. The metal salts include alkali metal (e.g., lithium, sodium and potassium), alkaline earth metal (e.g., barium, calcium and magnesium) and heavy metal (e.g., zinc and iron) salts as well as other metal salts such as aluminium. The organic amine salts include the salts of pharmaceutical acceptable aliphatic (e.g., alkyl), aromatic and heterocyclic amines, as well as those having a mixture of these types of structures.

Amines useful in preparing the salts of the invention can be primary, secondary or tertiary and preferably contain not more than 20 carbon atoms. The salts of the invention are prepared by contacting the acid form with a sufficient amount of the appropriate base to produce a salt in the conventional manner. The acid forms may be regenerated by treating the salt with a suitable dilute aqueous acid solution. The acid forms differ from their respective salt forms somewhat in certain physical properties, such as solubility in polar solvents, but the salts are otherwise equivalent to their respective acid forms for the purposes of the invention.

All such salts are intended to be pharmaceutically acceptable within the scope of the invention and all salts are considered equivalent to the acid form for the purposes of the invention.

The compounds of the present invention can also form stable complexes with solvent molecules that remain intact after the non-complexed solvent molecules are removed from the compounds. These complexes are referred to herein as “solvates”. Solvates of the compounds of the present invention are also included in the present invention. In a particular embodiment, the solvent molecule is water (i.e., forming a hydrate).

For all of the methods and new compounds described herein, it is also contemplated that the identified compounds are readily employed in combination with one or more art-known agents for killing or controlling various types of parasites, e.g., including all of the ecto- and endoparasites described herein. Thus, although the inventive compounds and methods are preferred over previously known agents and methods of using previously known agents, in certain optional embodiments they are contemplated to be employed in combination, simultaneously, or sequentially (e.g. in the same composition or in separate compositions), with other art-known agents or combinations of such art-known agents employed for killing or controlling various types of pests.

These additional agents include, for example, art-known anthelmintics, such as, for example, avermectins (e.g. ivermectin, moxidectin, milbemycin), benzimidazoles (e.g. albendazole, triclabendazole), salicylanilides (e.g. closantel, oxyclozanide), substituted phenols (e.g. nitroxynil), pyrimidines (e.g. pyrantel), imidazothiazoles (e.g. levamisole) and praziquantel.

Additional art-known agents for killing or controlling pests include the organophosphate pesticides. This class of pesticides has very broad activity, e.g. as insecticides and, in certain instances, anthelminitic activity. Organophosphate pesticides include, e.g., dicrotophos, terbufos, dimethoate, diazinon, disulfoton, trichlorfon, azinphos-methyl, chlorpyrifos, malathion, oxydemeton-methyl, methamidophos, acephate, ethyl parathion, methyl parathion, mevinphos, phorate, carbofenthion, phosalone, to name but a few such compounds. It is also contemplated to include combinations of the inventive methods and compounds with carbamate type pesticides, including, e.g., carbaryl, carbofuran, aldicarb, molinate, methomyl, carbofuran, etc., as well as combinations with the organochlorine type pesticides. It is further contemplated to include combinations with biological pesticides, including e.g. repellents, the pyrethrins (as well as synthetic variations thereof, e.g., allethrin, resmethrin, permethrin, tralomethrin), and nicotine, that is often employed as an acaricide. Other contemplated combinations are with miscellaneous pesticides including: bacillus thuringensis, chlorobenzilate, formamidines, (e.g. amtitaz), copper compounds, e.g., copper hydroxide, cupric oxychloride sulfate, cyfluthrin, cypermethrin, dicofol, endosulfan, esenfenvalerate, fenvalerate, lambda-cyhalothrin, methoxychlor and sulfur.

In addition, for all of the methods and new compounds described herein, it is further contemplated that the identified compounds can be readily employed in combination with syngergists such as piperonyl butoxide (PBO) and triphenyl phosphate (TPP); and/or with Insect Growth Regulators (IGRs) and Juvenile Hormone Analogues (JHAs) such as diflubenzuron, cyromazine, methoprene, etc., thereby providing both initial and sustained control of parasites (at all stages of insect development, including eggs) on the animal subject, as well as within the environment of the animal subject.

Combinations with cyclodienes, ryania, KT-199 and/or older art-known anti-helminth agents, such as avermectins (e.g., ivermectin, moxidectin, milbemycin), benzimidazoles (e.g., albendazole, triclabendazole), salicylanilides (e.g., closantel, oxyclozanide), substituted phenols (e.g., nitroxynil), pyrimidines (e.g., pyrantel), imidazothiazoles (e.g., levamisole), praziquantel and some organophosphates such as naphthalophos and pyraclofos, are also contemplated to be employed in such combinations.

In particular, additional antiparasitic compounds useful within the scope of the present invention are preferably comprised of the class of avermectin compounds. As stated above, the avermectin family of compounds is a series of very potent antiparasitic agents known to be useful against a broad spectrum of endoparasites and ectoparasites in mammals.

A preferred compound for use within the scope of the present invention is ivermectin. Ivermectin is a semi-synthetic derivative of avermectin and is generally produced as a mixture of at least 80% 22,23-dihydroavermectin B1ₐ and less than 20% 22,23-dihydroavermectin B1_{b}. Ivermectin is disclosed in U.S. Pat. No. 4,199,569, hereby incorporated by reference. Ivermectin has been used as an antiparasitic agent to treat various animal parasites and parasitic diseases since the mid-1980's.

Abamectin is an avermectin that is disclosed as avermectin B1a/B1b in U.S. Pat. No. 4,310,519, which is hereby incorporated by reference in its entirety. Abamectin contains at least 80% of avermectin B1ₐ and not more than 20% of avermectin B1_{b}.

Another preferred avermectin is Doramectin also known as 25-cyclohexyl-avermectin B₁. The structure and preparation of Doramectin, is disclosed in U.S. Pat. No. 5,089,480, which is hereby incorporated by reference in its entirety.

Another preferred avermectin is Moxidectin. Moxidectin, also known as LL-F28249 alpha is known from U.S. Pat. No. 4,916,154, which is hereby incorporated by reference in its entirety.

Another preferred avermectin is Selamectin. Selamectin is 25-cyclohexyl-25-de(1-methylpropyl)-5-deoxy-22,23-dihydro-5-(hydroxyimino)-avermectin B₁ monosaccharide.

Milbemycin, or B41, is a substance which is isolated from the fermentation broth of a Milbemycin producing strain of Streptomyces. The microorganism, the fermentation conditions and the isolation procedures are more fully described in U.S. Pat. No. 3,950,360 and U.S. Pat. No. 3,984,564.

Emamectin (4″-deoxy-4″-epi-methylaminoavermectin B₁), which can be prepared as described in U.S. Pat. No. 5,288,710 or 5,399,717, is a mixture of two homologues, 4″-deoxy-4″-epi-methyl aminoavermectin B1a and 4″-deoxy-4″-epi-methylaminoavermectin B1b. Preferably, a salt of Emamectin is used. Non-limiting examples of salts of Emamectin which may be used in the present invention include the salts described in U.S. Pat. No. 5,288,710, e.g., salts derived from benzoic acid, substituted benzoic acid, benzenesulfonic acid, citric acid, phosphoric acid, tartaric acid, maleic acid, and the like. Most preferably, the Emamectin salt used in the present invention is Emamectin benzoate.

Eprinomectin is chemically known as 4″-epi-Acetylamino-4″-deoxy-avermectin B₁. Eprinomectin was specifically developed to be used in all cattle classes and age groups. It was the first avermectin to show broad-spectrum activity against both endo- and ecto-parasites while also leaving minimal residues in meat and milk. It has the additional advantage of being highly potent when delivered topically.

The composition of the present invention optionally comprises combinations of one or more of the following antiparasite compounds.

The antiparasite imidazo[1,2-b]pyridazine compounds as described by U.S. patent application Ser. No. 11/019,597, filed on Dec. 22, 2004, hereby incorporated by reference herein, see also WO05066177.

The antiparasite phenyl-3-(1H-pyrrol-2-yl)acrylonitrile compounds, as described by U.S. patent application Ser. No. 11/280,739, filed on Nov. 16, 2005, hereby incorporated by reference herein, see also WO06055565.

The antiparasite N-[(phenyloxy)phenyl]-1,1,1-trifluoromethanesulfonamide and N-[(phenylsulfanyl)phenyl]-1,1,1-trifluoromethanesulfonamide derivatives, as described by U.S. patent application Ser. No. 11/448,421, filed on Jun. 7, 2006, hereby incorporated by reference herein, see also WO06135648.

The antiparasite trifluoromethanesulfonanilide oxime ether compounds, as described by U.S. application Ser. No. 11/231,423, filed on Sep. 21, 2005, hereby incorporated by reference herein, see also WO06034333.

The compositions of the present invention may also further comprise a flukicide. Suitable flukicides include, for example, Triclabendazole, Fenbendazole, Albendazole, Clorsulon and Oxibendazole. It will be appreciated that the above combinations may further include combinations of antibiotic, antiparasitic and anti-fluke active compounds.

In addition to the above combinations, it is also contemplated to provide combinations of the inventive methods and compounds, as described herein, with other animal health remedies such as trace elements, anti-inflammatories, anti-infectives, hormones, dermatological preparations, including antiseptics and disinfectants, and immunobiologicals such as vaccines and antisera for the prevention of disease.

For example, such antinfectives include one or more antibiotics that are optionally co-administered during treatment using the inventive compounds or methods, e.g., in a combined composition and/or in separate dosage forms. Art-known antibiotics suitable for this purpose include, for example, those listed hereinbelow.

One useful antibiotic is Florfenicol, also known as D-(threo)-1-(4-methylsulfonylphenyl)-2-dichloroacetamido-3-fluoro-1-propanol. Another preferred antibiotic compound is D-(threo)-1-(4-methylsulfonylphenyl)-2-difluoroacetamido-3-fluoro-1-propanol. Other florfenicol analogs and/or prodrugs have been disclosed and such analogs also can be used in the compositions and methods of the present invention [see e.g., U.S. Pat. No. 7,041,670, U.S. Pat. No. 7,153,842, U.S. patent application Ser. No. 11/018,156, filed on Dec. 21, 2004, and U.S. patent application Ser. No. 11/611,997, filed Dec. 18, 2006, all of which are hereby incorporated by reference in their entireties]. When the antibiotic compound is Florfenicol, a florfenicol analog, or a fenicol prodrug, the concentration of antibiotic typically is from about 10% to about 50% w/v, with the preferred level between about 20% and about 40% w/v, even more preferred being at least about 30% w/v.

Another useful antibiotic is Thiamphenicol. Processes for the manufacture of these antibiotic compounds, and intermediates useful in such processes, are described in U.S. Pat. Nos. 4,311,857; 4,582,918; 4,973,750; 4,876,352; 5,227,494; 4,743,700; 5,567,844; 5,105,009; 5,382,673; 5,352,832; and 5,663,361, hereby incorporated by reference.

Another useful antibiotic compound is Tilmicosin. Tilmicosin is a macrolide antibiotic that is chemically defined as 20-dihydro-20-deoxy-20-(cis-3,5-dimethylpiperidin-1-yl)-desmycosin and which is reportedly disclosed in U.S. Pat. No. 4,820,695, hereby incorporated by reference. Also disclosed in U.S. Pat. No. 4,820,695 is an injectable, aqueous formulation comprising 50% (by volume) propylene glycol, 4% (by volume) benzyl alcohol, and 50 to 500 mg/ml of active ingredient. Tilmicosin may be present as the base or as a phosphate. Tilmicosin has been found to be useful in treatment of respiratory infections, particularly Pasteurella haemolytica infections in cattle when administered by injection over a 4 day treatment period. Accordingly, Tilmicosin may be used in treatment of, for example, neonatal calf pneumonia and bovine respiratory disease. When Tilmicosin is present, it is present in an amount of about 1% to about 50%, preferably 10% to about 50%, and in a particular embodiment, 30%.

Another useful antibiotic for use in the present invention is Tulathromycin. Tulathromycin has the following chemical structure.

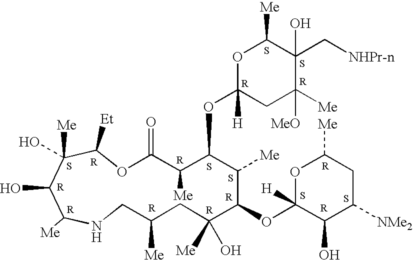

Tulathromycin may be identified as 1-oxa-6-azacyclopentadecan-15-one, 13-[(2,6-dideoxy-3-C-methyl-3-O-methyl-4-C-[(propylamino)methyl]-alpha-L-ribo-hexopyranosyl]oxy]-2-ethyl-3,4,0-trihydroxy-3,5,8,10,12,14-hexamethyl-11-[[3,4,6-trideoxy-3-(dimethylamino)-beta-D-xylo-hexopyranosyl]oxy]-, (2R,3S,4R,5R,8R,10R,11R,12S,13S,14R). Tulathromycin may be prepared in accordance with the procedures set forth in U.S. Patent Publication No. 2003/0064939 A1, which is hereby incorporated by reference in its entirety. Tulathromycin may be present in injectable dosage forms at concentration levels ranging from about 5.0% to about 70% by weight. Tulathromycin is most desirably administered in dosages ranging from about 0.2 mg per kg body weight per day (mg/kg/day) to about 200 mg/kg/day in single or divided doses (i.e., from 1 to 4 doses per day), and more preferably 1.25, 2.5 or 5 mg/kg once or twice weekly, although variations will necessarily occur depending upon the species, weight and condition of the subject being treated. Tulathromycin may be present in injectable dosage forms at concentration levels ranging from about 5.0% to about 70% by weight.

Further antibiotics for use in the present invention include the cephalosporins such as, for example, Ceftiofur, Cefquinome, etc. The concentration of the cephalosporin in the formulation of the present invention optionally varies between about 1 mg/ml to 500 mg/ml.

Another useful antibiotic includes the fluoroquinolones, such as, for example, Enrofloxacin, Danofloxacin, Difloxacin, Orbifloxacin and Marbofloxacin. In the case of Enrofloxacin, it may be administered in a concentration of about 100 mg/ml. Danofloxacin may be present in a concentration of about 180 mg/ml.

Other useful macrolide antibiotics include compounds from the class of ketolides, or, more specifically, the azalides. Such compounds are described in, for example, U.S. Pat. Nos. 6,514,945, 6,472,371, 6,270,768, 6,437,151 and 6,271,255, and U.S. Pat. Nos. 6,239,112, 5,958,888, and U.S. Pat. Nos. 6,339,063 and 6,054,434, all of which are hereby incorporated by reference in their entireties.

Other useful antibiotics include the tetracyclines, particularly chlortetracycline and oxytetracycline. Other antibiotics may include p-lactams such as penicillins, e.g., Penicillin, Ampicillin, Amoxicillin, or a combination of Amoxicillin with Clavulanic acid or other beta lactamase inhibitors

Additionally, the present invention optionally includes a composition for the treatment of a microbial and parasitic infection in an animal that comprises one or more of the above-listed antibiotics admixed and/or in combination with one or more of the inventive compounds, and an optional carrier and/or excipient.

Further, it is also contemplated that the inventive methods and compounds be advantageously employed in combination, simultaneously or sequentially, with art-known animal health remedies e.g., trace elements, vitamins, anti-inflammatories, anti-infectives and the like, in the same or different compositions.

### Preparation of Inventive Compounds

The compounds of the invention can be prepared by a number of methods. Simply by way of example, and without limitation, the compounds can be prepared using one or more of the reaction schemes and methods described below. Some of the compounds useful in this invention are also exemplified by the following preparative examples, which should not be construed to limit the scope of the disclosure.

The following solvents and reagents may be referred to herein by the abbreviations indicated: acetic acid (AcOH), aluminium trichloride (AlCl₃), ammonium chloride (NH₄Cl), boron trichloride (BCl₃), n-butylamine (n-BuNH₂), cuprous chloride (CuCl), 1,2-dichloroethane (DCE), CH₂Cl₂ (CH₂Cl₂), diethyl azodicarboxylate (DEAD), diethyl ether (Et₂O), N,N-dimethylethylenediamine [H₂N(CH₂)₂N(CH₃)₂], N,N-dimethylformamide (DMF), dimethyl sulfoxide (DMSO), ethanol (EtOH), ethyl acetate (EtOAc), hydrazine monohydrate (N₂H₄, H₂O), hydrochloric acid (HCl), hydrogen (H₂), iron powder (Fe), iodomethane (Mel), magnesium sulfate (MgSO₄), methanol (MeOH), nitric acid (HNO₃), petroleum ether; b.p. 40-60° C. (PE), platinum oxide (PtO₂), potassium permanganate (KMnO₄), sodium acetate (NaOAc), sodium carbonate (Na₂CO₃), sodium hydride (NaH), sodium hydrosulfite (Na₂S₂O₄), sulfuric acid (H₂SO₄), triethylamine (Et₃N), trifluoromethanesulfonic anhydride [(CF₃SO₂)₂O], triphenylphosphine (PPh₃), water (H₂O). “RT” is room temperature.

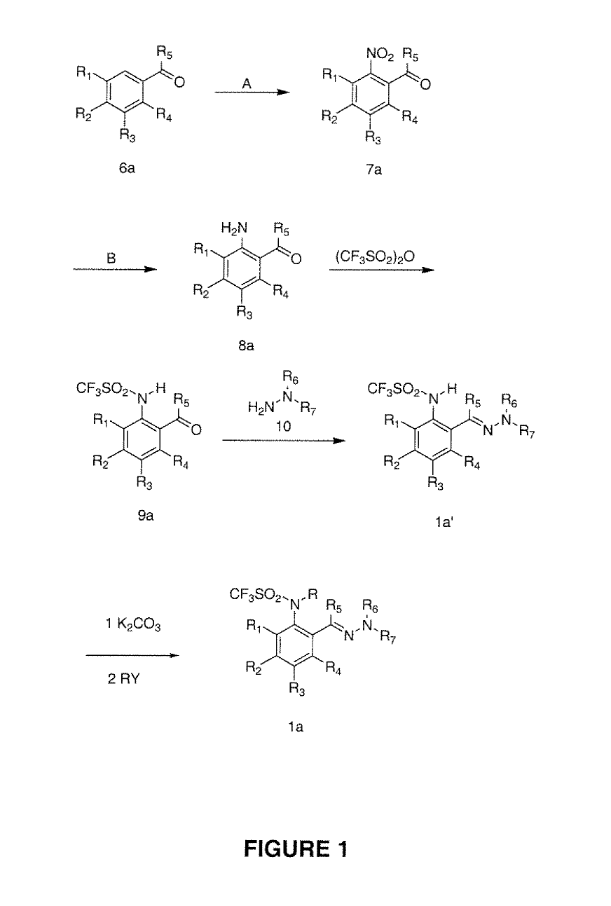

Preferred methods of synthesis of the compounds of Formula 1a, wherein R₁, R₂, R₃ and R₄ are independently selected from hydrogen, alkyl, alkoxy or halo, R₅ is alkyl, and R₆ and R₇ are the same as that set forth above, generally commence from R₅-substituted aryl ketone derivatives of Formula 6a as shown in Reaction Scheme 1 of FIG. 1.

Thus, by way of a nonlimiting example, and with reference to FIG. 1, the reaction of R₅-substituted aryl ketone derivatives of the Formula 6a with a mixture of fuming nitric and concentrated sulfuric acids affords R₅-substituted ortho-nitroaryl ketone compounds of Formula 7a using the procedure reported by Simpson, J. C. E. et al., O. J. Chem. Soc., 1945, 646-657. Reduction of the nitro group is preferentially achieved with iron powder in the presence of an acid such as NH₄Cl (using the method reported by Tsuji, K., et al., Chem. Pharm. Bull., 1992, 40, 2399-2409), or alternatively with PtO₂/H₂ (using the general method by Leonard, N. J., et alt, J. Org. Chem., 1946, 11, 405-418), to afford R₅-substituted ortho-aminoaryl ketone compounds of Formula 8a, Compounds of Formula 8a are dissolved in a solvent such as CH₂Cl₂ and treated with trifluoromethanesulfonic anhydride to yield N-phenyl-1,1,1-trifluoromethanesulfonamide compounds of Formula 9a (using a modification of the procedure by Harrington, J. K., et al., J. Med. Chem., 1970, 13, 137). Compounds of Formula 9a are dissolved in a solvent such as EtOH and reacted with R₆, R₇-substituted hydrazine derivatives of Formula 10 at room temperature or at elevated temperature to afford N-phenyl-1,1,1-trifluoromethanesulfonamide hydrazone derivatives of Formula 1a. In some cases an acid salt of a hydrazine of Formula 10 is reacted with the ketone compound of Formula 9a in a solvent such as ethanol in the presence of a base such as K₂CO₃ or potassium acetate. Compounds of Formula 1a are obtained as either single isomers or as a mixture of E- and Z-hydrazone derivatives.

The hydrazine derivatives of Formula 10 can be made by well established methods, for example, preparation of N-(substituted) alkyl-hydrazines (Jensen-Korte, U., Methoden der organischen Chemie, 1990, Band 16a/Teil 1, 425-468); preparation of N,N-(substituted) dialkyl-hydrazines (Jensen-Korte, U., Methoden der organischen Chemie, 1990, Band 16a/Teil 1, 469-503); preparation of N-(substituted) phenyl-hydrazines (Mueller, N., Methoden der organischen Chemie, 1990, Band 16a/Teil 1, 648-673); preparation of N-(substituted) heteroaryl-hydrazines (Mueller, N., Methoden der organischen Chemie, 1990, Band 16e/Teil 1, 678-793), preparation of N-(substituted) alkyl-N-(substituted) aryl-hydrazines (Mueller, N., Methoden der organischen Chemie, 1990, Band 16a/Teil 1, 588-600).

A preferred method of preparing hydrazines of Formula 10 wherein R₆ is (substituted) alkyl and R₇ is

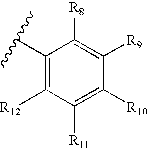

wherein R₈-R₁₂ are independently selected from the following: hydrogen, cyano, halo and the following optionally substituted moieties: alkyl, cycloalkyl, aryl, heterocyclyl, heteroaryl, alkoxy, cycloalkoxy, aryloxy, heteroaryloxy, heterocyclyloxy, haloalkyl, haloalkoxy involves commencing from the corresponding hydrazine of Formula 10 wherein R₇ is

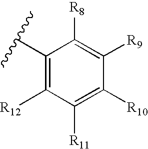

wherein R₈-R₁₂ are independently selected from the following: hydrogen, cyano, halo and the following optionally substituted moieties: alkyl, cycloalkyl, aryl, heterocyclyl, heteroaryl, alkoxy, cycloalkoxy, aryloxy, heteroaryloxy, heterocyclyloxy, haloalkyl, haloalkoxy, and

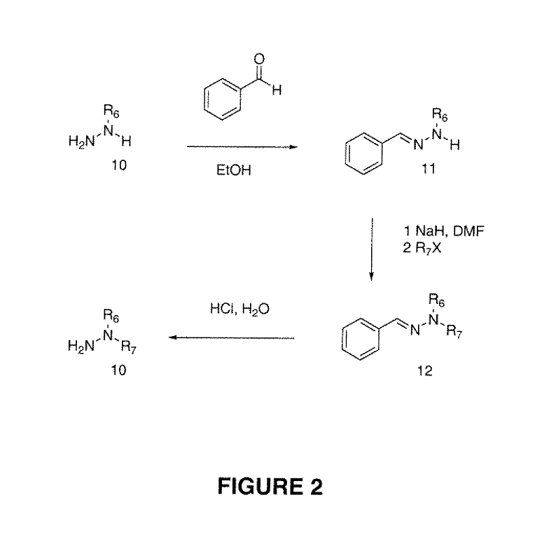

R₆ is hydrogen, as is shown in Reaction Scheme 2 of FIG. 2. Thus a hydrazine of Formula 10 as defined above wherein R₆ is hydrogen is reacted with benzaldehyde to form the corresponding hydrazone derivative of Formula 11. The hydrazone derivative of Formula 11 is treated with a base such as for example sodium hydride and then reacted with a (substituted) alkyl halide to form the corresponding hydrazone of Formula 12 wherein R₆ is (substituted) alkyl. This hydrazone derivative is then hydrolysed to afford the corresponding hydrazine of Formula 10 wherein R₆ is (substituted) alkyl and R₇ is

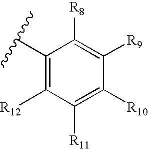

wherein R₈-R₁₂ are independently selected from the following: hydrogen, cyano, halo and the following optionally substituted moieties: alkyl, cycloalkyl, aryl, heterocyclyl, heteroaryl, alkoxy, cycloalkoxy, aryloxy, heteroaryloxy, heterocyclyloxy, haloalkyl, haloalkoxy. A preferred method of hydrolysis involves heating the hydrazone of Formula 12 in aqueous hydrochloric acid with continuous removal by steam distillation of the liberated benzaldehyde. Evaporation of the aqueous hydrochloric acid then affords the hydrazine of Formula 10 wherein R₆ is (substituted) alkyl and R₇ is

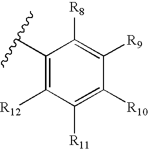

wherein R₈-R₁₂ are independently selected from the following: hydrogen, cyano, halo and the following optionally substituted moieties: alkyl, cycloalkyl, aryl, heterocyclyl, heteroaryl, alkoxy, cycloalkoxy, aryloxy, heteroaryloxy, heterocyclyloxy, haloalkyl, haloalkoxy as a hydrochloride salt.

A preferred method for preparing compounds of Formula 1a, wherein R₁, R₂, R₃, and R₄ are independently selected from hydrogen or halo, R₅ is hydrogen and R₆ and R₇ are the same as that set forth above, involves commencing from an ortho-nitrobenzaldehyde derivative of Formula 7a (wherein R₅ is hydrogen). Reduction of the nitro group with Na₂S₂O₄, in the presence of a base such as Na₂CO₃, affords ortho-aminobenzaldehyde compounds of Formula 7a (using the method of Horner, J. K., et al., J. Med. Chem. 1968, 11, 946-949) which are converted in two steps to N-phenyl-1,1,1-trifluoromethanesulfonamide hydrazone derivatives of Formula 1a using the methods illustrated in Reaction Scheme 1.

A preferred method for preparing compounds Formula 1a, wherein R₁, R₂, R₃, and R₄ are independently selected from hydrogen or halo, R₅ is (optionally substituted)aryl and R₆ and R₇ are the same as that set forth above, commences from an ortho-aminobenzophenone derivative of Formula 8a [wherein R₅ is (optionally substituted)aryl] as shown in Scheme 1. Compounds of Formula 8a are then converted in two steps to N-phenyl-1,1,1-trifluoromethanesulfonamide hydrazone derivatives of Formula 1a using the methods illustrated in Reaction Scheme 1 of FIG. 1.

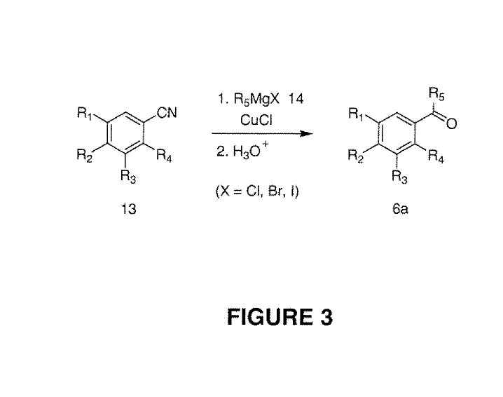

A preferred method for preparing compounds of Formula 1a, wherein R₁, R₂, R₃, and R₄ are independently selected from hydrogen or halo, R₅ is alkyl, alkenyl, cycloalkyl, (optionally substituted)aryl, (optionally substituted)arylalkyl, (optionally substituted)heteroaryl, haloalkyl or haloalkenyl and R₆ and R₇ are the same as that set forth above, commences from arylnitrile derivatives of Formula 13 as shown in Reaction Scheme 3 of FIG. 3.

Thus, by way of a nonlimiting example, reaction of an arylnitrile derivative of Formula 13 with an appropriate organomagnesium halide of Formula 14, in the presence of a catalytic amount of a copper salt such as CuCl, affords R₅-substituted aryl ketone derivatives of Formula 6a (using the procedure by Weiberth, F. J., et al., J. Org. Chem., 1987, 52, 3901-3904). Compounds of Formula 6a are then converted in four steps to N-phenyl-1,1,1-trifluoromethanesulfonamide hydrazone derivatives of Formula 1a using the methods illustrated in Reaction Scheme 1 of FIG. 1.

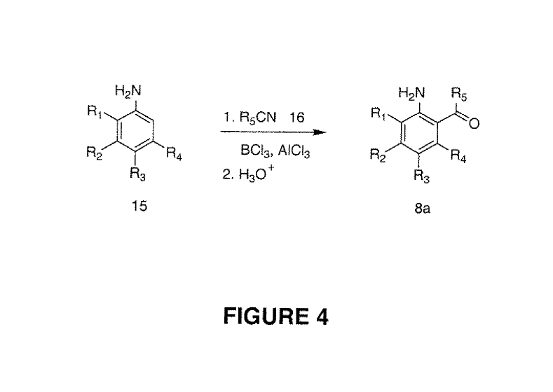

A further preferred method for preparing compounds of Formula 1a, wherein R₁, R₂, R₃, and R₄ are independently selected from hydrogen or halo, R₅ is alkyl, alkenyl, cycloalkyl, (optionally substituted)aryl, (optionally substituted) arylalkyl, (optionally substituted) heteroaryl, (optionally substituted) heterocyclyl, haloalkyl or haloalkenyl, involves commencing from aniline derivatives of Formula 15 as shown in Reaction Scheme 4 of FIG. 4.

Thus, by way of a nonlimiting example, anilines of Formula 15 can be ortho-acylated with an R₅-substituted nitrile of Formula 16 in the presence of a stoichiometric amount of BCl₃ and AlCl₃ (using the method of Sugasawa, T., et al., J. Am. Chem. Soc., 1978, 100, 4842-4852). This method gives compounds of Formula 8a which are then converted in two steps to N-phenyl-1,1,1-trifluoromethanesulfonamide hydrazone derivatives of Formula 1a using the processes illustrated in Reaction Scheme 1 of FIG. 1.

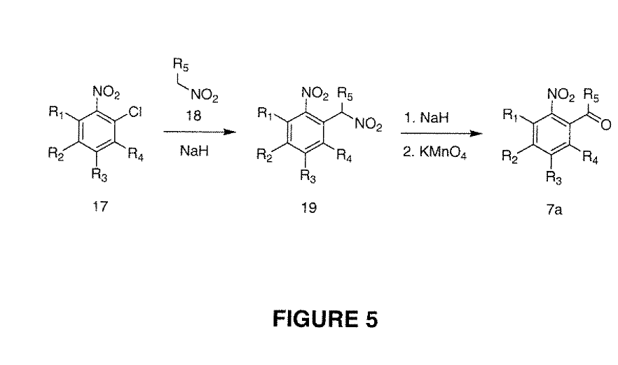

A preferred method for preparing compounds of Formula 1a, wherein R₁, R₂, R₃, and R₄ are independently selected from hydrogen or haloalkyl, R₅ is alkyl and R₆ is the same as that set forth above, involves commencing from ortho-nitroaryl chloride derivatives of Formula 17 as shown in Reaction Scheme 5 of FIG. 5.

Thus, by way of a nonlimiting example, reaction of an ortho-nitroaryl chloride of Formula 17 with the disodio salt of an appropriate R₅-substituted nitroalkane of Formula 18 affords α-aryl R₅-substituted nitroalkane derivatives of Formula 19 (using a modification of a procedure by Reid, J. G., et al. Tetrahedron Lett., 1990, 31, 1093-1096). Subjecting compounds of Formula 19 to an oxidative Nef reaction (using the procedure of Komblum, N. et al., J. Org. Chem., 1982, 47, 4534-4538) affords compounds of Formula 7a, which are then converted in three steps to N-phenyl-1,1,1-trifluoromethanesulfonamide hydrazone derivatives of Formula 1a using the methods illustrated in Reaction Scheme 1 of FIG. 1.

Some preferred methods of making compounds of Formula 1a, 1b and 1c wherein R₇ is

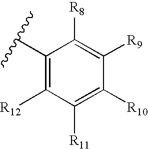

wherein R₈-R₁₂ are as defined supra, and R₆ is alkyl or substituted alkyl involves the reaction of the corresponding hydrazone compound of Formula 1a, 1b and 1c wherein R₆ is hydrogen with a base such as sodium hydride in an aprotic solvent such as DMF at 0° C., followed by treatment with an electrophile such as an alkyl halide (these methods have been reviewed by Kim, S. and Yoon, J. Y. in Science of Synthesis, 2004, 27, 695-696).

A preferred method of preparing compounds of Formula 1a, 1b, and 1c, wherein R is other than hydrogen, involves the reaction of a compound of Formula 1a, 1b, and 1c wherein R is H, with a base, e.g., potassium carbonate, followed by reaction with an electrophilic reagent RY, wherein R is as defined above, and Y is a leaving group such as chloride, bromide, iodide or an alkylsulfonate or arylsulfonate. By way of non-limiting examples the base may be an inorganic base such as potassium carbonate or an organic base such as triethylamine. For example, reaction of a compound of Formula 1a, 1b and 1c wherein R is H with (substituted) alkyl halides or (substituted) alkenyl halides or (substituted) alkynyl halides in the presence of potassium carbonate affords the corresponding compounds of Formula 1a, 1b, and 1c wherein R is (substituted) alkyl or (substituted) alkenyl or (substituted) alkynyl; reaction of a compound of Formula 1a, 1b and 1c wherein R is H with alkoxymethyl chloride in the presence of potassium carbonate affords the corresponding compound of Formula 1a, 1b, and 1c wherein R is alkoxymethyl; reaction of a compound of Formula 1a, 1b, and 1c wherein H is H with alkoxycarbonylalkyl chloride in the presence of potassium carbonate affords the corresponding compound of Formula 1a, 1b, and 1c, wherein R is alkoxycarbonylalkyl; reaction of a compound of Formula 1a, 1b, and 1c wherein R is H with acyl chlorides in the presence of a base, such as triethylamine, in methylene chloride affords the corresponding compound of Formula 1a, 1b and 1c wherein R is aroyl (according to the method of Hendrickson, J. B., et al., Journal of the American Chemical Society, 1973, 95, 3412-3413, incorporated by reference herein); reaction of a compound of Formula 1a, 1b, and 1c wherein R is H with alkylchloroformates affords the corresponding compound of Formula 1a, 1b and 1c wherein R is alkoxycarbonyl (according to the method of DE 2,118,190, incorporated by reference herein); reaction of a compound of Formula 1a, 1b, and 1c wherein R is H with arylisocyanates or arylisothiocyanates in the presence of either aqueous sodium hydroxide and acetone or triethylamine in toluene affords the corresponding compounds of Formula 1a, 1b and 1c wherein R is N-arylcarbamoyl or N-arylthiocarbamoyl (according to the method of Howbert, et al., Journal of Medicinal Chemistry, 1990, 33, 2393-2407, incorporated by reference herein).

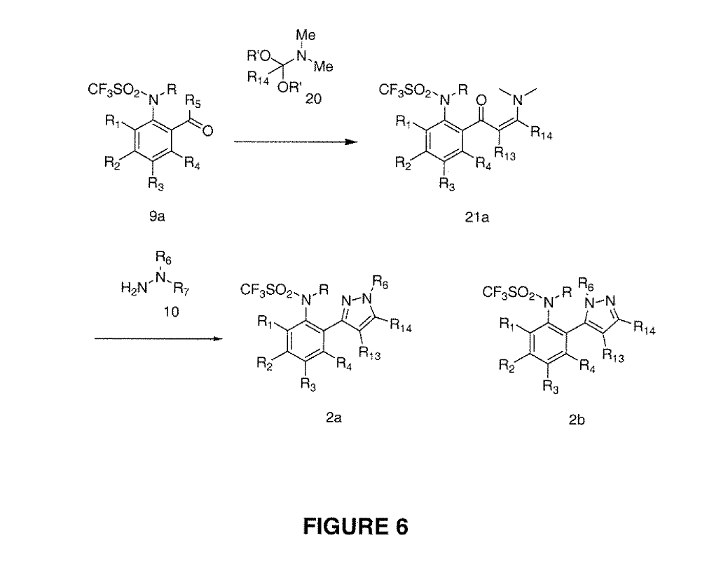

Preferred methods of synthesis of the compounds of Formula 2a and 2b wherein R₁, R₂, R₃ and R₄ are independently selected from hydrogen, alkyl, alkoxy or halo, R₅ is alkyl, and R₆ is the same as that set forth above, generally commence from R₅-substituted aryl ketone derivatives of Formula 9a as shown in Reaction Scheme 6 of FIG. 6.

Thus, by way of a nonlimiting example, reaction of a ketone derivative of Formula 9a with an N,N-dimethyl-(1,1-dialkoxy)alkylamine compound of Formula 20 affords an enone derivative of Formula 21a that is reacted with a hydrazine derivative of Formula 10 wherein R₇ is hydrogen. Depending upon the nature of the hydrazine derivative and the reaction conditions, this reaction sequence provides a pyrazole derivative of Formula 2a and/or an isomeric pyrazole of Formula 2b.

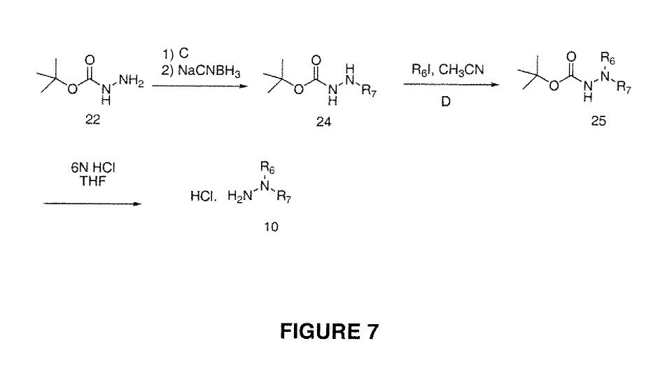

A preferred method for preparing hydrazines of Formula 10 wherein R₆ is alkyl and R₇ is (substituted) cycloalkyl or (substituted) heterocycyl commences from tert-butyl carbazate as shown in Reaction Scheme 7 of FIG. 7. Thus, by way of a nonlimiting example, tert-butyl carbazate 22 is condensed with an alicyclic ketone or heterocyclic ketone and the C═N double bond of the condensation product is reduced with sodium cyanoborohydride in acetic acid/water (according to the method of Ranatunge, R. R.; Augustyniak, M.; Bandarage, U. K.; Earl, R. A.; Ellis, J. L.; Garvey, D. S.; Janero, D. R.; Letts, L. G.; Martino; A. M.; Murty, M. G.; Richardson, S. K.; Schroeder, J. D.; Shumway, M. J.; Tam, S. W.; Trocha, A. M.; and Young, D. V., J. Med. Chem. 2004, 47, 2180-2193) to give compounds of Formula 24 wherein R₇ is (substituted) cycloalkyl or (substituted) heterocycyl. Compounds 24 are selectively alkylated on the nitrogen bearing the cycloalkyl or heterocyclyl group by treatment with suitable electrophiles in the presence of a base such as potassium carbonate and using microwave heating where necessary to give compounds of Formula 25. Subjecting compounds of Formula 25 to conditions prone to effect cleavage of the tert-butoxy carbonyl group gives hydrazones of Formula 10 or salts thereof. Thus, by way of a nonlimiting example, compounds of Formula 25 were treated with 6N hydrochloric acid in tetrahydrofuran to give, after evaporation, the hydrochloride salt of compounds of Formula 10, wherein R₇ is (substituted) cycloalkyl or (substituted) heterocycyl.

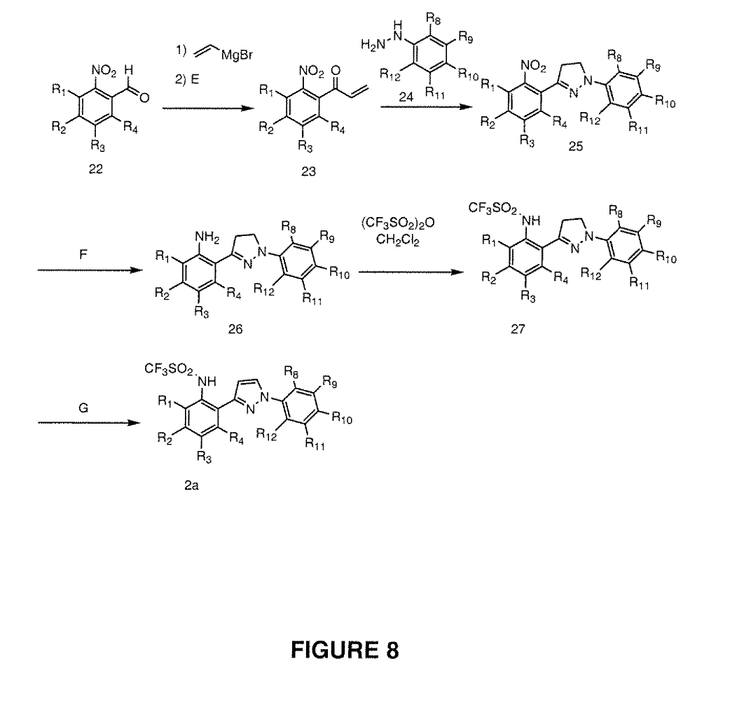

A preferred method for preparing 1,3-diarylpyrazolines of Formula 1a wherein R═H, Ram R₂, R₃, R₄ are independently selected from hydrogen, (C₁-C₆)alkyl, (C₁-C₆)alkoxy or halo, R₅, R₆ together form the linkage —CH₂—CH₂— and R₇ is the group:

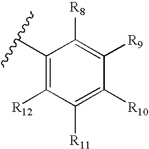

wherein R₈-R₁₂ are independently selected from the following: hydrogen, cyano, halo and the following optionally substituted moieties: alkyl, cycloalkyl, aryl, heterocyclyl, heteroaryl, alkoxy, cycloalkoxy, aryloxy, heteroaryloxy, heterocyclyloxy, haloalkyl, haloalkoxy, is shown in Reaction Scheme 8 of FIG. 8. Thus, by way of a nonlimiting example, the enone derivative of Formula 23 is prepared in 2 steps according to the method of Shen, W.; Coburn, C. A.; Bornmann, W. G. and Danishefsky, S. J., J. Org. Chem. 1993, 58, 611-617, whereby a 2-nitrobenzaldehyde of Formula 22 undergoes addition with vinyl magnesium bromide and the resultant allylic alcohol is oxidised using Jones' reagent. The enone of Formula 23 thus obtained is reacted with a phenyl hydrazine of Formula 24, wherein R₈-R₁₂ are the same as that set forth above, using a modification of the method of Mannich, C. and Lammering, D., Chem. Ber., 1922, 55, 3510, to give 1,3-diarylpyrazolines of Formula 25. Reduction of the nitro group to give the aryl amine of Formula 26 is preferentially achieved with tin (11) chloride in ethanol (using the method reported by Camacho, E.; Leon, J.; Entrena, A.; Velasco, G.; Carrion, M. D.; Escames, G.; Vivó, A.; Acuha-Castroviejo, D.; Gallo, M. A. and Espinosa, A., J. Med. Chem. 2004, 47, 5641.) or by catalytic hydrogenation in acetic acid in the presence of hydrochloric acid. Treatment of the aromatic amines of Formula 26 with trifluoromethanesulfonic anhydride in dichloromethane gives 1,3-diarylpyrazolines of Formula 27; these are compounds of Formula 1a, wherein R₅ and R₆ together form the linkage —CH₂CH₂— and R₇ is substituted aryl.

A preferred method for preparing 1,3-diarylpyrazoles of Formula 2a, wherein R═H, R₁, R₂, R₃, and R₄ are independently selected from hydrogen or halo, R₁₃, R₁₄═H and R₆ is the group:

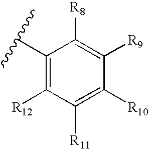

wherein R₈-R₁₂ are independently selected from the following: hydrogen, cyano, halo and the following optionally substituted moieties: alkyl, cycloalkyl, aryl, heterocyclyl, heteroaryl, alkoxy, cycloalkoxy, aryloxy, heteroaryloxy, heterocyclyloxy, haloalkyl, haloalkoxy, involves the oxidation of compounds of Formula 27 with a suitable oxidizing agent. Thus, by way of a nonlimiting example, reaction of a compound of Formula 27 with 2,3-dichloro-5,6-dicyano-1,4-benzoquinone in dichloromethane gives 1,3-diarylpyrazoles of Formula 2a.

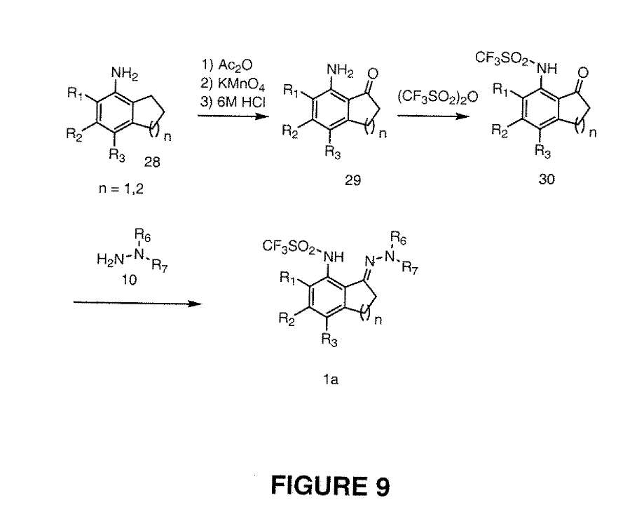

A preferred method for preparing hydrazones of Formula 1a wherein R═H, R₁, R₂, R₃ are independently selected from hydrogen, (C₁-C₆)alkyl, (C₁-C₆)alkoxy or halo, R₄ and R₅ form part of the same 5- or 6-membered carbocyclic ring, and R₆ and R₇ are the same as that set forth above, is shown in Reaction Scheme 9 of FIG. 9. Thus, by way of a nonlimiting example 8-amino-3,4-dihydro-2H-naphthalen-1-one, a compound of Formula 29 wherein R₁, R₂ and R₃ are hydrogen, was prepared in three steps from 5,6,7,8-tetrahydro-1-naphthylamine, a compound of Formula 28 wherein R₁ and R₂ are hydrogen, R₃ is chloro and n=2, according to the procedure of Nguyen, P.; Corpuz, E.; Heidelbaugh, T. M.; Chow, K. and Garst, M. E., J. Org. Chem. 2003, 68, 10195-10198 and treated with trifluoromethanesulfonic anhydride to give N-(8-oxo-5,6,7,8-tetrahydro-naphthalen-1-yl)-trifluoromethanesulfonamide, a compound of Formula 30 wherein R₁ and R₂ are hydrogen, R₃ is chloro and n=2. Reaction of a ketone of Formula 30 with hydrazines 10 gives hydrazones of Formula 1a wherein R₄ and R₅ form part of the same 5- or 6-membered carbocyclic ring.

### Animals to be Treated

The present invention provides compounds and/or compositions for use in the prevention and/or treatment of infestation, diseases and/or related disorders caused by, or as a result of, parasites or other pests that are killed or inhibited (e.g., growth-suppressed) by such compounds and/or compositions. The animal is preferably a vertebrate, and more preferably a mammal, avian or fish. The compound or composition may be administered directly to the animal subject and/or indirectly by applying it to the local environment in which the animal dwells (such as bedding, enclosures, or the like). Appropriate animal subjects include those in the wild, livestock (e.g., raised for meat, milk, butter, eggs, fur, leather, feathers and/or wool), beasts of burden, research animals, companion animals, as well as those raised for/in zoos, wild habitats and/or circuses.

In a particular embodiment, the animal subject is a mammal (including great apes such as humans). Other mammalian subjects include primates (e.g., monkeys), bovine (e.g., cattle or dairy cows), porcine (e.g., hogs or pigs), ovine (e.g., goats or sheep), equine (e.g., horses), canine (e.g., dogs), feline (e.g., house cats), camels, deer, antelopes, rabbits, and rodents (e.g., guinea pigs, squirrels, rats, mice, gerbils, and hamsters). Avians include Anatidae (swans, ducks and geese), Columbidae (e.g., doves and pigeons), Phasianidae (e.g., partridges, grouse and turkeys), Thesienidae (e.g., domestic chickens), Psittacines (e.g., parakeets, macaws, and parrots), game birds, and ratites, (e.g., ostriches).

Birds treated or protected by the inventive compounds can be associated with either commercial or noncommercial aviculture. These include e.g., Anatidae, such as swans, geese, and ducks, Columbidae, e.g., doves and pigeons, such as domestic pigeons, Phasianidae, e.g., partridge, grouse and turkeys, Thesienidae, e.g., domestic chickens, Psittacines, e.g., parakeets, macaws, and parrots, e.g., raised for the pet or collector market, among others.

For purposes of the present invention, the term “fish” shall be understood to include without limitation, the Teleosti grouping of fish, i.e., teleosts. Both the Salmoniformes order (which includes the Salmonidae family) and the Perciformes order (which includes the Centrarchidae family) are contained within the Teleosti grouping. Examples of potential fish recipients include the Salmonidee family, the Serranidae family, the Sparidae family, the Cichlidae family, the Centrarchidae family, the three-Line Grunt (Parapristipoma trilineatum), and the Blue-Eyed Plecostomus (Plecostomus spp), among others.

Other animals are also contemplated to benefit from the inventive compounds, including marsupials (such as kangaroos), reptiles (such as farmed turtles) and other economically important domestic animals for which the inventive compounds are safe and effective in treating or preventing parasite infection or infestation.

### Crops to be Treated

The inventive compounds are also contemplated to be active against agricultural pests that attack plants. In particular, plants include crops of economic or other importance, i.e., in agriculture and related endeavers. Agricultural pests contemplated to be controlled by the inventive compounds include, for example, insect pests. Insect pests include those that can attack stored grains, e.g., Tribolium sp., Tenebrio sp. Other agricultural pests include spider mites (Tetranychus sp.), aphids (Acyrthiosiphon sp.), migratory orthopterans such as locusts, and the immature stages of insects that live on plant tissue such as the Southern army worm and Mexican bean beetle larvae.

Further pests of agricultural importance include, e.g., Acrobasis vaccinii, Agrotis spp, Alsophila pometaria, Archips spp, Argyrotaenia citrana, A velutinana, Autographa californica, Bacillus thuringiensis, Callopistria floridensis, Choristoneura fumiferana, C occidentalis, C pinus, C rosaceana, Cryptophlebia ombrodelta, Cydia (Laspeyresia) pomonella, C caryana, Dasychira pinicola, Datena ministra, Desmia funeralis, Diatrea saccharalis, Dichocrocis punctiferalis, Dioryctria zimmerman, Ectropis excursaria, Ematurga amitaria, Ennomos subsignaria, Eoreuma loftini, Epiplyas postvittena, Euproctis chrysorrhoea, Grapholita packardi, Hellula rogatafis, Homoeosoma vagella, Hyphantria cunea, Lambdina fiscellaria, Liphophane antennata, Lobesia botrana, Lophocampa maculeta, Lymantria dispar, Malecosoma spp, Manduca spp, Megalopyge opercularis, Mnesampela privata, Orgyia pseudotsugate, O vetusta, Ostrinia nubilalis, Platynota flavedana, P stuftana, Pseudaletia unipuncta, Rhopobote naevana, Rhyacionia spp, Spodoptera eridania, S exigua, S frugiperda, S ornithogalli, Thaumatopoea pityocampa, Thridopteryx ephemeraeformis, Thyrinzeina amobia, and others too numerous to mention.

Crops that can be treated with the inventive compounds and methods, in order to kill, remove or prevent infestation with crop-related pests include, e.g., alfalfa, blueberries, brassicas, brocolli, bush berries, cabbage, cane berries, clover, cole crops, cotton, cucumber, cranberries, currants, beet roots and tops, grapes, grapefruit, gooseberries, hay, huckleberries, kiwi fruit, leafy and fruiting vegetables, legumes, macadamia nuts, mint, ornamentals, peppers, potatoes, raspberry, shrubs, soy, sugarcane, starfruit, sunflower, squash, table beets, turnips, walnuts, the various grain grasses, including corn or maize, wheat, rye, rice, oats, barley, spelt, millet, etc. Trees are also contemplated to be treated by the inventive compounds and methods. Trees include those found in wild or cultivated forest, such as deciduous species, pine species and the like. Trees also include those cultivated as sources of lumber or paper, for shade or decoration (e.g., maple or pine), and/or for fruit or nut crops, such as trees yielding pome fruits (apples, pears etc.), stone fruits (cherries, plum, peach, nectarine and hybrids thereof), citrus fruits (grapefruit, orange, tangerine, lemon, lime, etc.), avocado, pecan, acorn, chestnut, palm trees (coconut, fig), breadfruit, and others too numerous to list.

### Susceptible Parasites

The inventive compounds are broadly described as endectoparasiticides, in that the inventive compounds include those that are active against ectoparasites (arthropods, acarines, etc.) and endoparasites (helminths, e.g., nematodes, trematodes, cestodes, canthocephalans, etc.), including pests that prey on agricultural crops and stored grains (spider mites, aphids, caterpillars, migratory orthopterans such as locusts). Protozoa parasites (Flagellata, Sarcodina Ciliophora, and Sporozoa, etc.) are also contemplated to be treated by the inventive compounds. The inventive compounds are also active against household pests, and particularly against arthropod pests, such as spiders, mites, and insects, including flies, mosquitoes, ants, termites, silverfish, cockroach, clothes moth, and a myriad of beetles and beetle larvae that impact households.

1. Helminths

The disease or group of diseases described generally as helminthiasis is due to infection of an animal host with parasitic worms known as helminths. Helminthiasis is a prevalent and serious economic problem with domesticated animals such as swine, sheep, horses, cattle, goats, dogs, cats and poultry. Among the Helminths, the group of worms described as nematodes causes widespread and at times serious infection in various species of animals. Nematodes that are contemplated to be treated by the inventive compounds include, without limitation, the following genera:

Acanthocheilonema, Aelurostrongylus, Ancylostoma, Angiostrongylus, Ascaridia, Ascards, Brugia, Bunostomum, Capillaria, Chabertia, Cooperd, Crenosoma, Dictyocaulus, Dioctophyme, Dipetaeonema, Diphyllobothdium, Diplydium, Dirorflaria, Dracunculus, Enterobius, Filaroides, Haemonchus, Heterakis, Lagochilascaris, Loa, Mansonella, Muellerius, Nanophyetus, Necator, Nematodfrus, Oesophagostomum, Opisthorchis, Ostertagia, Oxyuris, Parafilaria, Paragonimus, Parascaris, Physaloptere, Protostrongylus, Setara, Spirocerca, Spirometra, Stephanofilaria, Strongyloides, Strongylus, Thelazia, Toxascaris, Toxocara, Trichinella, Trichonema, Trichostrongylus, Trichuris, Uncinaria, and Wuchererda.

Of the above, the most common genera of nematodes infecting the animals referred to above are Haemonchus, Trichostrongylus, Ostertagia, Nemaodirus, Coopere, Ascares, Bunostomum, Oesophagostomum, Chabertia, Trichurds, Strongylus, Trichonema, Dictyocaulus, Capilleria, Heterakis, Toxocara, Ascarddia, Oxyurds, Ancylostoma, Unicinaria, Toxascaris and Parascaris. Certain of these, such as Nematodirus, Cooperia and Oesophagostomum attack primarily the intestinal tract while others, such as Haemonchus and Ostertagia, are more prevalent in the stomach while others such as Dictyocaulus are found in the lungs. Still other parasites may be located in other tissues such as the heart and blood vessels, subcutaneous and lymphatic tissue and the like. Table 1A, below, lists a number of these, by Family and Genus, that are of economic (medical and veterinary) importance.

TABLE 1A

| Class | Family | Genus (examples) |
|---|---|---|
| Trematoda | Fasciolidae | Fasciola |
| Cestoda | Anoplocephalidae | Moniezia |
| ″ | Dilepididae | Dipylidium |
| ″ | Taeniidae | Taenia, Echinococcus |
| Nematoda | Strongyloididae | Stongyloides |
| ″ | Strongylidae | Strongylus, Oesophagostomum |
| ″ | Syngamidae | Syngamus |
| ″ | Trichostrongylidae | Trichostrongylus, Cooperia, |
| | | Ostertagia, Haemonchus |
| ″ | Heligmonellidae | Nippostrongylus |
| ″ | Dictyocaulidae | Dictyocaulus |
| ″ | Ascarididae | Ascaris |
| ″ | Toxocaridae | Toxacara |
| ″ | Oxyuridae | Oxyuris |
| ″ | Filaridae | Parafilaria |
| ″ | Onchocercidae | Onchocerca |
| ″ | Trichinellidae | Trichinella |
| ″ | Trichuridae | Trichuris |
| ″ | Capillariidae | Capillaria |

The most common genera of parasites of the gastrointestinal tract of man are Ancylostoma, Necator, Ascaris, Strongyloides, Trichinella, Capillaria, Trichuris, and Enterobius. Other medically important genera of parasites which are found in the blood or other tissues and organs outside the gastrointestinal tract are the filarial worms such as Wuchereria, Brugia, Onchocerca and Loa, Dracunculus and extra intestinal stages of the intestinal worms Strongyloides and Trichinella.

Numerous other Helminth genera and species are known to the art, and are also contemplated to be treated by the compounds of the invention. These are enumerated in great detail in TEXTBOOK OF VETERINARY CLINICAL PARASITOLOGY, VOLUME 1, HELMINTHS, by E.J.L. Soulsby, Publ. F.A. Davis Co., Philadelphia, Pa.; HELMINTHS, ARTHROPODS AND PROTOZOA (Sixth Ed. Of MONNIG'S VETERINARY HELMINTHOLOGY AND ENTOMOLOGY) by E.J.L. Soulsby, Publ. The Williams and Wilkins Co., Baltimore, Md., the contents of both of which are incorporated by reference herein in their entireties.

The parasitic infections known as helminthiasis lead to anemia, malnutrition, weakness, weight loss, severe damage to the walls of the intestinal tract and other tissues and organs, and if left untreated, may result in death of the infected host. The compounds described herein have unexpectedly high activity against these parasites, and in addition are also active against Dirofilaria in dogs, and Namatospiroides, Syphacia, Aspiculuris in rodents. The inventive compounds are also useful as a nematocide for the control of soil nematodes and plant parasites such as Meloidogyne spp.

2. Arthropods

It is also contemplated that the inventive compounds are effective against a number of ectoparastides of animals, e.g., arthropod ectoparasites of mammals and birds. Athropods include those summarized in Table 1B, as follows.

TABLE 1B
Summary Of Taxonomy for Important Arthropod Pests

| Subphylum | Class | Order | Examples |
|---|---|---|---|
| Trilobita | | | |
| Cheliceratac | | | |
| helicera and | | | |
| pedipalps | | | |
| | Merostomata | | |
| | Arachnida | | |
| | | Araneae | spiders |
| | | Scorpionida | scorpions |
| | | Acari | mites and ticks |
| Uniramia | | | |
| | Chilopoda | | centipedes |
| | Diplopoda | | millipedes |
| | Pauropoda | | Soft bodied |
| | | | myriapods |
| | Insecta | | |
| | | Hymenoptera | bees, wasps |
| | | Lepidoptera | moths, |
| | | | butterflies |
| | | Hoptera | grasshoppers |
| | | Diptera | true flies |
| | | Hemiptera | true bugs |
| | | Coleoptera | beetles |

Thus, insect pests include, e.g., biting insects, such as flies and mosquitoes, mites, ticks, lice, fleas, true bugs, parasitic maggots, and the like.

Biting insects include, e.g., migrating diperous larvae as Hypoderma sp. in cattle, Gastrophilus in horses, and Cuterebra sp. in rodents, as well as biting flies and mosquitoes of all types. For example, bloodsucking adult flies include, e.g., the horn fly or Haematobia irritans, the horse fly or Tabanus spp., the stable fly or Stomoxys calcitrans, the black fly or Simulium spp., the deer fly or Chrysops spp., the louse fly or Melophagus ovinus, the tsetse fly or Iossina spp. Parasitic fly maggots include, e.g., the bot fly (Oestrus ovis and Cuterebra spp.], the blow fly or Phaenicia spp., the screwworm or Cochliomyia hominivorax, the cattle grub or Hypoderma spp., and the fleeceworm. Mosquitoes, include, for example, Culex spp., Anopheles spp., and Aedes spp.

Mites include Mesostigmata spp., e.g., mesostigmatids such as the chicken mite, Dermanyssus gailinae; itch or scab mites such as Sarcoptidae spp., for example, Sarcoptes scabiei; mange mites such as Psoroptidae spp., including Chorioptes bovis and Psoroptes ovis; chiggers, e.g., Trombiculidae spp., for example the North American chigger, Trombicula alfreddugesi.

Ticks include, e.g., soft-bodied ticks including Argasidae spp., for example Argas spp. and Ornithodoros spp.; hard-bodied ticks including Ixodidae spp., for example Rhipicephalus sanguineus, and Boophilus spp.

Lice include, e.g., sucking lice, e.g., Menopon spp. and Bovicola spp.; biting lice, e.g., Haematopinus spp., Linognathus spp. and Solenopotes spp.

Fleas include, e.g., Ctenocephalides spp., such as dog flea (Ctenocephalldes canis) and cat flea (Ctenocephalides felis); Xenopsylla Spp., such as oriental rat flea (Xenopsylla cheopis); and Pulex spp., such as human flea (Pulex irritans).

True bugs include, e.g., Cimicidae or e.g., the common bed bug (Cimex lectularius); Triatominae spp., including triatomid bugs also known as kissing bugs; for example Rhodnius prolixus and Triatoma spp.

Generally, flies, fleas, lice, mosquitoes, gnats, mites, ticks and helminths cause tremendous losses to the livestock and companion animal sectors. Arthropod parasites also are a nuisance to humans and can vector disease-causing organisms in humans and animals.

Numerous other arthropod pests and ectoparasites are known to the art, and are also contemplated to be treated by the compounds of the invention. These are enumerated in great detail in MEDICAL AND VETERINARY ENTOMOLOGY, by D. S. Kettle, Publ. John Wiley & Sons, New York and Toronto; CONTROL OF ARTHROPOD PESTS OF LIVESTOCK: A REVIEW OF TECHNOLOGY, by R. O. Drummand, J. E. George, and S. E. Kunz, Publ. CRC Press, Boca Raton, Fla., the contents of both of which are incorporated by reference herein in their entireties.

3. Protozoa

It is also contemplated that the inventive compounds are effective against a number of protozoa endoparasites of animals, including those summarized by Table 1C, as follows.

TABLE 1C
Exemplary Parasitic Protozoa and Associated Human Diseases

| | | Representative | Human Disease or |
|---|---|---|---|
| Phylum | Subphylum | Genera | Disorder |
| Sarcomas- | Mastigophora | Leishmania | Visceral, cutaneous |
| tigophora | (Flagella) | | and mucocutaneous |
| (with flagella, | | | Infection |
| pseudopodia, | | | |
| or both) | | | |
| | | Trypansoma | Sleeping sickness |
| | | | Chagas' disease |
| | | Giardia | Diarrhea |
| | | Trichomonas | Vaginitis |
| | Sarcodina | Entamoeba | Dysentery, liver |
| | (pseudopodia) | | Abscess |
| | | Dientamoeba | Colitis |
| | | Naegleria and | Central nervous |
| | | Acanthamoeba | system and |
| | | | corneal ulcers |
| | | Babesia | Babesiesis |
| Apicomplexa | | Plasmodium | Malaria |
| (apical | | Isospora | Diarrhea |
| complex) | | Sarcocystis | Diarrhea |
| | | Cryptosporidum | Diarrhea |
| | | Toxoplasma | Toxoplasmosis |
| Microspora | | Enterocytozoon | Diarrhea |
| Ciliephora | | Balantidium | Dysentery |
| (with cilia) | | | |
| Unclassified | | Pneumocystis | Pneumonia |

4. Animal Pests, Generally

Livestock pests will include parasites identified above as helminths, arthropods and protozoa. In addition, and simply by way of example, a number of agricultural arthropod pests are summarized by Table 1D, below, in association with exemplary livestock for which these pests are of economic significance.

TABLE 1D

| | |
|---|---|
| Companion | Mosquitoes, fleas, ticks, mites. |
| animals, e.g., | |
| canine and feline. | |
| Horses | Bot fly, Horse flies, Deer flies. |
| Cattle | Horn flies, Face flies, Lice, Ticks. |
| Sheep | Myiasid flies (eg screwworm), Lice |
| Poultry | Lesser Mealworms or Litter beetles. |
| General Pests | Rat-tailed maggots. |
| | Moth flies. |
| | Ants, including Allegheny mound ants. |

5. Crop Pests

Simply by way of example, a number of agricultural crop pests are summarized by Table 1E, in association with exemplary crops for which these pests are of economic significance.

TABLE 1E

| Crop | Parasite or Pest | Crop | Parasite or Pest |
|---|---|---|---|
| Alfalfa | | | Whiteflies |
| | Blister beetles, | | |
| | generally | | |
| | Clover Root | Potatoes | |
| | curculio | | |
| | Potato leafhoppers | | Colorado Potato |
| | | | beetle |
| Corn | | Peppers | |
| | Armyworms | | Beet Armyworm |
| | Corn borers, e.g, | | European Corn |
| | the Common Stalk | | borer |
| | borer and the | | |
| | European Corn | | |
| | borer | | |
| | Corn Leaf aphid | | Pepper Maggot |
| | Cutworm | Other | |
| | | Vegetables | |
| | Lesser Cornstalk | | Cabbage |
| | borer | | Webworm |
| | Seedcorn Maggots | | Cabbage insects, |
| | | | generally |
| | Southwestern Corn | | Squash Vine Borer |
| | Borer | | and Squash Bug |
| | Stink bugs | Greenhouse | |
| | Wireworms | | Float Plant pests, |
| | | | generally |
| Soybeans | | | Cyclamen mites |
| | | | (e.g., in a |
| | | | Greenhouse) |
| | Beetles, such as | Tree Fruits | |
| | the Japanese and | | |
| | the Bean Leaf | | |
| | beetles | | |
| | Cutworms | | Cherry Fruit flies |
| | Green cloverworm | | Codling moth |
| | Seedcorn maggot | | European Red mite |
| | Soybean podworm | | Green fruitworms |
| | | | Leafhoppers |
| | | | (e.g., on Apples) |
| Small | | | Leaf rollers |
| Grains | | | |
| | Aphids and Barley | | Oriental Fruit moth |
| | Yellow Dwarf | | |
| | Armyworms | | Peachtree borer |
| | generally, e.g., in | | |
| | small grains. | | |
| | Cereal Leaf beetle | | Rosy Apple aphid |
| | Hessian fly | | San Jose scale |
| | Wheat Streak | | Woolly Apple aphid |
| | Mosaic virus and | | |
| | the Wheat Curl | | |
| | mite | | |
| Stored | | | Lesser Peachtree |
| Grain | | | borer |
| | Beetles, such as | | Plum vurculio |
| | the Cadelle beetle | | |
| | and Flour beetle | | |
| | Indianmeal moth | Nuts | |
| | Lesser Grain borer | | Nut weevils |
| Greenhouse | | | Pecan Insects |
| Plants | | | |
| | Cyclamen Mites | Grapes | |
| | Float Plant pests, | | Grape Berry moth |
| | generally | | |
| | Springtails | | Grape Cane |
| | | | Gallmaker |
| General | | | Grape Cane Girdler |
| Crop Pests | | | |
| | Aphids | | Grape Flea beetle |
| | Beet armyworm | | Grape Insects, |
| | | | generally |
| | Garden fleahopper | | phylloxera, e.g., on |
| | | | grapes |
| | Grasshopper, e.g., | | Grape Root borer |
| | redlegged, the two- | | |
| | striped, and the | | |
| | differential | | |
| | grasshopper. | | |
| | Japanese beetles | Berries | |
| | Seed maggots | | Rednecked and |
| | | | Raspberry Cane |
| | | | Borers |
| | | | Root weevils |
| | Two-Spotted | | |
| | Spider mites | | |

6. Household Pests

The inventive compounds are also contemplated to be active against household pests such as the cockroach, Blatella sp., clothes moth, Tineola sp., carpet beetle, Attagenus sp., and the housefly, Musca domestica. In particular, susceptible household pests include those that cause sanitary or economic problems in association with residential and office space and materials, as follows.
Ants, including Carpenter ants (Camponotus spp), Pavement ants (Tetramorium caespitum), Pharaoh ants (Monomorium pharaonis), Thief ants (Solenopsis molesta), Yellow ants (Acanthomyops spp.), Red ants;
Bed Bugs (Cirmex spp.);
Beetles, e.g., Carpet (Attagenus spp.), Longhorned, Flour (Tribolium sp.), Drugstore (Stegobium paniceum), Elm Leaf, Ladybird (Harmonia axyridis);
Old House Borer and Flatheaded Wood Borer, Family Buprestidee., to name but a few;
Boxelder Bug (Boisea trivittata);
Carpenter bees;
Centipedes (Scutigera coleopterata);
Cockroaches, including, e.g., the American cockroach (Periplaneta americana), German cockroach (Blsaella germanica), Brownbanded cockroach (Supella longipalpa), Oriental Cockroach (Blatta orientatis), to name but a few.
Earwigs (Forficula sp.);
Field crickets;

Flies, including Cluster flies, Pollenia rudis; fruit flies, Moth flies, Psychoda spp. gnats, including, e.g., the Fungus gnat, Sciara spp. Phorids, Family Phoride
Millipede (Looceles reclusa);
Mites, e.g., Clover mites;
Mosquitoes, e.g., Culex spp., Anopheles spp., Aedes spp.;
Moths, including Clothes (Tineola sp., Tinea sp.); and Indian Meal (Plodia interpunctella);
Psocids (Liposcellis sp.);
Silverfish (Lepisma saccharine);
Sowbugs;
Spiders, including, e.g., the Black Widow, (Lactrodectus spp.), and the Orb Weaver;
Springtails, Order Collembola
Ticks, e.g., the American Dog tick, the Lone Star tick (Amblyomma americanium); and

Wasps, such as the Yellowjacket (Dolichovespula spp. and Vespula spp.).

### Treating and Inhibiting Parasite Infestation of Animals

It will be understood by those of ordinary skill that the methods and compounds of the present invention are useful in treating diseases and disorders that are known to be associated with the presence of helminths and protozoa, including for example, those listed above, that are present in the tissue or body fluids of animals.

For such infections or infestations, systemic administration is preferred, e.g., administration of the inventive compound by a route selected from the oral or rectal route, a parenteral route, e.g., by intraluminal, intramuscular, intravenous, intratracheal, subcutaneous injection or other type of injection or infusion. Topical administration for systemic absorption, i.e., in the treatment of internal parasites, is also preferred in certain optional embodiments, e.g., the topical application of the inventive compound to treat or prevent internal parasite infestation in cattle.

The administered inventive compound is optionally provided in the form of a pharmaceutically acceptable oral or parenteral composition, or in the feed or water or other liquid composition, as discussed in greater detail, below.

Generally, good results are obtained with the inventive compound by the systemic administration of from about 0.001 to 100 mg per kg of animal body weight, or more particularly, from about 0.01 to 10 mg per kg of animal body weight, such total dose being given at one time or in divided doses over a relatively short period of time such as 1-5 days. With the disclosed inventive compound, excellent control of such parasites is obtained in animals, e.g., by administering from about 0.025 to 50 mg per kg of body weight in a single dose, or more particularly, from about 0.025 to about 5 mg per kg of body weight in a single dose. Repeat treatments are given as required to combat re-infections and are dependent upon the species of parasite and the husbandry techniques being employed. The techniques for administering these materials to animals are known to the artisan. The exact amount of the inventive compound given will of course depend on several factors including the specific compound selected, the animal being treated, the parasite(s) infecting the animal, severity of infection, etc. and all such factors being considered by the artisan in calculating the required effective dose without undue experimentation.

In one preferred embodiment, the inventive compound is administered to animals in an oral unit dosage form, such as a capsule, bolus or tablet, or as a liquid drench where used as an anthelmintic in mammals. The drench is normally a solution, suspension or dispersion of the active ingredient usually in water together with a suspending agent such as bentonite and a wetting agent or like excipient. Generally, the drenches also contain an antifoaming agent. By way of example, drench formulations generally 0.0001 to about 50% by weight of the inventive compound. Preferred drench formulations contain from about 0.001 to about 10% by weight of the inventive compound. More preferred drench formulations contain from about 0.1 to about 5% by weight of the inventive compound. The drench capsules and boluses comprise the active ingredient admixed with a carrier vehicle such as starch, talc, magnesium stearate, or di-calcium phosphate. In certain optional embodiments, e.g., for large animals, such drench formulations are applied topically, and provide a surface concentration on the animal that is effective to kill or suppress parasites, e.g., by providing a concentration of the inventive compound ranging from about 0.001 μg/cm² to about 1 μg/cm², or more preferably, from about 0.01 μg/cm² to about 100 μg/cm².

In certain other optional embodiments, the inventive compounds may be administered in a controlled release form, e.g., in a subcutaneous slow release formulation, or in the form of a controlled release device affixed to an animal such as a so-called fleacollar. Collars for the controlled release of an insecticide agent for long term protection against flea infestation in a companion animal are art-known, and are described, for example, by U.S. Pat. Nos. 3,852,416, 4,224,901, 5,555,848, and 5,184,573, incorporated herein by reference.

Where it is desired to administer the inventive compounds in a dry, solid unit dosage form, capsules, boluses or tablets containing the desired amount of active compound usually are employed. These dosage forms are prepared by intimately and uniformly mixing the active ingredient with suitable finely divided diluents, fillers, disintegrating agents and/or binders such as starch, lactose, talc, magnesium stearate, vegetable gums and the like. Such unit dosage formulations may be varied widely with respect to their total weight and content of the antiparasitic agent depending upon factors such as the type of host animal to be treated, the severity and type of infection and the weight of the host.

When the inventive compound is to be administered via an animal feedstuff, it is intimately dispersed in the feed or used as a top dressing or in the form of pellets which may then be added to the finished feed or optionally fed separately.

Alternatively, the inventive compound may be administered to animals parenterally, for example, by intraluminal, intramuscular, intratracheal, or subcutaneous injection in which event the active ingredient is dissolved or dispersed in a liquid carrier vehicle. For parenteral administration, the active material is suitably admixed with an acceptable vehicle, preferably of the vegetable oil variety such as peanut oil, cotton seed oil and the like. Other parenteral vehicles such as organic preparation using solketal, glycerol formal, and aqueous parenteral formulations are also used. The selected inventive compound is dissolved or suspended in the parenteral formulation for administration; such formulations generally contain from 0.005 to 5% by weight of the active compound.

The inventive compounds may also be used to prevent and treat diseases caused by other parasites, for example, arthropod parasites such as ticks, lice, fleas, mites and other biting insects in domesticated animals, including poultry. It is also effective in treatment of parasitic diseases that occur in other animals including humans. The optimum amount to be employed for best results will, of course, depend upon the particular compound employed, the species of animal to be treated and the type and severity of parasitic infection or infestation.

When the compound described herein is administered as a component of the feed of the animals, or dissolved or suspended in the drinking water, compositions are provided in which the active compound or compounds are intimately dispersed in an inert carrier or diluent. An inert carrier is one that will not react with the antiparasitic agent and one that may be administered safely to animals. Preferably, a carrier for feed administration is one that is, or may be, an ingredient of the animal ration.

Suitable compositions include feed pre-mixes or supplements in which the active ingredient is present in relatively large amounts and which are suitable for direct feeding to the animal or for addition to the feed either directly or after an intermediate dilution or blending step. Typical carriers or diluents suitable for such compositions include, for example, distillers' dried grains, corn meal, citrus meal, fermentation residues, ground oyster shells, wheat shorts, molasses solubles, corn cob meal, edible bean mill feed, soya grits, crushed limestone and the like. The active inventive compounds are intimately dispersed throughout the carrier by methods such as grinding, stirring, milling or tumbling. Compositions containing from about 0.05 to about 5.0%, or from about 0.005 to about 2.0% by weight of the active compound are particularly suitable as feed pre-mixes. Feed supplements, which are fed directly to the animal contain from about 0.0002 to 0.3% by weight of the active compounds.

Such supplements are added to the animal feed in an amount to give the finished feed the concentration of active compound desired for the treatment and control of parasitic diseases. Although the desired concentration of active compound will vary depending upon the factors mentioned supra as well as upon the particular inventive derivative employed, the compound described in this invention is usually fed at concentrations of between about 0.0001 to 0.02% or from about 0.00001 to about 0.002% in the feed in order to achieve the desired antiparasitic result. The compounds of this invention are also useful in combating agricultural pests that inflict damage upon crops while they are growing or while in storage. The compound is applied using known techniques as sprays, dusts, emulsions and the like, to the growing or stored crops to effect protection from such agricultural pests.

Routes of Administration for Animals

As used herein, in the context of treating animals, the terms, “administer” or “administration” refer to the delivery of a compound, salt, solvate, or prodrug of the present invention or of a pharmaceutical composition containing a compound, salt, solvate, or prodrug of this invention to an organism for the purpose of treating or preventing a parasite infestation in animals.

Suitable routes of administration may include, without limitation, oral, rectal, topical, transmucosal, intramuscular, subcutaneous, intramedullary, intrathecal, direct intraventricular, intravenous, intravitreal, intraperitoneal, intranasal, aural or intraocular. The preferred routes of administration are oral and parenteral.

Alternatively, one may administer the compound in a local rather than systemic manner, for example, by preparation as a salve or topically applied formulation that is applied directly to the infected area or by injection of the compound directly into infected tissue. In either case, a sustained release formulation may be used.

Thus, administration of the compounds of the invention, or their pharmaceutically acceptable salts, in pure form or in an appropriate pharmaceutical composition, can be carried out via any of the accepted modes of administration or agents for serving similar utilities. The routes of administration can be any known to those of ordinary skill. The inventive compounds are given to those in need thereof in any art recognized form, ice., solid, semi-solid, lyophilized powder, or liquid dosage forms, such as for example, tablets, suppositories, pills, soft elastic and hard gelatin capsules, powders, solutions, suspensions, or aerosols, or the like, in unit or multi-dosage forms suitable for simple administration of precise dosages. The compositions will include a conventional pharmaceutical carrier or excipient and a compound of the invention as the active agent, and, in addition, may include other medicinal agents, pharmaceutical agents, carriers, etc.

For aquatic animal species, erg., vertebrate fish species, methods of administering the inventive compound(s) include the foregoing, e.g., by injection or by ad-mixing the effective compounds in the feed of farmed fish, and so forth. Method of administering to aquatic animal species also include dipping the fish into water comprising an effective concentration of the inventive compound(s), spraying the fish with an effective concentration of the inventive compound(s), while the fish is briefly separated from the water, and so forth.

The inventive compounds are also contemplated to be useful in treating other aquatic organisms, including aquatic invertebrates, such as crustaceans, e.g., lobsters, crabs and shrimp, mollusks, e.g., shellfish, snails, squid and octopus, etc. Treatment methods are analogous to those employed for fish.

Composition/Formulation for Animals

Pharmaceutical compositions of the present invention may be manufactured by processes well known in the art, e.g., using a variety of well-known mixing, dissolving, granulating, dragee-making, levigating, emulsifying, encapsulating, entrapping or lyophilizing processes. The compositions may be formulated in conjunction with one or more physiologically acceptable carriers comprising excipients and auxiliaries which facilitate processing of the active compounds into preparations which can be used pharmaceutically. Proper formulation is dependent upon the route of administration chosen.

A compound of the present invention, or a physiologically acceptable salt of either the compound, may be administered as such to an animal in need thereof, or may be administered in pharmaceutical compositions in which the foregoing materials are mixed with suitable excipient(s). Techniques for formulation and administration of drugs may be found in Remington's Pharmacological Sciences, Mack Publishing Co., Easton, Pa., latest edition. The formulations and techniques discussed in Remington relate primarily to use with human patients; however, they readily may be modified for use with non-human patients by techniques well-known to those skilled in the veterinary art.

For injection, including, without limitation, intravenous, intramuscular and subcutaneous injection, the compounds of the invention may be formulated in aqueous solutions, preferably in physiologically compatible buffers known to those of ordinary skill, as well as other excipients or other materials known to those of ordinary skill. For transmucosal administration, penetrants appropriate to the barrier to be permeated are used in the formulation. Such penetrants are generally known in the art.

For oral administration, the compounds can be formulated by combining the active compounds with pharmaceutically acceptable carriers well-known in the art. Such carriers enable the compounds of the invention to be formulated as tablets, pills, lozenges, dragees, capsules, liquids, gels, syrups, pastes, slurries, solutions, suspensions, concentrated solutions and suspensions for diluting in the drinking water of a patient, premixes for dilution in the feed of a patient, and the like, for oral ingestion by a patient. Pharmaceutical preparations for oral use can be made using a solid excipient, optionally grinding the resulting mixture, and processing the mixture of granules, after adding other suitable auxiliaries if desired, to obtain tablets or dragee cores. Useful excipients are, in particular, fillers such as sugars, including lactose, sucrose, mannitol, or sorbitol, cellulose preparations such as, for example, maize starch, wheat starch, rice starch and potato starch and other materials such as gelatin, gum tragacanth, methyl cellulose, hydroxypropyl-methylcellulose, sodium carboxy-methylcellulose, and/or polyvinylpyrrolidone (PVP). If desired, disintegrating agents may be added, such as cross-linked PVP, agar, or alginic acid. A salt such as sodium alginate may also be used.

When the inventive compounds described herein are administered as a component of the feed of the animals, or dissolved or suspended in the drinking water, compositions are provided in which the active agent(s) are intimately dispersed in an inert carrier or diluent. An inert carrier is one that will not react with the inventive compound and one that may be administered safely to animals. Preferably, a carrier for feed administration is one that is, or may be, an ingredient of the animal ration.

Suitable compositions include feed pre-mixes or supplements in which the active ingredient is present in relatively large amounts and which are suitable for direct feeding to the animal or for addition to the feed either directly or after an intermediate dilution or blending step. Typical carriers or diluents suitable for such compositions include, for example, distillers' dried grains, corn meal, citrus meal, fermentation residues, ground oyster shells, wheat shorts, molasses solubles, corn cob meal, edible bean mill feed, soya grits, crushed limestone, and the like. The inventive compound is intimately dispersed throughout the carrier by methods such as grinding, stirring, milling or tumbling. Compositions containing from about 0.05 to about 5.0%, or from about 0.005 to about 2.0% by weight of the active compound are particularly suitable as feed pre-mixes, Feed supplements, which are fed directly to the animal contain from about 0.0002 to 0.3% by weight of the active compounds.

Such supplements are added to the animal feed in an amount to give the finished feed the concentration of active compound desired for the treatment and control of parasitic diseases.

Although the desired concentration of active compound will vary depending upon the factors mentioned supra as well as upon the particular inventive derivative employed, the compound described in this invention is usually fed at concentrations of between about 0.0001 to 0.02% or from about 0.00001 to about 0.002% in the feed in order to achieve the desired antiparasitic result.

The invention compound is also optionally adminstered in the form of dragee cores provided with suitable coatings. For this purpose, concentrated sugar solutions may be used which may optionally contain gum arabic, talc, PVP, carbopol gel, polyethylene glycol, and/or titanium dioxide, lacquer solutions, and suitable organic solvents or solvent mixtures. Dyestuffs or pigments may be added to the tablets or dragee coatings for identification or to characterize different combinations of active compound doses.

Pharmaceutical compositions that can be used orally include push-fit capsules made of gelatin, as well as soft, sealed capsules made of gelatin and a plasticizer, such as glycerol or sorbitol. The push-fit capsules can contain the active ingredients in admixture with a filler such as lactose, a binder such as starch, and/or a lubricant such as talc or magnesium stearate and, optionally, stabilizers. In soft capsules, the active compounds may be dissolved or suspended in suitable liquids, such as fatty oils, liquid paraffin, or liquid polyethylene glycols. Stabilizers also may be added in these formulations.

For administration by inhalation, the compounds of the present invention can conveniently be delivered in the form of an aerosol spray using a pressurized pack or a nebulizer and a suitable propellant, e.g., without limitation, dichlorodifluoromethane, trichlorofluoromethane, dichlorotetrafluoroethane or carbon dioxide. In the case of a pressurized aerosol, the dosage unit may be controlled by providing a valve to deliver a metered amount. Capsules and cartridges of, for example, gelatin for use in an inhaler or insulator may be formulated containing a powder mix of the compound and a suitable powder base such as lactose or starch.

The compounds may also be formulated for parenteral administration, e.g., by bolus injection or continuous infusion. Formulations for injection may be presented in unit dosage form, e.g., in ampoules or in multi-dose containers. Useful compositions include, without limitation, suspensions, solutions or emulsions in oily or aqueous vehicles, and may contain adjuncts such as suspending, stabilizing and/or dispersing agents. Pharmaceutical compositions for parenteral administration include aqueous solutions of a water soluble form, such as, without limitation, a salt, of the active compound. Additionally, suspensions of the active compounds may be prepared in a lipophilic vehicle. Suitable lipophilic vehicles include fatty oils such as sesame oil, synthetic fatty acid esters such as ethyl oleate and triglycerides, or materials such as liposomes. Aqueous injection suspensions may contain substances that increase the viscosity of the suspension, such as sodium carboxymethyl cellulose, sorbitol, or dextran. Optionally, the suspension may also contain suitable stabilizers and/or agents that increase the solubility of the compounds to allow for the preparation of highly concentrated solutions. Alternatively, the active ingredient may be in powder form for constitution with a suitable vehicle, e.g., sterile, pyrogen-free water, before use.

The compounds may also be formulated in rectal compositions such as suppositories or retention enemas, using, e.g., conventional suppository bases such as cocoa butter or other glycerides.

In addition to the formulations described supra, the compounds may also be formulated as depot preparations. Such long acting formulations may be administered by implantation (for example, subcutaneously or intramuscularly) or by intramuscular or subcutaneous injection. A compound of this invention may be formulated for this route of administration with suitable polymeric or hydrophobic materials (for instance, in an emulsion with a pharmacologically acceptable oil), with ion exchange resins, or as a sparingly soluble derivative such as, without limitation, a sparingly soluble salt.

Other delivery systems for relatively hydrophobic pharmaceutical compounds may be employed. Liposomes and emulsions are well-known examples of delivery vehicles or carriers for hydrophobic drugs. In addition, organic solvents such as dimethylsulfoxide may be used, if needed.

Additionally, the compounds may be delivered using a sustained-release system, such as semi-permeable matrices of solid hydrophobic polymers containing the therapeutic agent. Various sustained-release materials have been established and are well known by those skilled in the art. Sustained-release capsules may, depending on their chemical nature, release the compounds for a few weeks up to over 100 days. Depending on the chemical nature and the biological stability of the particular compound, additional stabilization strategies may be employed.

Pharmaceutical compositions useful herein also may comprise solid or gel phase carriers or excipients. Examples of such carriers or excipients include, but are not limited to, calcium carbonate, calcium phosphate, various sugars, starches, cellulose derivatives, gelatin, and polymers such as polyethylene glycols.

Delivery to Plants/Crops, Facilities, Habitats

The compounds of the invention can be readily formulated by art-known methods for delivery for killing, suppressing or inhibiting endo or ectoparasites in or on plants generally, and particularly in crop plants, e.g., to kill or suppress any of the myriad plant pests enumerated supra. In addition, the compounds of the invention can be applied or distributed into selected environmental areas to kill or suppress endo or ectoparasites where desired. The inventive compounds are readily formulated, by methods known to the art, into compositions suitable for such applications. Such compositions optionally include more than one of the inventive compounds, each selected for an optimal spectrum of activity. In certain optional embodiments, the compositions include other agents, e.g., other art-known antiparasitic agents, pesticides and the like, as enumerated supra, that may provide a useful complementary or synergistic anti-parasiticidal effect.

It is further contemplated that the compositions optionally include other useful agents, including plant nutritional supplements, weed killers or herbicides, fertilizers, and the like, for efficient agriculture management.

Compositions for such distribution include solutions, suspensions and dry forms of the inventive compound(s) as discussed supra. This process of administering such compositions can be achieved by methods well known to the art. These include spraying, brushing, dipping, rinsing, washing, dusting, using art-known equipment, in a selected area. The selected area optionally includes plants, e.g., crops, and/or animals.

Thus, environmental areas contemplated to be treated in this way include, e.g., fields, orchids, gardens and the like, buildings and their environs, including landscaping, storage facilities, transport or fixed storage containers or analogous structures and structural components, such as walls, floors, roofs, fences, windows and window screens, and the like. Animal living spaces are also included, e.g., animal pens, chicken coops, corals, barns and the like. Human homes and other human residential, business or commercial and educational facilities are also contemplated to be treated or contacted with the inventive compounds or compositions thereof as described above.

Application can be achieved using art-known spraying devices, e.g., self-pressurized aerosol containers, larger devices employing compressed air or centrifugal distribution, as well as crop dusters, and the like.

### EXAMPLES

The following preparative examples of preferred derivatives of the inventive compound serve to provide further appreciation of the invention but are not meant in any way to restrict the effective scope of the invention.

### Example 1

### Preparation of N-(2-acetyl-4-chlorophenyl)-trifluoromethanesulfonamide

The following compounds were prepared according to the reaction scheme illustrated by FIG. 1.

a) To a rapidly stirred solution of fuming HNO₃ (17 mL) and concentrated H₂SO₄ (2.5 mL) at −20° C. was added portionwise 3-chloroacetophenone (5.0 g, 32.34 mmol) over 15 min. The reaction mixture was allowed to warm to −10° C. and stirred for 5 h at this temperature after which ice-water (75 mL) was added and the reaction mixture extracted twice with CH₂Cl₂. The organic layers were combined, washed five times with water, dried over MgSO₄ and concentrated under reduced pressure. The residue was filtered through a pad of silica (eluting with CH₂Cl₂/PE, 4:1) to afford a pale green oil which was recrystallized from Et₂O/PE to give 1-(5-chloro-2-nitrophenyl)ethanone (5.45 g, 84%), as pale yellow crystals.

b) A mixture of 1-(5-chloro-2-nitrophenyl)ethanone (4.40 g, 22.05 mmol), PtO₂ (40 mg) and charcoal (400 mg) in EtOH (80 mL) was rapidly stirred at RT for 4.5 h under one atmosphere of hydrogen. The reaction mixture was filtered through a pad of celite (the residues washed with CH₂Cl₂) and concentrated under reduced pressure. The residue was filtered through a pad of silica (eluting with CH₂Cl₂/PE, 4:1) to afford a pale green oil which was recrystallized from Et₂O/PE to give 1-(2-amino-5-chlorophenyl)ethanone (3.30 g, 88%), as pale green crystals.

c) To a solution of 1-(2-amino-5-chlorophenyl)ethanone (4.72 g, 27.83 mmol) in anhydrous CH₂Cl₂ (150 mL) at 0° C. was added dropwise (CF₃SO₂)₂O (7.0 mL, 41.74 mmol) in anhydrous CH₂Cl₂ (30 mL) over 30 min. and the reaction allowed to warm to RT overnight. The reaction mixture washed with water, dried over MgSO₄ and concentrated under vacuum. The residue was filtered through a pad of silica (eluting with CH₂Cl₂/PE, 3:7) to afford a yellow oil which was recrystallized from Et₂O/PE to give N-(2-acetyl-4-chlorophenyl)trifluoromethanesulfonamide (6.88 g, 82%), as pale yellow crystals. M.p. 36-38° C. ¹H n.m.r. (200 MHz, CDCl₃) δ 12.01, 1H, br s; 7.91, 1H, d, J2.2 Hz; 7.75, 1H, d, J8.8 Hz; 7.55, 1H, dd, J₁8.8 Hz J₂2.2 Hz; 2.71, 3H, s.

### Example 1A

### Preparation of N-[2-(1-phenylhydrazono)ethyl-4-chlorophenyl]-trifluoromethanesulfonamide (Compound 12)

N-(2-acetyl-4-chlorophenyl)-trifluoromethanesulfonamide (1.00 g, 3.3 mmol) and phenylhydrazine (0.364 g, 3.365 mmol) were mixed in ethanol (20 mL). The reaction was stirred at RT for 20 hrs. The solid was collected, rinsed with cold ethanol and then dried in air (0.728 g). The mother liquor was concentrated to about ½ volume to obtain the second crop of the product (0.353 g). The total yield of Compound 12 was 83%. M.p. 159.5-160° C. ¹H n.m.r. (CDCl₃), δ 12.70, 1H, s; 7.70, 1H, d, J8.8 Hz; 7.49, 1H, d, J2.4 Hz; 7.34, 1H, s br; 7.35, 2H, dd, J₁8.5 Hz, J₂7.5 Hz; 7.28, 1H, dd, J₁8.8 Hz, J₂2.4 Hz; 7.06, 2H, dd, J₁8.5 Hz, J₂0.9 Hz; 7.00, 1H, dt, J₁7.4 Hz, J₂0.9 Hz; 2.37, 3H, s.

### Example 1B

### Preparation of N-[2-(1-(2-chlorophenyl)hydrazono)ethyl-4-chlorophenyl]-trifluoromethanesulfonamide (Compound 149)

2-Chlorophenylhydrazine hydrochloride (0.656 g, 3.66 mmol) was stirred with anhydrous potassium acetate (0.36 g, 3.66 mmol) in EtOH (20 mL). A solution of N-(2-acetyl-4-chlorophenyl)-trifluoromethanesulfonamide (1.00 g, 3.33 mmol) in EtOH (8 ml) was added and the reaction stirred at RT for 30 hours. The solvent was removed under vacuum and the residue partitioned between EtOAc and water. The organic phase washed with brine and dried (MgSO₄). Removal of the solvent generated a slightly coloured solid (1.390 g). The crude product was recrystallized from DCM/PE to give 1.105 g of the product. The mother liquor was subjected to chromatography on a silica using 15% DCM/PE to give more product (0.182 g). M.p. 137.5-139° C. ¹H n.m.r (CDCl₃) 12.58, 1H, s; 7.94, 1H, s br; 7.70, 1H, d, J8.8 Hz; 7.53, 1H, d, J2.1 Hz; 7.36-7.30, 4H, m; 6.94, 1H, m; 2.42, 3H, s.

Using the same method in 1B with a reduced reaction time of 18 to 20 hours, the following additional compounds listed by Table 2, were prepared: 1, 3, 4, 5, 6, 7, 8, 10, 150, 151, 152, 153, 154, 155 and 156.

TABLE 2

| Cpd # | ¹H n.m.r.(200MHz, CDCl₃) |
|---|---|
| 1^{A} | 12.45, 1H, b, NH; 7.70, 1H, d, J8.8Hz; 7.60, 2H, d, J8.4Hz; 7.51, 1H, d, |
| | J2.3Hz; 7.32, 1H, dd, J₁8.9Hz, J₂2.3Hz; 7.10, 2H, d, J8.5Hz; 2.40, 3H, s. |
| 3^{B} | 12.45, 1H, s; 8.01, 1H, b; 7.70, 1H, d, J8.8Hz; 7.54, 1H, d, J2.4Hz; |
| | 7.33, 1H, dd, J₁8.8Hz, J₂2.4Hz; 7.28-7.23, 2H, m; 7.09, 1H, m; 2.44, 3H, s. |
| 4^{B} | 12.42, 1H, s; 7.87, 1H, s; 7.70, 1H, d, J8.8Hz; 7.53, 1H, d, J2.3Hz; |
| | 7.37, 1H, d, J2.1Hz; 7.32, 1H, dd, J₁8.8Hz, J₂2.3Hz; 7.31, 1H, dd, |
| | J₁6.3Hz, J₂2.1Hz; 7.27, 1H, d, 6.3Hz; 2.42, 3H, s. |
| 5^{B} | 12.33, 1H, s; 7.68, 1H, d, J8.8Hz; 7.49, 1H, d, J2.3Hz; 7.40, 1H, s; |
| | 7.39, 1H, d, J8.8Hz; 7.30, 1H, dd, J₁8.8Hz, J₂2.3Hz; 7.15, 1H, d, |
| | J2.7Hz; 6.91, 1H, dd, J₁8.8Hz, J₂2.7Hz; 2.37, 3H, s. |
| 6^{B} | 12.37, 1H, b; 7.68, 1H, d, J8.8Hz; 7.49, 1H, d, J2.4; 7.38, 1H, d, |
| | J8.7Hz; 7.43-7.37, 1H, b; 7.31, 1H, dd, J₁8.8Hz, J₂2.4Hz; 7.14, 1H, d, |
| | J2.7Hz; 6.90, 1H, dd, J₁8.7Hz, J₂2.7Hz; 2.37, 3H, s. |
| 7^{B} | 12.24, 1H, s; 7.90, 1H, b; 7.69, 1H, d, J8.8Hz; 7.53, 1H, d, J2.3Hz; |
| | 7.36, 1H, dd, J₁8.8Hz, J₂2.3Hz; 7.31, 1H, d, J2.1Hz; 7.27, 1H, d, |
| | J8.6Hz; 6.90, 1H, dd, J₁8.5Hz, J₂2.3Hz; 2.43, 3H, s. |
| 8^{B} | 12.57, 1H, s; 7.68, 1H, d, J8.8Hz; 7.49, 1H, d, J2.4Hz; 7.44, 2H, m; |
| | 7.29, 1H, dd, J₁8.9, J₂2.4Hz; 6.93, 2H, m; 2.36, 3H, s. |
| 10^{B} | 12.94, 7.67, 1H, d, J8.8Hz; 7.46, 1H, d, J2.3Hz; 7.25, dd, 1H, J₁8.8Hz, |
| | J₂2.2Hz; 7.00, 2H, d, J8.8Hz; 6.90, 2H, d, J8.9Hz; 3.79, 3H, s; 2.34, 3H, s. |
| 150^{B} | 12.43, 1H, s; 7.69, 1H, d, J8.8Hz; 7.49, 1H, d, J2.1Hz; 7.30, 1H, dd, |
| | J₁8.9Hz, J₂2.3Hz; 7.28-7.24, 1H, m; 7.04, 1H, br; 6.97-6.93, 2H, m; |
| | 2.37, 3H, s. |
| 151^{B} | 12.52, 1H, s; 7.68, 1H, d, J8.9Hz; 7.49, 1H, d, J2.3Hz; 7.30, 2H, d, |
| | J8.9Hz; 7.29, 1H, dd, J₁8.9Hz, J₂2.4Hz; 6.99, 2H, d, J8.9Hz; 2.36, |
| | 3H, s. |
| 152^{B} | 12.59, 1H, s; 7.70, 1H, d, J8.8Hz; 7.56, 1H, d, J2.5Hz; 7.51, 1H, dbr, |
| | J2.3Hz; 7.34, 1H, t, J8.1Hz; 7.31, 1H, dd, J₁9.0Hz, J₂2.3Hz; 7.18, |
| | 1H, t, J7.8Hz; 7.10, 1H, m; 6.93, 1H, m; 2.40, 3H, s. |
| 153^{B} | 12.43, 1H, s; 7.69, 1H, d, J8.8Hz; 7.49, 1H, d, J2.3Hz; 7.44, 1H, br; |
| | 7.30, 1H, dd, J8.6Hz; 7.31-7.27, 1H, m; 6.82, 1H, dd, J₁8.2Hz, J₂1.9Hz; |
| | 6.77, dt, J₁10.5Hz, J₂2.2Hz; 6.68, 1H, td, J₁8.3Hz, J₂2.2Hz; 2.37, |
| | 3H, s. |
| 154^{B} | 12.65, 1H, s; 7.68, 1H, d, J8.8Hz; 7.48, 1H, d, J2.2Hz; 7.32-7.27, 2H, |
| | m; 7.08-6.99, 4H, m; 2.36, 3H, s. |
| 155^{B} | *12.80, 1H, s; 7.70, 1H, d, J8.8Hz; 7.47, 1H, d, J2.4Hz; 7.33, 1H, b; |
| | 7.27, 1H, dd, J₁8.7Hz; J₂2.4Hz; 7.15, 2H, d, J8.1Hz; 6.96, 2H, d, J8.4Hz; 2.35, |
| | 3H, s; 2.31, 3H, s. |
| 156^{B} | 11.45, 1H, s; 7.62, 1H, d, J8.8Hz; 7.47, 1H, d, J2.4Hz; 7.43, 1H, br; 7.37, |
| | 2H, d, J8.1Hz; 7.29, 1H, dd, J₁8.8Hz, J₂2.4Hz; 7.03, 1H, t, J8.1Hz; 2.44, 3H, s. |

*Spectrum measured at 400MHz
^{A}Made by the method described in Example 1A;
^{B}Made by the method described in Example 1B.

### Example 2

### Preparation of N-(4-chloro-2-propionylphenyl)-trifluoromethanesulfonamide

The following compounds were prepared according to the reaction scheme illustrated by FIG. 1.

a) To a rapidly stirred solution of fuming HNO₃ (9 mL) and concentrated H₂SO₄ (1.3 mL) at −20° C. was added portionwise 3-chloropropiophenone (2.50 g, 14.82 mmol) over 15 min. The reaction mixture was allowed to warm to −10° C. and stirred for 2.25 h at this temperature after which ice-H₂O (75 mL) was added and the reaction mixture extracted twice with CH₂Cl₂. The organic layers were combined, washed five times with water, dried over MgSO₄ and concentrated under reduced pressure. The residue was filtered through a pad of silica (eluting with CH₂Cl₂/PE, 7:3) to afford 1-(5-chloro-2-nitrophenyl)-propan-1-one (2.99 g, 94%), as a pale yellow solid.

b) To a mixture of 1-(5-chloro-2-nitrophenyl)propan-1-one (2.49 g, 11.66 mmol) in EtOH (20 mL) and H₂O (10 mL) was added iron powder (3.25 g, 58.28 mmol) and NH₄Cl (312 mg, 5.83 mmol) and the reaction was rapidly stirred at 90° C. for 30 min. The hot reaction mixture was filtered (the residues were washed with EtOAc) and further EtOAc and H₂O added. The EtOAc layer was separated, dried over MgSO₄ and concentrated under reduced pressure. The residue was filtered through a pad of silica (eluting with CH₂Cl₂/PE, 7:3) to afford 1-(2-amino-5-chlorophenyl)propan-1-one (1.95 g, 91%), as a yellow solid.

c) To a solution of 1-(2-amino-5-chlorophenyl)propan-1-one (2.12 g, 11.54 mmol) in anhydrous CH₂Cl₂ (80 mL) at 0° C. was added dropwise (CF₃SO₂)₂O (2.91 mL, 17.32 mmol) in anhydrous CH₂Cl₂ (30 mL) over 30 minutes and the reaction allowed to warm to RT overnight. The reaction mixture washed with water, dried over MgSO₄ and concentrated under vacuum. The residue was filtered through a pad of silica (eluting with CH₂Cl₂/PE, 3:2) to afford a yellow oil which was recrystallized from Et₂O/PE to give N-(4-chloro-2-propionylphenyl)-trifluoromethanesulfonamide (3.12 g, 86%), as pale yellow crystals. M.p. 54-55° C. ¹H n.m.r. (200 MHz, CDCl₃) δ 12.06, 1H, s br; 7.93, 1H, d, J2.4 Hz; 7.75, 1H, d, J9.0 Hz; 7.54, 1H, dd, J₁9.0 Hz, J₂2.4; 3.09, 2H, q, J7.2 Hz; 1.24, 3H, t, J7.2 Hz.

### Example 2A

### Preparation of N-[2-(1-(phenylhydrazono)propyl)-4-chlorophenyl]-trifluoromethanesulfonamide (Compound 157)

N-(2-propionyl-4-chlorophenyl)-trifluoromethanesulfonamide (735 mg, 2.33 mmol) and phenylhydrazine (273 mg, 8.16 mmol) were mixed in ethanol (20 mL). The reaction was stirred at RT over night. The solvent was evaporated under vacuum and the residue filtered through a silica plug (4×4 cm) eluting with CH₂Cl₂/PE (30%). Removal of the solvent gave the product as a yellow solid (928 mg, 99%). M.p. 128-129° C. ¹H n.m.r. (CDCl₃) δ 12.88, 1H, s; 7.71, 1H, d, J8.8 Hz; 7.54, 1H, b; 7.47, 1H, d, J2.3 Hz; 7.35, 2H, dd, J₁8.5 Hz, J₂7.5 Hz; 7.29, 1H, dd, J₁8.8 Hz, J₂2.4 Hz; 7.06, 2H, m; 7.00, 1H, t, J7.4 Hz; 2.80, 2H, q, J7.8 Hz; 1.31, 3H, t, J7.8 Hz.

### Example 2B

### Preparation of N-[2-[1-(2,3-dichlorophenyl)hydrazono]propyl-4-chlorophenyl]-trifluoromethanesulfonamide (Compound 13)

N-(2-propionyl-4-chlorophenyl)-trifluoromethanesulfonamide (400 mg, 1.3 mmol) and 2,3-dichlorophenylhydrazine hydrochloride (270 mg, 1.3 mmol) were mixed in ethanol (20 mL). Sodium acetate (109 mg, 1.33 mmol) was added. The reaction mixture was stirred at RT for 20 hrs. The solid was removed by filtration and the filtrate was concentrated under vacuum. The residue was purified on a short silica column eluting with CH₂Cl₂/PE (6:4) to give Compound 13 as a yellow solid (201 mg) (34.4%). M.p. 153-155° C., ¹H n.m.r. (CDCl₃), δ 12.63, 1H, b; 8.21, 1H, s; 7.72, 1H, d, J8.9 Hz; 7.52, 1H, d, J2.4 Hz; 7.33, 1H, J₁8.9 Hz, J₂2.4 Hz; 7.27, 1H, m; 7.09, 1H, dd, J₁5.7 Hz, J₂3.8 Hz; 2.87, 2H, q, J7.7 Hz; 1.38, 3H, J7.7 Hz.

The following trifluoromethanesulfonamide compounds, as listed by Table 3, were prepared using the same preparative method: 2, 14, 15, 16, 18 and 19.

TABLE 3

| Cpd # | ¹H n.m.r.(200MHz, CDCl₃) |
|---|---|
| 2^{A} | 12.62, 1H, s; 7.72, 1H, d, J8.9; 7.72, 1H, b; 7.60, 2H, d, J8.4 Hz; 7.50, 1H, d, |
| | J2.3Hz; 7.32, 1H, dd, J₁8.8Hz, J₂2.3Hz; 7.11, 2H, d, J8.4Hz; 2.83, 2H, q, |
| | J7.7Hz; 1.33, 3H, t, J7.7 Hz. |
| 14^{B} | 12.54, 1H, s; 7.70, 1H, d, J8.8Hz; 7.48, 1H, d, J2.3Hz; 7.39, 1H, d, J8.8Hz; |
| | 7.32, 1H, dd, J₁8.8Hz, J₂2.3Hz; 7.15, 1H, d, J2.7Hz; 6.92, 1H, dd, J₁8.8, |
| | J₂2.7Hz; 2.79, 2H, q, J7.7Hz; 1.31, 3H, t, J7.7Hz. |
| 15^{B} | 12.79, 1H, s; 7.70, 1H, d, J8.9Hz; 7.48, 1H, d, J2.4Hz; 7.74, 2H, d, J8.9Hz; |
| | 7.30, 1H, dd, J₁8.9Hz, J₂2.4Hz; 6.94, 2H, d, J8.9Hz; 2.80, 2H, q, J7.7Hz; |
| | 1.31, 3H, t, J7.7Hz. |
| 16^{B} | 12.38, 1H, s; 7.70, 1H, d, J8.9Hz; 7.56, 1H, b; 7.49, 1H, d, J2.4Hz; 7.33, |
| | 1H, dd, J₁8.9Hz, J₂2.3Hz; 6.95, 3H, b; 2.80, 2H, q, J7.7Hz; 1.30, 3H, q, |
| | J7.7Hz. |
| 18^{B} | 12.63, 1H, s; 8.07, 1H, s; 7.71, 1H, d, J8.8Hz; 7.51, 1H, d, J2.4Hz, 7.39-7.33, |
| | 2H, m; 7.32-7.27, 2H, m; 2.86, 2H, q, J7.6; 1.37, 3H, t, J7.7Hz. |
| 19^{B} | 12.44, 1H, s; 8.10, 1H, s; 7.71, 1H, d, J8.8; 7.51, 1H, d, J2.4; 7.37-7.24, 3H, |
| | m; 6.90, 1H, dd, J₁8.6Hz, J₂2.4Hz; 2.86, 2H, q, J7.7Hz; 1.37, 3H, t, J7.7Hz. |

^{A}Made by the method described in Example 2A;
^{B}Made by the method described in Example 2B.

### Example 3

### Preparation of N-[2-[1-(N′-methyl-N′-phenyl)hydrazono)]ethyl-4-chlorophenyl]-trifluoromethanesulfonamide (Compound 9)

1-Methyl-1-phenylhydrazine (0.946 g, 7.7 mmol) was added to a solution of N-(2-acetyl-4-chlorophenyl)-trifluoromethanesulfonamide (2.20 g, 7.3 mmol) in ethanol (25 mL) and the reaction stirred at RT for 20 hrs. The solvent was evaporated under vacuum and the residue purified with a short silica column (4×9 cm) eluting with CH₂Cl₂/PE (10%-30%) to afford a solid (2.831 g) which was recrystallized from PE to give Compound 9 (2.533 g, 85.5%). M.p. 75-76° C. ¹H n.m.r. (CDCl₃), δ 7.75, 1H, d, J8.9 Hz; 7.56, 1H, d, J2.4 Hz; 7.38, 1H, dd, J₁8.9 Hz, J₂2.4 Hz; 7.34-7.30, 2H, m; 7.04, 1H, m; 6.95-6.93, 2H, m; 3.29, 3H, s; 2.33, 3H, s.

### Example 3A

### Preparation of N-[2-[1-((N′-ethyl-N′-phenyl)amino)imino)ethyl]-4-chloro-phenyl]trifluoromethanesulfonamide (Compound 34)

1-Ethyl-1-phenylhydrazine (made by the method of Marc M. Baum, Edward H. Smith, J. Chem. Soc. Perkin Trans. 1, 1993, 2513) (0.100 g, 0.74 mmol) and N-(2-acetyl-4-chlorophenyl)-trifluoromethanesulfonamide (0.200 g, 0.66 mmol) were mixed in ethanol (3 mL) and the reaction was stirred at RT for 20 hrs. The solvent was evaporated under vacuum and the residue purified with a silica column (3×7 cm) using CH₂Cl₂/PE (20%). To afford an oil which was crystallized from PE to give Compound 34 as yellow crystals (0.200 g, 72%). M.p. 111-114° C. ¹H n.m.r. (CDCl₃) δ 7.76, 1H, d, J8.9 Hz; 7.51, 1H, d, J2.2 Hz; 7.37, 1H, dd, J₁8.9 Hz, J₂2.3 Hz, 7.31, 2H, m; 7.06, 1H, t, J7.4 Hz; 6.94, 2H, d, J8.2 Hz; 3.65, 2H, q, J7.2 Hz; 2.19, 3H, s; 1.26, 3H, J7.1 Hz.

### Example 4

### Preparation of N-ethyl-N-[2-[1-(phenylhydrazono)]ethyl-4-chlorophenyl]-trifluoromethanesulfonamide (Compound 34)

N-[2-[1-(phenylhydrazono)]ethyl-4-chlorophenyl]-trifluoromethanesulfonamide (Compound 12) (0.200 g, 0.51 mmol) and NaH (100 mg, 2.5 mmol, 60% in oil, rinsed with PE) were mixed in DMF (3 mL) and the reaction was stirred at RT for 20 min. Iodoethane (400 mg, 2.5 mmol) was added to the orange reaction mixture. The reaction was stirred at RT over night, quenched with MeOH* and then neutralised with dilute HCl to pH 7. The mixture was concentrated under vacuum and the residue extracted with CH₂Cl₂. The residue from the CH₂CO₂ extract was purified using a silica column (1×12 cm) eluting with CH₂Cl₂/PE (20%) to give Compound 34 as a yellow solid (161 mg, 54%).

### Example 5

### Preparation of N-[2-[1-((N′-methyl-N′-2-fluorophenyl)amino)imino)ethyl]-4-chloro-phenyl]trifluoromethanesulfonamide (Compound 49)

a) Benzaldehyde (3.26 g, 30.75 mmol) was added to a mixture of 2-fluorophenylhydrazine hydrochloride (5.00 g, 30.75 mmol) and potassium carbonate (4.25 g, 30.75 mmol) in ethanol (110 ml). The reaction was stirred at RT over night. The reaction mixture was concentrated under vacuum and the residue partitioned with EtOAc and water. The organic layer washed with brine (×2) and dried (MgSO₄). Removal of the solvent under vacuum gave benzaldehyde N-(2-fluoro)phenylhydrazone as a yellow solid (6.22 g) which was used for the next step without purification.

b) The solid obtained from the above step (6.17 g, 28.82 mmol) was added to a mixture of NaH (2.30 g, 60% in oil, rinsed with PE) in DMF (90 ml) cooled with an ice bath. The reaction was stirred for 40 min followed by addition of iodomethane (6.14 g, 43.22 mmol). After 40 min, the ice bath was removed and reaction stirred at RT over night. DMF was removed under vacuum and the residue partitioned with EtOAc and water. The organic solution was washed with brine (×2), dried (MgSO₄) and evaporated. The crude product was purified using a short silica column. Elution with DCM/PE (5%) gave benzaldehyde N-methyl-N-(2-fluorophenyl) hydrazone as a pale yellow oil (6.11 g).

c) The oil obtained from step b (6.11 g) was mixed with 12% HCl (150 ml). The reaction was heated at reflux for 4 h using a Dean-Stark apparatus to remove liberated benzaldehyde. The aqueous solution was concentrated to dryness under vacuum. The residue was triturated and washed with diethyl ether to give the hydrochloride salt of 1-methyl-1-(2-fluorophenyl)hydrazine as a light brown solid (4.42 g, 93%).

d) Sodium (0.55 g, 23.94 mmol) was added to methanol (250 ml) and the solution cooled to RT. 1-Methyl-1-(2-fluorophenyl)hydrazine hydrochloride (4.00 g, 22.65 mmol) was added and the reaction stirred at RT for 30 min. Methanol was removed under vacuum and the residue mixed with diethyl ether (20 ml). N-(2-acetyl-4-chlorophenyl)trifluoromethanesulfonamide (5.69 g, 18.87 mmol) was added and the reaction stirred at RT over night. The reaction mixture washed with water and brine and the ethereal solution dried with MgSO₄. The solvent was removed and crude product purified on a short silica column using DCM/PE (10%) as the eluent. The yellow solid (7.72 g) obtained was recrystallized from PE to give 7.135 g of Compound 49. M.p. 70.6-71.2° C.

The following trifluoromethanesulfonamide compounds, as listed by Table 4, were prepared using the above methods described in Examples 3, 4, 5 and 6: 22, 24, 25, 26, 27, 28, 30, 31, 32, 33, 34, 37, 38, 39, 41, 42, 43, 45, 46, 47, 48, 49, 50, 51, 52, 53, 54, 56, 63, 65, 66, 67, 68, 69, 70, 71, 72, 73, 74, 75, 76, 77, 96, 97, 98, 99, 100, 101, 102, 103, 104, 105, 106, 113, 141, 142, 143, 144 and 148.

TABLE 4

| Cpd # | ¹H n.m.r.(200MHz, CDCl₃) |
|---|---|
| 22^{A} | 7.70, 1H, d, J8.8Hz; 7.47, 1H, s; 7.38-7.26, 9H, m; 7.08, 1H, |
| | t, J7.1Hz; 6.99, 2H, d, J7.5Hz; 4.76, 2H, s; 2.18, 3H, s. |
| 24^{A} | 7.72, 1H, d, J9.0Hz; 7.45, 1H, d, J2.4Hz; 7.38, 1H, d, J7.4Hz; |
| | 7.36-7.30, 5H, m; 7.28, 1H, m; 7.10, 1H, t, J7.4Hz; 7.06, |
| | 2H, dd, J₁8.7Hz, J₂1.1Hz; 4.67, 2H, s; 2.77, 2H, q, J7.6Hz; |
| | 0.81, 3H, t, J7.6Hz. |
| 25^{B} | 7.76, 1H, d, J8.9Hz; 7.50, 1H, d, J2.4Hz; 7.35, 1H, dd, |
| | J₁8.9Hz; J₂2.4Hz; 7.29, 2H, dd, J₁8.5Hz, J₂7.5Hz; 7.04, |
| | 1H, t, J7.4Hz; 6.91, 2H, dd, J₁8.6Hz, J₂1.0Hz; 3.55, 2H, m; |
| | 2.16, 3H, s; 1.70, 2H, tq, J₁=J₂7.4Hz; 0.98, 3H, t, J7.4Hz. |
| 26^{C,D} | 7.76, 1H, d, J8.8Hz; 7.52, 1H, s; 7.37, 1H, d, J9.0Hz; 7.27, |
| | 2H, d(J not readable); 6.85, 2H, d, J8.6Hz; 3.61, 2H, q, |
| | J7.2Hz; 2.20, 3H, s; 1.24, 3H, t, J7.1Hz. |
| 27^{C} | 7.76, 1H, d, J8.9Hz; 7.51, 1H, d, J2.3Hz; 7.37, 1H, dd, |
| | J₁8.9Hz, J₂2.4Hz; 7.25, 2H, d, J8.8Hz; 6.83, 2H, d, J8.9Hz, |
| | 3.51, 2H, t, J7.4Hz; 2.17, 3H, s; 1.69, 2H, tq, J₁=J₂7.4Hz; |
| | 0.97, 3H, t, J7.4Hz. |
| 28^{C} | 7.80, 1H, d, J9.0Hz; 7.48, 1H, d, J2.4Hz; 7.34, 1H, dd, |
| | J₁9.0Hz, J₂2.4Hz; 7.29, 2H, dd, J₁8.4Hz, J₂7.5Hz; 7.06, |
| | 1H, t, J7.4Hz; 6.92, 2H, d, J8.6Hz, 3.91, 1H, sept, J6.7Hz; |
| | 2.13, 3H, s; 1.28, 6H, d, J6.7Hz. |
| 30^{C} | 7.74, 1H, d, J8.9Hz; 7.48, 1H, d, J2.3Hz; 7.44, 1H, d, J2.3; |
| | 7.35, 1H, dd, J₁9.0Hz, J₂2.4Hz; 7.16, 1H, dd, J₁8.6Hz, |
| | J₂2.4Hz; 6.90, 1H, d, J8.6Hz; 3.48, 2H, q, J7.1Hz; 2.04, |
| | 3H, s; 1.30, 3H, t, J7.1Hz. |
| 31^{C} | 7.74, 1H, d, J8.9Hz; 7.47, 1H, d, J2.1Hz; 7.43, 1H, d, J2.1Hz; |
| | 7.35, 1H, dd, J₁8.9Hz, J₂2.1Hz; 7.16, 1H, dd, J₁8.7Hz, |
| | J₂2.1Hz; 6.91, 1H, d, J8.6Hz; 3.37, 2H, t, J7.5Hz; 2.05, 3H, |
| | s; 1.75, 2H, tq, J₁=J₂7.4Hz; 0.99, 3H, t, J7.4Hz |
| 32^{C} | 7.77, 1H, d, J8.9Hz; 7.49, 1H, d, J2.2Hz; 7.42, 1H, d, J2.2Hz; |
| | 7.34, 1H, dd, J₁8.9Hz, J₂2.2Hz; 7.15, 1H, dd, J₁8.6Hz, |
| | J₂2.3Hz; 6.81, 1H, d, J8.6Hz; 3.69, 1H, sept, J6.7Hz; 2.00, |
| | 3H, s; 1.32, 6H, d, J6.7Hz. |
| 33^{C} | 7.79, 1H, d, J9.0Hz; 7.49, 1H, d, J2.3Hz; 7.36, 1H, dd, |
| | J₁9.0Hz, J₂2.3Hz; 7.26, 2H, d, J8.7Hz; 6.86, 2H, d, J8.8Hz; |
| | 3.88, 1H, sept, J6.7Hz; 2.14, 3H, s; 1.27, 6H, d, J6.7Hz. |
| 34^{B,C} | 7.76, 1H, d, J8.9Hz; 7.51, 1H, d, J2.2Hz; 7.37, 1H, dd, |
| | J₁8.9Hz, J₂2.3Hz; 7.31, 2H, m; 7.06, 1H, t, J7.4Hz; 6.94, 2H, |
| | d, J8.2Hz; 3.65, 2H, q, J7.2Hz; 2.19, 3H, s; 1.26, 3H, J7.1Hz. |
| 37^{C} | 7.75, 1H, d, J8.9Hz; 7.47, 1H, dd, J₁7.9Hz, J₂1.5Hz; 7.43, |
| | 1H, d, J2.4Hz; 7.34, 1H, dd, J₁8.9Hz, J₂2.4Hz; 7.18, 1H, |
| | td, J₁7.8Hz, J₂1.6Hz; 7.10, 1H, td, J₁7.8Hz, J₂1.6Hz; 6.95, |
| | 1H, dd, J₁7.9Hz, J₂1.6Hz; 3.52, 2H, q, J7.1Hz; 2.01, 3H, s; |
| | 1.31, 3H, t, J7.1Hz. |
| 38^{C} | 7.77, 1H, d, J8.9Hz; 7.56, 1H, d, J2.4Hz; 7.39, 1H, dd, |
| | J₁8.9Hz, J₂2.4Hz; 7.22 1H, t, J8.1Hz; 7.00, 1H, ddd, J₁7.9Hz, |
| | J₂1.8Hz, J₃0.8Hz; 6.87, 1H, t, J2.1Hz; 6.76, 1H, ddd, |
| | J₁8.2Hz, J₂2.1Hz, J₃0.8Hz; 3.64, 2H, q, J7.1Hz; 2.23, 3H, |
| | s; 1.25, 3H, t, J7.1Hz |
| 39^{C,D} | 7.75, 1H, d, J8.9Hz; 7.49, 1H, d, J2.4Hz; 7.35, 1H, dd, |
| | J₁8.9Hz, J₂2.4Hz; 7.03-6.99, 2H, m; 6.95-6.92, 2H, m; 3.56, |
| | 2H, q, J7.1Hz; 2.16, 3H, s; 1.23, 3H, t, J7.1Hz. |
| 41^{C} | 7.78, 1H, d, J8.9Hz; 7.58, 1H, d, J2.4Hz; 7.53, 2H, d, J8.6Hz; |
| | 7.42, 1H, dd, J₁8.9Hz, J₂2.4Hz; 6.90, 2H, d, J8.6Hz, |
| | 3.62, 2H, t, J7.5Hz; 2.24, 3H, s; 1.71, 2H, tq, J₁=J₂7.5Hz; |
| | 0.98, 3H, t, J7.4Hz. |
| 42^{C} | 7.75, 1H, d, J8.9Hz; 7.46, 1H, dd, J₁7.9Hz, J₂1.4Hz; 7.43, |
| | 1H, d, J2.4Hz; 7.33, 1H, dd, J₁8.9Hz, J₂2.4Hz; 7.18, 1H, |
| | td, J₁7.9Hz, J₂1.5Hz; 7.10, 1H, td, J₁7.9Hz, J₂1.6Hz; 6.96, |
| | 1H, dd, J₁7.9Hz, J₂1.6Hz; 3.40, 2H, t, J7.6Hz; 2.02, 3H, s; |
| | 1.77, 2H, tq, J₁=J₂7.5Hz; 1.00, 3H, t, J7.5Hz. |
| 43^{C} | 7.75, 1H, d, J8.9Hz; 7.47, 1H, d, J2.4Hz; 7.34, 1H, dd, |
| | J₁8.9Hz, J₂2.4Hz; 7.14-7.10, 2H, m; 7.07-7.03, 1H, m; |
| | 6.96-6.92, 1H, m; 3.57, 2H, q, J7.1Hz; 2.10, 3H, s; 1.27, 3H, t, |
| | J7.1Hz. |
| 45^{C} | 7.75, 1H, d, J8.9Hz; 7.46, 1H, d, J2.4Hz; 7.34, 1H dd, |
| | J₁8.9Hz, J₂2.4Hz; 7.15-7.08, 2H, m; 7.07-7.02, 1H, m; |
| | 6.94-6.90, 1H, m; 3.47, 2H, t, J7.4Hz; 2.09, 3H, s; 1.71, 2H, tq, |
| | J₁=J₂7.4Hz; 0.98, 3H, t, J7.4Hz. |
| 46^{C} | 7.78, 1H, d, J8.9Hz; 7.45, 1H, d, J2.4Hz; 7.33, 1H, dd, |
| | J₁8.9Hz, J₂2.4Hz; 7.14-7.10, 2H, m; 7.07-7.03, 1H, m; 6.91, |
| | 1H, t, J7.9Hz;. 3.78, 1H, sept, J6.6Hz; 2.07, 3H, s; 1.31, |
| | 6H, d, J6.7Hz. |
| 47^{C} | 7.82, 1H, d, J9.0Hz; 7.56, 1H, d, J2.4Hz; 7.54, 2H, d, J8.6Hz; |
| | 7.40, 1H, dd, J₁9.0Hz, J₂2.4Hz; 6.93, 2H, d, J8.6Hz,. |
| | 4.10, 1H, sept, J6.7Hz; 2.19, 3H, s; 1.29, 6H, d, J6.7Hz |
| 48^{C} | 7.79, 1H, d, J8.9Hz; 7.47, 1H, d, J2.4Hz; 7.34, 1H, dd, |
| | J₁8.9Hz, J₂2.4Hz; 7.02-6.97, 2H, m; 6.94-6.91, 2H, m;. 3.79, |
| | 1H, sept, J6.7Hz; 2.11, 3H, s; 1.26, 6H, d, J6.7Hz. |
| 49^{C,D} | 7.73, 1H, d, J8.9Hz; 7.49, 1H, d, J2.4Hz; 7.35, 1H, dd, |
| | J₁8.9Hz, J₂2.4Hz; 7.16-7.08, 2H, m; 7.07-7.05, 1H, m; |
| | 7.01-5.97, 1H, m;. 3.29, 3H, s; 2.17, 3H, s. |
| 50^{C} | 7.82, 1H, d, J9.0Hz; 7.53, 1H, d, J2.4Hz; 7.37, 1H, dd, |
| | J₁9.0Hz, J₂2.4Hz; 7.21, 1H, t, J8.1Hz; 7.01, 1H, ddd, J₁8.0Hz, |
| | J₂2.0Hz, J₃0.9Hz; 6.90, 1H, t, J2.1Hz; 6.76, 1H, ddd, |
| | J₁8.2Hz, J₂2.1Hz, J₃0.8Hz; 3.95, 1H, sept, J6.7Hz; 2.17, |
| | 3H, s; 1.28, 6H, d, J6.7Hz. |
| 51^{C} | 7.76, 1H, d, J8.9Hz; 7.61, 1H, d, J2.4Hz; 7.40, 1H, dd, |
| | J₁8.9Hz, J₂2.4Hz; 7.23, 1H, t, J8.1Hz; 7.00, 1H, ddd, J₁7.9Hz, |
| | J₂1.8Hz, J₃0.8Hz; 6.90, 1H, t, J2.1Hz; 6.79, 1H, ddd, |
| | J₁8.2Hz, J₂2.2Hz, J₃0.7Hz;. 3.25, 3H, s; 2.39, 3H, s. |
| 52^{C} | 7.80, 1H, d, J8.9Hz; 7.51, 1H, d, J2.4Hz; 7.40, 2H, m; 7.36, |
| | 1H, dd, J₁8.9Hz, J₂2.4Hz; 6.80, 2H, m; 3.89, 1H, sept, J6.7Hz; |
| | 2.14, 3H, s; 1.27, 6H, d, J6.7Hz |
| 53^{C} | 7.75, 1H, d, J8.9Hz; 7.52, 1H, d, J2.4Hz; 7.39, 2H, m; 7.37, |
| | 1H, dd, J₁8.9Hz, J₂2.4Hz; 6.77, 2H, m; 3.52, 2H, t, J7.4Hz; |
| | 2.18, 3H, s; 1.69, 2H, tq, J₁=J₂7.4Hz; 0.97, 3H, t, J7.4Hz. |
| 54^{C} | 7.76, 1H, d, J8.9Hz; 7.54, 1H, d, J2.4Hz; 7.40, 2H, m; 7.37, |
| | 1H, dd, J₁8.9Hz, J₂2.4Hz; 6.79, 2H, m; 3.62, 2H, q, J7.1Hz; |
| | 2.21, 3H, s; 1.24, 3H, t, J7.4Hz |
| 56^{C} | 7.78, 1H, d, J8.9Hz; 7.48, 1H, dd, J₁7.9Hz, J₂1.5Hz; 7.42, |
| | 1H, d, J2.4Hz; 7.32, 1H, dd, J₁8.9Hz, J₂2.4Hz; 7.18, 1H, |
| | td, J₁7.9Hz, J₂1.5Hz; 7.10, 1H, td, J₁7.9Hz, J₂1.6Hz; 6.89, |
| | 1H, dd, J₁7.9Hz, J₂1.6Hz; 3.75, 1H, sept, J6.7Hz; 1.99, 3H, |
| | s; 1.34, 6H, J6.7Hz. |
| 63^{C} | 7.75, 1H, d, J8.9Hz; 7.58, 1H, d, J2.4Hz; 7.41, 2H, m; 7.39, |
| | 1H, dd, J₁8.9Hz, J₂2.4Hz; 6.81, 2H, m; 3.24, 3H, s; 2.37, |
| | 3H, s. |
| 65^{C,E,F} | 7.76, 1H, d, J8.9Hz; 7.64, 1H, d, J2.3Hz; 7.56, 2H, d, J8.7Hz; |
| | 7.42, 1H, dd, J₁8.9Hz, J₂2.2Hz; 6.95, 2H, d, J8.6Hz; |
| | 3.30, 3H, s; 2.44, 3H, s. |
| 66^{C} | 7.77, 1H, d, J8.9Hz; 7.42, 1H, d, J2.4Hz; 7.33, 1H, dd, |
| | J₁8.9Hz, J₂2.4Hz; 7.28, 1H, dd, J₁8.0Hz, J₂1.5Hz; 7.11, 1H, |
| | t, J8.1Hz; 6.80, 1H, dd, J₁8.1Hz, J₂1.5Hz; 3.74, 1H, sept, |
| | J6.7Hz; 2.00, 3H, s; 1.33, 6H, d, J6.7Hz. |
| 67^{C} | 7.82, 1H, d, J9.0Hz; 7.58, 1H, d, J2.4Hz; 7.40, 1H, dd, |
| | J₁9.0Hz, J₂2.4Hz; 7.00, 1H, t, J1.8Hz; 6.74, 2H, d, J1.8Hz; |
| | 4.00, 1H, sept, J6.7Hz; 2.22, 3H, s; 1.27, 6H, d, J6.7Hz. |
| 68^{C} | 7.81, 1H, d, J9.0Hz; 7.55, 1H, d, J2.4Hz; 7.38, 1H, dd, |
| | J₁9.0Hz, J₂2.4Hz; 7.34, 1H, d, J8.7Hz; 7.00, 1H, d, J2.6Hz; |
| | 6.75, 1H, dd, J₁8.7Hz, J₂2.6Hz; 3.94, 1H, Sept, J6.7Hz; |
| | 2.19, 3H, s; 1.28, 6H, d, J6.7Hz. |
| 69^{C} | 7.57, 1H, d, J8.9Hz; 7.45, 1H, d, J2.2Hz; 7.35, 1H, dd, |
| | J₁8.9Hz, J₂2.3Hz; 7.29, 1H, d, J7.5Hz; 7.12, 1H, t, J8.1Hz; |
| | 6.89, 1H, d, J8.1Hz; 3.51, 2H, q, J7.1Hz; 2.04, 3H, s; 1.32, |
| | 3H, t, J7.4Hz. |
| 70^{C} | 7.78, 1H, d, J8.9Hz; 7.61, 1H, d, J2.4Hz; 7.42, 1H, dd, |
| | J₁8.9Hz, J₂2.4Hz; 6.99, 1H, t, J1.7Hz; 6.71, 2H, d, J1.7Hz; |
| | 3.63, 2H, q, J7.1Hz; 2.29, 3H, s; 1.25, 3H, t, J7.4Hz. |
| 71^{C} | 7.77, 1H, d, J8.9Hz; 7.57, 1H, d, J2.4Hz; 7.40, 1H, dd, |
| | J₁8.9Hz, J₂2.4Hz; 7.34, 1H, d, J8.8Hz; 6.97, 1H, d, J2.7Hz; |
| | 6.73, 1H, dd, J₁8.8Hz, J₂2.7Hz; 3.62, 2H, q, J7.1Hz; |
| | 2.25, 3H, s; 1.24, 3H, t, J7.1Hz. |
| 72^{C} | 7.77, 1H, d, J8.9Hz; 7.55, 1H, d, J2.4Hz; 7.38, 1H, dd, |
| | J₁8.9Hz, J₂2.4Hz; 7.24, 1H, td, J₁8.2Hz, J₂6.6Hz; 6.71, 1H, |
| | tdd, J₁8.2Hz, J₂2.4Hz, J₃0.6Hz; 6.66, 1H, ddd, J₁8.2Hz, |
| | J₂2.1Hz, J₃0.6Hz; 6.57, 1H, dt, J₁10.8Hz, J₂2.3Hz, |
| | 3.56, 2H, t, J7.4Hz; 2.22, 3H, S; 1.70, 2H, tq, J₁=J₂7.4Hz; |
| | 0.98, 3H, t, J7.4Hz |
| 73^{C} | 7.77, 1H, d, J8.9Hz; 7.49, 1H, d, J2.4Hz; 7.34, 1H, dd, |
| | J₁8.9Hz, J₂2.4Hz; 7.11, 2H, d, J8.1Hz; 6.84, 2H, d, J8.4Hz; |
| | 3.51, 2H, t, J7.4Hz; 2.31, 3H, s; 2.15, 3H, 1.70, 2H, tq, |
| | J₁=J₂7.4Hz; 0.99, 3H, t, J7.4Hz. |
| 74^{C,G,F} | 7.76, 1H, d, J8.9Hz; 7.62, 1H, d, J2.4Hz; 7.40, 1H, dd, |
| | J₁8.9Hz, J₂2.4Hz; 7.27, 1H, td, J₁8.3Hz, J₂6.8Hz; 6.73-6.68, |
| | 2H, m; 6.61, 1H, dt, J₁11.1 Hz, J₂2.3Hz, 3.26, 3H, s; 2.40, |
| | 3H, s. |
| 75^{C} | 7.74, 1H, d, J8.9Hz; 7.53, 1H, d, J2.4Hz; 7.36, 1H, dd, |
| | J₁8.9Hz, J₂2.4Hz; 7.12, 2H, d, J8.3Hz; 6.86, 2H, d, J8.5Hz; |
| | 3.26, 3H, s; 2.31, 3H, s; 2.28, 3H, s. |
| 76^{C} | 7.77, 1H, d, J8.9Hz; 7.56, 1H, d, J2.4Hz; 7.38, 1H, dd, |
| | J₁8.9Hz, J₂2.4Hz; 7.25, 1H, td, J₁8.2Hz, J₂6.8Hz; 6.72, 1H, |
| | td, J₁8.2Hz, J₂1.9Hz; 6.66, 1H, dd, J₁8.2Hz, J₂1.6Hz; 6.57, |
| | 1H, dt, J₁10.8Hz, J₂2.2Hz, 3.65, 2H, q, J7.1Hz; 2.24, 3H, s; |
| | 1.25, 3H, t, J7.1Hz. |
| 77^{C} | 7.81, 1H, d, J8.9Hz; 7.54, 1H, d, J2.4Hz; 7.37, 1H, dd, |
| | J₁8.9Hz, J₂2.4Hz; 7.24, 1H, td, J₁8.2Hz, J₂6.7Hz; 6.73, 1H, |
| | td, J₁8.2Hz, J₂1.9Hz; 6.68, 1H, dd, J₁8.2Hz, J₂1.5Hz; 6.59, |
| | 1H, dt, J₁10.7Hz, J₂2.2Hz, 3.97, 1H, sept, J6.7Hz; 2.18, 3H, |
| | s; 1.28, 6H, d, J6.7Hz. |
| 96^{C} | 7.75, 1H, d, J8.9Hz; 7.62, 1H, d, J2.4Hz; 7.41, 1H, dd, |
| | J₁8.9Hz, J₂2.4Hz; 7.35, 1H, d, J8.8Hz; 6.99, 1H, d, J2.8Hz; |
| | 6.76, 1H, dd, J₁8.8Hz, J₂2.8Hz; 3.22, 3H, s; 2.42, 3H, s. |
| 97^{C} | 7.76, 1H, d, J8.9Hz; 7.56, 1H, d, J2.4Hz; 7.39, 1H, dd, |
| | J₁8.9Hz, J₂2.4Hz; 7.33, 1H, d, J8.8Hz, 6.96, 1H, d, J2.7Hz; |
| | 6.72, 1H, dd, J₁8.8Hz, J₂2.7Hz; 3.52, 2H, t, J7.4Hz; |
| | 2.23, 3H, s; 1.69, 2H, tq, J7.4Hz; 0.97, 3H, t, J7.4Hz. |
| 98^{C} | 7.77, 1H, d, J8.9Hz; 7.60, 1H, d, J2.3Hz; 7.41, 1H, dd, |
| | J₁8.9Hz, J₂2.3Hz; 6.98, 1H, t, J1.6Hz; 6.71, 2H, d, J1.6Hz; |
| | 3.54, 2H, t, J7.5Hz; 2.27, 3H, s; 1.70, 2H, tq, J7.4Hz; 0.98, |
| | 3H, t, J7.4Hz. |
| 99^{C} | 7.76, 1H, d, J8.9Hz; 7.65, 1H, d, J2.4Hz; 7.42, 1H, dd, |
| | J₁8.9Hz, J₂2.4Hz; 6.98, 1H, t, J1.7Hz; 6.76, 2H, d, J1.7Hz; |
| | 3.22, 2H, s; 2.44, 3H, s. |
| 100^{C} | 7.72, 1H, d, J8.9Hz; 7.46, 1H, d, J2.4Hz; 7.35, 1H, dd, |
| | J₁8.9Hz, J₂2.4Hz; 7.31, 1H, dd, J₁8.0Hz, J₂1.4Hz; 7.16, |
| | 1H, t, J8.1Hz; 7.00, 1H, dd, J₁8.1Hz, J₂1.4Hz; 3.25, 3Hs; |
| | 2.09, 3H, s. |
| 101^{C} | 7.76, 1H, d, J8.9Hz; 7.49, 1H, d, J2.4Hz; 7.34, 1H, dd, |
| | J₁8.9Hz, J₂2.4Hz; 7.10, 2H, d, J8.2Hz; 6.83, 2H, d, J8.3Hz; |
| | 3.59, 2H, q, J7.2Hz; 2.30, 3H, s; 2.15, 3H, s; 1.24, 3H, t, |
| | J7.1Hz. |
| 102^{C} | 7.81, 1H, d, J9.0Hz; 7.48, 1H, d, J2.4Hz; 7.33, 1H, dd, |
| | J₁9.0Hz, J₂2.4Hz; 7.10, 2H, d, J8.2Hz; 6.84, 2H, d, J8.4Hz; |
| | 3.84, 1H, sept, J6.7Hz; 2.31, 3H, s; 2.13, 3H, s; 1.27, 6H, d, |
| | J6.7Hz. |
| 103^{C} | 7.70, 1H, d, J8.9Hz; 7.38, 1H, d, J2.3Hz; 7.35, 2H, d, J8.1Hz; |
| | 7.27, 1H, dd, J₁8.9Hz, J₂2.3Hz; 7.14, 1H, t, J8.1Hz; |
| | 3.51, 2H, t, J7.7Hz; 1.85, 2H, m; 1.84, 3H, s; 1.00, 3H, t, |
| | J7.4Hz. |
| 104^{C} | 7.75, 1H, d, J8.9Hz; 7.49, 1H, d, J2.4Hz; 7.34, 1H, dd, |
| | J₁8.9Hz, J₂2.4Hz; 6.99, 2H, m; 6.93, 2H, m; 3.47, 2H, t, |
| | J7.5Hz; 2.15, 3H, s; 1.68, 2H, tq, J7.4Hz; 0.98, 3H, t, J7.4Hz |
| 105^{C} | 7.74, 1H, d, J8.9Hz; 7.57, 1H, d, J2.4Hz; 7.38, 1H, dd, |
| | J₁8.9Hz, J₂2.4Hz; 7.27, 2H, m; 6.82, 2H, d, J9.0Hz, 3.23, |
| | 3H, s; 2.35, 3H, s. |
| 106^{C} | 7.77, 1H, d, J8.9Hz; 7.55, 1H, d, J2.4Hz; 7.38, 1H, dd, |
| | J₁8.9Hz, J₂2.4Hz; 7.21, 1H, t, J8.1Hz; 6.99, 1H, ddd, J₁8.0Hz, |
| | J₂1.8Hz, J₃0.8Hz; 6.87, 1H, t, J2.0Hz; 6.75, 1H, ddd, |
| | J₁8.2Hz, J₂2.0Hz, J₃0.8Hz;. 3.55, 2H, t, J7.4Hz; 2.21, 3H, |
| | s; 1.70, 2H, tq, J7.4Hz; 0.98, 3H, J7.4Hz. |
| 113^{A} | 7.71, 1H, d, J8.9Hz; 7.55, 1H, d, J2.4Hz; 7.35, 1H, dd, |
| | J₁8.9Hz, J₂2.4Hz; 2.74, 6H, s; 2.53, 3H, s. |
| 141^{C} | 7.73, 1H, d, J8.9Hz; 7.49, 1H, d, J2.4Hz; 7.39, 1H, d, J8.6Hz; |
| | 7.38, 1H, dd, J₁8.9Hz, J₂2.4Hz; 7.11, 1H, dd, J₁8.6Hz, |
| | J₂2.4Hz; 7.04, 1H, d, J2.4Hz; 3.24, 3H, s; 2.13, 3H, s. |
| 142^{C} | 7.76, 1H, d, J8.9Hz; 7.47, 1H, d, J2.4Hz; 7.40, 1H, d, J8.6Hz; |
| | 7.37, 1H, dd, J₁8.9Hz, J₂2.4Hz; 7.09, 1H, dd, J₁8.6Hz, |
| | J₂2.4Hz; 6.91, 1H, d, J2.4Hz; 3.50, 2H, q, J7.1Hz; 2.06, |
| | 3H, s; 1.31, 3H, t, J7.4Hz. |
| 143^{C} | 7.76, 1H, d, J8.9Hz; 7.47, 1H, d, J2.4Hz; 7.39, 1H, d, J8.7Hz; |
| | 7.36, 1H, dd, J₁8.9Hz, J₂2.4Hz; 7.09, 1H, dd, J₁8.6Hz, |
| | J₂2.4Hz; 6.92, 1H, d, J2.4Hz; 3.38, 2H, t, J7.5Hz; 2.07, 3H, |
| | s; 1.76, 2H, tq, J7.5Hz; 0.99, 3H, t, J7.4Hz. |
| 144^{C} | 7.78, 1H, d, J8.7Hz; 7.45, 1H, d, J2.0Hz; 7.40, 1H, d, J8.8Hz; |
| | 7.35, 1H, dd, J₁8.8Hz, J₂2.1Hz; 7.08, 1H, dd, J₁8.5Hz, |
| | J₂2.4Hz; 6.83, 1H, d, J2.2Hz; 3.72, 1H, sept, J6.6Hz; 2.02, |
| | 3H, s; 1.33, 6H, d, J6.6Hz. |
| 148^{B} | 7.73, 1H, d, J8.9Hz; 7.46, 1H, dd, J₁8.0Hz, J₂1.4Hz; 7.44, |
| | 1H, d, J2.4Hz; 7.34, 1H, dd, J₁8.9Hz, J₂2.4Hz; 7.22, 1H, |
| | dt, J₁7.8Hz, J₂1.5Hz; 7.13, 1H, dt, J₁7.9Hz, J₂1.6Hz; 7.07, |
| | 1H, dd, J₁7.9Hz, J₂1.5Hz; 3.27, 3H, s; 2.07, 3H, s. |
| 203^{E,F} | |
| 204^{E,F} | |

^{A}Made by method of Example 3;
^{B}made by method of Example 3A;
^{C}made by the method of Example 4;
^{D}made by the method of Example 5:
^{E}made by method of Example 5 with the modification that ethanol was used as the solvent in step a);
^{F}made with the method of Example 5 with the modification that in step d) toluene was used in place of diethyl ether and the reaction was refluxed to remove water using a Dean-Stark apparatus;
^{G}made by the method of Example 5 with the modification that in step a) toluene was used in place of diethyl ether and the reaction was refluxed to remove water using a Dean-starkapparatus;

### Example 6

### Preparation of N-[2-[1-(1-piperidyl)imino]ethyl-4-chlorophenyl]-trifluoromethanesulfonamide (Compound 21)

1-Aminopiperidine (0.735 g, 7.34 mmol) was added to a solution of N-(2-acetyl-4-chlorophenyl)-trifluoromethanesulfonamide (2.00 g, 6.6 mmol) in ethanol (20 mL) and the reaction stirred at RT for 20 hrs. The reaction mixture was cooled to 0° C. and the yellow solid that formed was filtered off, rinsed with cold ethanol and dried in air to afford Compound 21 (2.020 g). M.p. 124-125° C. The filtrate was concentrated under vacuum and the residue (0.535 g) purified using a silica column (2×12.5 cm) eluting with CH₂Cl₂/PE (50%) to give more product (0.358 g) (total yield 94%). ¹H n.m.r. (CDCl₃), δ 7.75, 1H, d, J9.0 Hz; 7.57, 1H, d, J2.3 Hz; 7.35, 1H, dd, J₁9.0 Hz, J₂2.3 Hz; 2.93, 4H, t, J5.3 Hz; 2.56, 3H, s; 1.78, 4H, pent J5.6 Hz; 1.55, 2H, pent, J5.9 Hz.

### Example 7

Preparation of Compound 55

1-Aminohydantoin hydrochloride (0.216 g, 1.47 mmol) and potassium carbonate (200 mg, 1.45 mmol) were added to a solution of N-(2-acetyl-4-chlorophenyl)-trifluoromethanesulfonamide (0.400 g, 1.32 mmol) in ethanol (15 mL). The reaction mixture was stirred at RT over night and then heated at reflux for 10 hrs. The solvent was removed under vacuum and the residue purified using a silica column, eluting first with CH₂Cl₂ to remove the starting acetophenone and then with MeOH/CH₂Cl₂ (4%) to obtain Compound 55 (30 mg, 6%). M.p. 164° C. (decomposed). ¹H n.m.r. (CDCl₃) δ 7.65, 1H, d, J8.8 Hz; 7.65, 1H, d, J2.4 Hz; 7.42, 1H, dd, J₁8.9 Hz, J₂2.4 Hz; 4.36, 2H, s; 2.51, 3H, s.

The following trifluoromethanesulfonamide compounds, as listed by Table 5, were prepared the methods described in Examples 6 and 7: 20, 23, 36, 83, 84, 107, 116, 117, 118, 119, 121, 128, 129, 130 and 131.

TABLE 5

| Cpd # | ¹H n.m.r.(400MHz, CDCl₃) |
|---|---|
| 20^{A} | 7.71, 1H, d, J8.9Hz; 7.57, 1H, d, J2.4Hz; 7.36, 1H, dd, |
| | J₁8.9Hz, J₂2.4Hz; 3.87, 4H, m; 2.94, 4H, m; 2.51, 3H, s. |
| 23^{A} | 7.67, 1H, d, J8.8Hz; 7.66, 1H, d, J2.4Hz; 7.42, 1H, dd, |
| | J₁8.9Hz, J₂2.4Hz; 4.55, 2H, t, J7.5Hz; 4.01, 2H, t, J7.5Hz; |
| | 2.51, 3H, s. |
| 36^{A} | Obtained as mixture of E/Z-isomers(ratio ca. 1.5:1) |
| | Major isomer: |
| | 7.61, 1H, d, J8.8Hz; 7.42, 1H, dd, J₁8.8Hz, J₂2.4Hz; 7.34, |
| | 1H, d, J2.4Hz; 3.79, 4H, t, J4.7Hz; 2.94-2.92, 4H, m; 2.70, |
| | 2H, q, J7.4Hz; 1.09, 3H, t, J7.4Hz. |
| | Minor isomer: |
| | 7.73, 1H, d, J8.9Hz; 7.56, 1H, d, J2.4Hz; 7.38, 1H, dd, |
| | J₁8.9Hz, J₂2.4Hz; 3.88, 4H, t, J4.7Hz; 3.04, 2H, q, J7.6Hz; |
| | 2.94-2.92, 4H, m; 1.21, 3H, t, J7.6Hz. |
| 83^{A} | 7.71, 1H, d, J8.9Hz; 7.52-7.48, 1H, m; 7.45, 1H, dd, J₁8.9Hz, |
| | J₂2.5Hz; 7.43-7.38, 4H, m; 6.98, 1H, d, J2.5Hz; 3.10, |
| | 4H, m; 1.85, 4H, m; 1.62, 2H, m. |
| 84^{A} | 13.24, 1H, brs; 7.67, 1H, d, J8.8Hz; 7.49, 1H, dd, J₁8.8Hz, |
| | J₂2.4Hz; 7.49-7.46, 1H, m; 7.43-7.35, 4H, m; 7.08, 1H, |
| | d, J2.4Hz; 3.83, 4H, m; 3.04, 4H, m. |
| 107^{A} | 7.73, 1H, d, J8.9Hz; 7.52, 1H, d, J2.4Hz; 7.31, 1H, dd, |
| | J₁8.9Hz, J₂2.4Hz; 3.19, 4H, t, J5.7Hz; 2.49, 3H, s; 1.81, |
| | 4H, b; 1.68, 4H, m. |
| 116^{B} | 7.56, 1H, d, J8.8Hz; 7.39, 1H, dd, J₁8.8Hz, J₂2.4Hz; 7.33, |
| | 1H, d, J2.3Hz; 3.11, 4H, m; 2.39, 3H, s; 1.94, 4H, m. |
| 117^{A} | 7.72, 1H, d, J8.8Hz; 7.45-7.43, 3H, m; 7.32, 1H, dd, J₁8.8HZ, |
| | J₂2.5Hz; 7.29-7.25, 2H, m; 7.24-7.22, 2H, m; 7.01-6.98, |
| | 3H, m; 6.96, 1H, d, J2.4Hz; 2.96, 3H, s. |
| 118^{A} | 7.53-7.51, 2H, m; 7.51, 1H, d, J8.7Hz; 7.47, 1H, m; 7.39, |
| | 2H, m; 7.32, 1H, dd, J₁8.7Hz, J₂2.4Hz; 7.21, 2H, m, 7.10, |
| | 2H, m; 7.04, 1H, m; 6.91, 1H, d, J2.4Hz; 3.18, 3H, s. |
| 119^{A} | 7.97, 1H, dd, J₁6.2Hz, J₂1.7Hz; 7.87, 1H, d, J9.2Hz; 7.67-7.58, |
| | 4H, m; 7.38, 1H, dd, J₁9.2Hz, J₂2.6Hz; 6.98, 1H, d, |
| | J2.5Hz; 3.84, 3H, s; 2.28, 1H, ddd, J₁12.7Hz, J₂9.9Hz, |
| | J₃7.8Hz; 1.99-1.90, 4H, m; 1.88-1.75, 4H, m; 1.64, 1H, d, |
| | J12.7Hz; 1.42, 1H, m. |
| 121^{A} | 7.72, 1H, d, J8.9Hz; 7.68, 1H, d, J7.2Hz; 7.71-7.62, 2H, m; |
| | 7.39, 1H, b; 7.32-7.30, 2H, m; 7.25, 1H, dd, J₁8.9Hz, J₂2.7Hz; |
| | 7.25 1H, d, J8.9Hz; 6.86, 2H, m; 6.79, 1H, d, J2.4Hz. |
| 128^{B} | 7.63, 1H, d, J8.8Hz; 7.41, 1H, dd, J₁8.8Hz, J₂2.4Hz; 7.30, |
| | 1H, d, J2.4Hz; 3.17, 4H, b; 2.73, 2H, q, J7.4Hz; 1.98, 4H, |
| | m; 1.10, 3H, t, J7.4Hz. |
| 129^{A} | E-isomer |
| | 7.67, 1H, d, J8.9Hz; 7.39, 1H, dd, J₁8.9Hz, J₂2.4Hz; 7.28, |
| | 1H, d, J2.4Hz; 3.04, 4H, b; 2.75, 2H, q, J7.4Hz; 1.84, 4H, |
| | m; 1.58, 2H, b; 1.09, 3H, t, J7.4Hz |
| 130^{A} | Z-isomer |
| | 7.79, 1H, d, J9.0Hz; 7.56, 1H, d, J2.4Hz; 7.38, 1H, dd, |
| | J₁9.0Hz, J₂2.4Hz; 3.12, 2H, q, J7.6Hz; 2.96, 4H, m; 1.81, |
| | 4H, m; 1.57, 2H, m; 1.27, 3H, t, J7.6Hz |
| 131^{A} | 7.67, 1H, d, J8.9Hz; 7.38, 1H, dd, J₁8.9Hz, J₂2.4Hz; 7.27, |
| | 1H, d, J2.6Hz; 3.21, 4H, m; 2.74, 2H, q, J7.4Hz; 1.80, 4H, |
| | m; 1.70, 4H, m; 1.09, 3H, t, J7.4Hz |

^{A}Made by the method described in Example 6;
^{B}Made by the method described in Example 7.

### Example 8

Preparation of Compound 35

N-(4-chloro-2-propionylphenyl)-trifluoromethanesulfonamide (2.50 g, 7.9 mmol) and 3-amino-2-oxazolidinone (1.225 g, 11.85 mmol) were mixed in toluene (30 mL). The reaction was heated, with a Dean-Stark apparatus to remove water, at reflux for 3 hrs. The reaction mixture was cooled and evaporated to dryness. The residue was purified on a silica column using 20-100% CH₂Cl₂/PE, followed by 2% MeOH/DCM as solvent. The product was then recrystallized from DCM/PE to give 2.20 g of white solid. M.p. 115-117° C. ¹H n.m.r. (CDCl₃) δ 11.82, 1H, b; 7.69, 1H, d, J8.9 Hz; 7.60, 1H, d, J2.2 Hz; 7.42, 1H, dd, J₁8.9 Hz, J₂2.3 Hz; 4.54, 2H, t, J7.4 Hz; 3.96, 2H, t, J7.4 Hz; 2.93, 2H, q, J7.6 Hz; 1.13, 3H, t, J7.6 Hz.

### Example 9

### Preparation of N-[2-[1-dimethylhydrazono-1-phenyl]methyl-4-chlorophenyl]-trifluoromethanesulfonamide (Compound 123)

1,1-Dimethylhydrazine (40 mg, 0.67 mmol) and N-(2-benzoyl-4-chlorophenyl)trifluoromethanesulfonamide (200 mg, 0.55 mmol) were mixed with methanol (5 mL) in a Emrys process vial and the reaction was heated with microwaves at 165° C. for 10 min. The solvent was removed and the crude purified using radial silica chromatography eluting with CH₂Cl₂/PE (60%) to afford Compound 113 as a yellow solid (0135 mg), M.p. 152-154° C. ¹H n.m.r. (CDCl₃) δ 7.68, 1H, d, J8.9 Hz; 7.50-7.47, 1H, m; 7.48, 1H, dd, J₁8.9 Hz, J₂2.4 Hz; 7.44-7.37, 4H, m; 7.04, 1H, d, J2.4 Hz; 2.77, 6H, s.

### Example 10

### Preparation of N-[2-[1-(4-chlorobenzoyl)hydrazono]ethyl-4-chlorophenyl]-trifluoromethanesulfonamide (Compound 57)

To a solution of N-(2-acetyl-4-chlorophenyl)-trifluoromethanesulfonamide (0.326 g, 1.08 mmol) in ethanol (10 mL) was added 4-chlorobenzohydrazide (0.208 g, 1.19 mmol). The reaction was stirred at RT over night under nitrogen. The mixture was concentrated to dryness under vacuum, then dissolved in CH₂Cl₂ and filtered through a silica plug eluting with CH₂Cl₂/PE to afford Compound 57 as yellow needles (313 mg). M.p. 121.6-122.5° C. ¹H n.m.r. (400 MHz, CDCl₃), δ 7.78, 2H, d br, J7.9 Hz; 7.70, 1H, d br, J8.0 Hz; 7.52, 1H, d, J2.3 Hz; 7.44, 2H, d, J8.5 Hz; 7.36, 1H, dd, J₁8.9 Hz, J₂2.4 Hz; 2.17, 3H, s.

The following trifluoromethanesulfonamide compounds, as listed by Table 6, were prepared using the method of Example 10: 11, 17, 58, 59, 60, 61, 62, 79, 80, 81, 82 and 138.

TABLE 6

| Cpd # | ¹H n.m.r.(400MHz, CDCl₃) |
|---|---|
| 11 | *12.92, 1H, br; 9.15, 1H, br; 7.84, 2H, dbr, J7.2Hz; 7.72, 1H, |
| | dbr, J8.4Hz; 7.56, 1H, d, J8.6Hz; 7.53, 1H, d, J2.4Hz; |
| | 7.48, 2H, m; 7.35, 1H, dd, J₁8.9Hz, J₂2.4Hz; 2.42, 3H, s. |
| 17 | 9.21, 1H, b; 7.86, 2H, d, J7.2Hz; 7.76, 1H, d, J8.9Hz; 7.59, |
| | 1H, m; 7.54-7.47, 3H, m; 7.37, 1H, dd, J₁8.9Hz, J₂2.4Hz; |
| | 2.83, 2H, q, J7.7Hz; 1.33, 3H, J7.7Hz. |
| 58 | *8.05, 1H, d, J6.2Hz(or m); 7.77, 1H, d, J8.8Hz; 7.55, 1H, |
| | d, J2.2Hz; 7.52-7.35, 4H, m; 2.41, 3H, s. |
| 59 | *7.70, 1H, d, J8.4Hz; 7.62, 1H, d, J2.2Hz; 7.57-7.38, 5H, m; |
| | 3.43, 3H, s; 2.37, 3H, s. |
| 60 | 7.79, 2H, d(b), J8.4Hz; 7.74, 1H, d(b), J not readable; 7.52, |
| | 1H, d, J2.2Hz; 7.47, 2H, m; 7.38, 1H, dd, J₁8.9Hz, J₂2.4Hz; |
| | 2.82, 2H, q, J7.7Hz; 1.32, 3H, t, J7.7Hz. |
| 61 | *8.00, 1H, d, J8.8Hz; 7.76, 1H, d, J8.9Hz; 7.55, 1H, d, J2.2Hz; |
| | 7.52-7.32, 3H, m; 2.41, 3H, s. |
| 62 | *7.72, 1H, d, J8.1Hz; 7.68, 1H, d, J2.5Hz; 7.51, 1H, m; 7.44, |
| | 1H, dd, J₁8.8Hz, J₂2.5Hz; 7.43-7.37, 2H, m; 3.27, 3H, m; |
| | 2.47, 3H, s. |
| 79^{A} | 12.81, 1H, b; 9.76, 1H, b; 8.06, 1H, d, J8.5Hz; 7.78, 1H, d, |
| | J8.9Hz; 7.54, 1H, d, J2.3Hz; 7.51, 1H, d, J1.8Hz; 7.43, 1H, |
| | dd, J₁8.5Hz, J₂1.8Hz; 7.39, 1H, dd, J₁8.8Hz, J₂2.3Hz; 2.79, |
| | 2H, q, J7.8Hz; 1.33, 3H, t, J7.8Hz. |
| 80^{A} | 12.87, 1H, b; 9.78, 1H, b; 8.10, 1H, d, J7.9Hz; 7.79, 1H, d, |
| | J8.9Hz; 7.54, 1H, d, J2.3Hz; 7.52-7.47, 2H, m; 7.46-7.43, |
| | 1H, m; 7.39, 1H, dd, J₁8.9Hz, J₂2.3Hz; 2.79, 2H, q, J7.8Hz; |
| | 1.33, 3H, t, J7.8Hz. |
| 81^{A} | 7.75, 1H, d, J8.9Hz; 7.54, 2H, d, J8.2Hz; 7.49, 1H, d, J2.2Hz; |
| | 7.43, 1H, dd, J₁8.9Hz, J₂2.3Hz; 3.39, 3H, s; 2.75, 2H, q, |
| | J7.6Hz; 1.12, 3H, t, J7.6Hz. |
| 82^{A} | 7.78, 1H, d, J8.9Hz; 7.54, 1H, d, J2.3Hz; 7.50, 1H, d, J1.2Hz; |
| | 7.44, 1H, dd, J₁8.9Hz, J₂2.2Hz; 7.42, 1H, d, J₁8.2Hz; |
| | 7.38, 1H, dd, J₁8.4Hz, J₂1.4Hz; 3.22, 3H, s; 2.85, 2H, q, |
| | J7.7Hz; 1.13, 3H, t, J7.7Hz. |
| 138^{B} | *7.70, 1H, d, J8.9Hz; 7.61, 1H, d, J2.4Hz; 7.61-7.55, 2H, m; |
| | 7.54-7.41, 3H, m; 7.42, 1H, dd, J₁8.9Hz, J₂2.4Hz; 3.44, 3H, |
| | s; 2.38, 3H, s. |

*Measured at 200MHz
^{A}The reaction temperature was changed to 45° C. in the preparation of 79, 80, 81 and 82;
^{B}The reaction was performed in a sealed tube and heated at 100° C. in the preparation of 138.

### Example 11

### Preparation of N-[2-[1-(4-phenyl)semicarbazono]ethyl-4-chlorophenyl]-trifluoromethanesulfonamide (Compound 90)

To a solution of N-(2-acetyl-4-chlorophenyl)-trifluoromethanesulfonamide (0.206 g, 0.68 mmol) in ethanol (10 mL) was added 4-phenylsemicarbazide (0.103 g, 0.68 mmol). The reaction was stirred at RT over night under nitrogen. The white solid which had formed was collected, washed thoroughly with cold ethanol and then dried under vacuum at 50° C. to give Compound 90 (232 mg). M.p. 225.6-228.0° C. ¹H n.m.r. (DMSO), δ 9.92, 1H, s; 8.78, 1H, S; 7.69, 1H, d, J2.3 Hz; 7.53, 2H, J7.6 Hz; 7.50, 1H, dd, J₁8.8 Hz, J₂2.4 Hz; 7.41, 1H, d, J8.6 Hz; 7.30, 2H, m; 7.02, 1H, td, J₁7.4 Hz, J₂1.2 Hz; 2.24, 3H, s

The following trifluoromethanesulfonamide compounds, as listed by Table 7, were prepared using the method of Example 11: 91 and 92.

TABLE 7

| Cpd # | ¹H n.m.r.(200MHz, DMSO) |
|---|---|
| 91 | 10.31, 1H, s; 8.90, 1H, s; 8.10, 1H, dd, J₁8.2Hz, |
| | J₂1.4Hz; 7.60, 1H, d, J2.3Hz; 7.49, 1H, dd, J₁8.0Hz, |
| | J₂1.4Hz; 7.46, 1H, dd, J₁8.6Hz, J₂2.5Hz; 7.40-7.38, |
| | 1H, m; 7.36-7.30, 1H, m; 7.10, 1H, td, J₁7.7Hz, |
| | J₂1.6Hz; 2.25, 1H, s. |
| 92 | 9.96, 1H, s; 8.90, 1H, s; 7.63-7.56, 3H, m; 7.49-7.41, |
| | 2H, m; 7.38-7.30, 2H, m; 2.22, 3H, s. |

*Measured at 400MHz, in D₆-DMSO

### Example 12

### Preparation of N-[2-[1-(methoxycarbonylhydrazono)ethyl]-4-chlorophenyl]-trifluoromethanesulfonamide (Compound 78)

N-(2-Acetyl-4-chlorophenyl)-trifluoromethanesulfonamide (0.215 g, 0.714 mmol) was dissolved in ethanol (10 mL) and methyl carbazate (0.064 g, 0.71 mmol) added. The reaction was stirred at RT under nitrogen for 5 days and then heated at 45° C. for 8 hrs. A white solid which had formed was collected, washed thoroughly with cold ethanol and then dried under vacuum at 45° C. to give Compound 78 (168 mg), M.p. 211.2-214.3° C. ¹H n.m.r. (CDCl₃), δ 12.79, 1H, s; 8.62, 1H, b; 7.74, 1H, d, J8.9 Hz; 7.50, 1H, s; 7.34, 1H, dd, J₁8.9 Hz, J₂2.3 Hz; 3.94, 3H, s; 2.29, 3H, s.

### Example 13

### Preparation of ethyl 2-(3-methyl)butylcarbazate

a) To a suspension of sodium hydride (60% in oil, 1.90 g, 48.5 mmol) in DMF (20 mL) at 0° C. was added dropwise a solution of ethyl 3-(2-propylidene) carbazate (5.00 g, 34.68 mmol) in DMF (20 mL). The reaction was stirred for 30 min and followed by the addition of a solution of 1-bromo-3-methylbutane (6.30 g, 41.62 mmol) in DMF (5 mL). The reaction was stirred at RT for 3 hrs and then heated at 60° C. over night. The reaction mixture was concentrated under vacuum and the residue partitioned with Et₂O and water. The organic layer washed with brine and dried (MgSO₄). The ethereal solution was concentrated to give 4.80 g of the crude product ethyl 2-(3-methylbutyl)-3-(2-propylidene)carbazate.

b) The crude ethyl 2-(3-methylbutyl)-3-(2-propylidene)carbazate was dissolved in a mixed solvent of ethanol/water (30 ml/20 ml) and heated at reflux for 6 hrs. GC analysis displayed some unhydrolised starting material but the reaction did not change even after further 3 hrs of heating at reflux. Most of ethanol and water was distilled off and the reaction mixture cooled to RT. Water (5 mL) and 3M hydrochloric acid (5 mL) were added and the mixture was extracted with Et₂O. The aqueous phase was adjusted with 1M NaOH to pH 8 and then extracted with CH₂Cl₂. The organic phase was dried over MgSO₄ and filtered. Removal of the solvent gave ethyl 2-(3-methyl)butylcarbazate as a pale oil (1.20 g). ¹H n.m.r. (CDCl₃), δ 4.14, 2H, q, J7.1 Hz; 3.39, 2H, t, J7.3 Hz; 1.52, 1H, sept, J6.6 Hz; 1.44, 2H, dt, J7.3 Hz; 1.25, 3H, t, J7.1 Hz; 0.90, 6H, d, J6.5 Hz.

### Example 13A

### Preparation of Compound 158

N-(2-Acetyl-4-chlorophenyl)-trifluoromethanesulfonamide (0.200 g, 0.66 mmol) and ethyl 2-(3-methyl)butylcarbazate (0.350 g, 1.98 mmol) were dissolved in ethanol (7 mL). The reaction was stirred at RT overnight and then concentrated under vacuum to dryness. The residue was extracted with Et₂O and the solution neutralised with 1M HCl. The organic layer washed with brine and dried over MgSO₄. Removal of the solvent gave Compound 158 as a yellow oil (0.250 g). ¹H n.m.r. (CDCl₃), δ 7.72, 1H, d, J8.9 Hz; 7.62, 1H, d, J2.4 Hz; 7.40, 1H, dd, J₁8.9 Hz, J₂2.4 Hz; 4.24, 2H, q, J7.1 Hz; 3.70, 2H, m; 2.35, 3H, s; 1.61, 1H, sept, J6.6 Hz; 1.52, 2H, m; 1.30, 3H, t, J7.1 Hz; 0.93, 3H, q, J6.5 Hz.

### Example 14

Preparation of Compound 126

N-(2-Acetyl-4-chlorophenyl)-trifluoromethanesulfonamide (0.200 g, 0.66 mmol) and methyl 2-ethylcarbazate (0.156 g, 1.32 mmol) were dissolved in EtOH (7 mL). The reaction was stirred at RT over night and then evaporated to dryness under vacuum. The residue was purified using a radial chromatography on silica eluting with 70% DCM/PE to give the desired product as a yellow oil (70 mg). The decomposition of the product on silica was observed during the purification. ¹H n.m.r. (CDCl₃), δ 12.77, 1H, b; 7.71, 1H, d, J8.9 Hz; 7.57, 1H, d, J2.4 Hz; 7.38, 1H, dd, J₁8.9 Hz, J₂2.4 Hz; 4.29, 2H, q, J7.1 Hz; 3.28, 3H, s; 2.37, 3H, s, 1.31, 3H, t, J7.1 Hz.

The following trifluoromethanesulfonamide compounds, as listed by Table 8, were prepared using the methods of Example 12, 13 and 14: 85, 86, 87, 88, 89, 125, 127, 139 and 140.

TABLE 8

| Cpd # | ¹H n.m.r.(400MHz, CDCl₃) |
|---|---|
| 85^{A} | 12.58, 1H, s; 8.75, 1H, b; 7.72, 1H, d, J8.9Hz; 7.50, 1H, d, J2.3Hz; |
| | 7.34, 1H, dd, J₁8.9Hz, J₂2.4Hz; 4.40, 2H, q, J7.0Hz; 2.30, 3H, s; 1.38, 3H, t, |
| | J7.1Hz. |
| 86^{A} | 11.88, 1H, b; 8.22, 1H, b; 7.63, 1H, d, J8.9Hz; 7.46, 1H, d, J2.4Hz; |
| | 7.33, 1H, dd, J₁8.9Hz, J₂2.4Hz; 2.27, 3H, s; 1.58, 9H, s. |
| 87^{A} | 12.91, 1H, b; 8.84, 1H, b; 7.75, 1H, d, J8.9Hz; 7.50, 1H, d, J2.2Hz; |
| | 7.34, 1H, dd, J₁8.9Hz, J₂2.4Hz; 3.94, 3H, s; 2.71, 2H, q, J7.7Hz; 1.25, |
| | 3H, t, J7.7Hz. |
| 88^{A} | 12.72, 1H, s; 9.00, 1H, b; 7.73, 1H, d, J8.9Hz; 7.50, 1H, d, J2.2Hz; |
| | 7.34, 1H, dd, J₁8.9Hz, J₂2.4Hz; 4.41, 2H, q, J7.0Hz; 2.73, 2H, q, J7.6Hz; |
| | 1.39, 3H, t, J7.1Hz; 1.25, 3H, t, J7.7Hz. |
| 89^{A} | 11.94, 1H, b; 8.34, 1H, b; 7.65, 1H, d, J8.9Hz; 7.46, 1H, d, J2.3Hz; |
| | 7.33, 1H, dd, J₁8.8Hz, J₂2.4Hz; 2.69, 2H, q, J7.7Hz; 1.59, 9H, s; 1.23, |
| | 3H, t, J7.7Hz. |
| 125^{B} | 7.72, 1H, d, J8.9Hz; 7.62, 1H, d, J2.4Hz; 7.40, 1H, dd, J₁8.9Hz, J₂2.4Hz; |
| | 4.25, 2H, q, J7.1Hz; 3.72, 2H, q, J7.1Hz; 2.36, 3H, s; 1.30, 3H, t, |
| | J7.1Hz; 1.25, 3H, t, J7.1Hz. |
| 127^{B} | ^{C}7.76, 1H, d, J8.9Hz; 7.55, 1H, d, J2.4Hz; 7.41, 1H, dd, J₁8.9Hz, J₂2.4Hz; |
| | 4.26, 2H, q, J7.1Hz; 3.79, 2H, q, J7.1Hz; 2.81, 2H, q, J7.6Hz; 1.30, |
| | 3H, t, J7.1Hz; 1.23, 3H, t, J7.1Hz; 1.09, 3H, t, J7.6Hz. |
| 139_{B} | 13.12, 1H, b; 7.73, 1H, d, J8.9Hz; 7.62, 1H, d, J2.3Hz; 7.40, 1H, dd, |
| | J₁8.9Hz, J₂2.4Hz; 3.81, 3H, s; 3.72, 2H, q, J7.1Hz; 2.38, 3H, s; 1.24, |
| | 3H, t, J7.1Hz. |
| 140^{B} | 12.32, 1H, b; 7.77, 1H, d, J8.9Hz; 7.53, 1H, d, J2.4Hz; 7.41, 1H, dd, |
| | J₁8.9Hz, J₂2.4Hz; 3.81, 3H, s; 3.68, 2H, q, J7.1Hz; 2.81, 2H, q, J7.6Hz; |
| | 1.22, 3H, t, J7.1Hz; 1.08, 3H, q, J7.6Hz. |

^{A}Made by the method of Example 12
^{B}Carbazates were made by the method described in Example 13 and the trifluoromethanesulfonamide compounds were made by the method described in Example 14.
^{C1}H n.m.r spectrum measured at 200MHz

### Example 15

### Preparation of N-[2-[1-(N′-methyl-N′-phenyl)hydrazono]ethyl-4-chlorophenyl]-N-methyl-trifluoromethanesulfonamide (Compound 109)

Iodomethane (524 mg, 3.7 mmol) in acetone (2 mL) was added to a mixture of N-[2-[1-(N′-methyl-N′-phenyl)hydrazono]ethyl-4-chlorophenyl]-trifluoromethanesulfonamide (Compound 9) (300 mg, 0.74 mmol) and potassium carbonate (510 mg, 3.7 mmol) in acetone (20 mL). The reaction was heated at 40° C. for 3 hrs and then at 60° C. for 1 hr. The reaction mixture was cooled and acetone evaporated under vacuum. The residue was added to a mixture of CH₂Cl₂ and water. The organic layer washed with water, dried (MgSO₄) and filtered. The filtrate was concentrated to dryness. The residue was purified by radial chromatography on silica using CH₂Cl₂/PE (10%-40%) as the eluent. Compound 109 was obtained as a yellow solid (170 mg, 55%). M.p 100-102° C. ¹H n.m.r. (CDCl₃), δ 7.51, 1H, d, J2.4 Hz; 7.42, 1H, dd, J₁8.5 Hz, J₂2.4 Hz; 7.31, 1H, d, J8.6 Hz; 7.30, 2H, m; 7.04, 2H, m; 6.98, 1H, tt, J₁7.3 Hz, J₂1.0 Hz; 3.48, 3H br s; 3.26, 3H, s; 2.34, 3H, s.

### Example 16

### Preparation of N-[2-[1-(N′-methyl-N′-(4-trifluoromethyl)phenyl)hydrazono]-ethyl-4-chlorophenyl]-N-methyl-trifluoromethanesulfonamide (Compound 159)

A suspension of NaH (44 mg, 60% in oil, 1.08 mmol, rinsed with PE) in DMF (2 ml) was cooled with an ice bath. A solution of N-[2-[1-(4-trifluoro-methylphenyl)hydrazono]ethyl-4-chlorophenyl]-trifluoromethanesulfonamide (Compound 1) (250 mg, 0.54 mmol) in DMF (2 ml) was added. The reaction was stirred in the ice bath for 30 min. Iodomethane (155 mg, 0.81 mmol) in DMF (2 mL) was added. The reaction was stirred in the cold bath for 1 hr and at RT over night. DMF was removed under vacuum and the residue partitioned between EtOAc and water. The organic layer washed with brine and dried (MgSO₄). The crude product was purified on a silica column using 30% CH₂Cl₂/PE as the eluent. The crude product thus obtained was further purified by radial chromatography on silica eluting with 20% DCM/PE. Two compounds were obtained. N-[2-[1-(N′-methyl-(4-trifluoromethyl)phenyl)hydrazono]-ethyl-4-chlorophenyl]-trifluoromethanesulfonamide (Compound 65) yellow crystals (25 mg) and Compound 159 yellow gum (40 mg) which was recrystallised from PE to give 26 mg of yellow crystals. ¹H n.m.r. (CDCl₃), δ 7.54, 1H, d, J2.4 Hz; 7.51, 2H, d, J8.6 Hz; 7.45, 1H, dd, J₁8.5 Hz, J₂2.4 Hz; 7.32, 1H, d, J8.6 Hz; 6.97, 2H, d, J8.6 Hz; 3.46, 3H br s; 3.27, 3H, s; 2.38, 3H, s.

The following trifluoromethanesulfonamide compounds, as listed by Table 10, were prepared using the methods of Example 15 and 16: 29, 40, 44, 64, 110, 111, 112, 136, and 137.

Additional data for compounds of Example 15 and 16 are provided by Table 9 below.

TABLE 9

| Cpd # | ¹H n.m.r.(400MHz, CDCl₃) |
|---|---|
| 29^{A} | 7.42, 2H, m; 7.38, 1H, dd, J₁8.5Hz, J₂2.5Hz; 7.28-7.24, |
| | 2H, m; 7.21, 1H, dd, J₁8.7Hz, J₂2.2Hz; 3.49, 3H, s; |
| | 3.18, 3H, s; 2.00, 3H, s. |
| 40^{A} | 7.44-7.41, 2H, m; 7.37, 1H, dd, J₁8.5Hz, J₂2.5Hz; 7.31, |
| | 1H, dd, J₁8.0Hz, J₂1.5Hz; 7.27, 1H, d, J7.9Hz; 7.23, dd, |
| | J₁8.0hz, J₂1.5Hz, 7.11-7.06, 1H, m; 3.51, 3H, brs; 3.23, |
| | 3H, s; 1.98, 3H, s. |
| 44^{A} | 7.42, 1H, d, J2.4Hz; 7.37, 1H, dd, J₁8.5Hz, J₂2.4Hz; |
| | 7.28, 1H, d, J8.5Hz; 7.13-7.07, 4H, m; 3.57, 2H, m; 3.51, |
| | 3H, s; 1.94, 3H, s; 1.22, 3H, t, J7.1Hz. |
| 64^{A} | 7.48, 1H, d, J2.4Hz; 7.40, 1H, dd, J₁8.5Hz, J₂2.5Hz; |
| | 7.28, 1H, d, J8.6Hz; 7.01-6.92, 4H, m; 3.25, 3H, brs; |
| | 3.18, 3H, s; 2, 29, 3H, s. |
| 110^{B} | 7.48, 1H, d, J2.1Hz; 7.44, 1H, d, J8.5Hz; 7.40, 1H, dd, |
| | J₁8.5Hz, J₂2.2Hz; 7.32-7.27, 2H, m; 6.98-6.95, 3H, m; |
| | 5.21, 1H, d, J9.4Hz; 4.92, 1H, d, J9.7Hz; 3.40, 3H, s; |
| | 3.23, 3H, s; 2.31, 3H, s. |
| 111^{B} | 7.51, 1H, d, J2.4Hz; 7.40, 1H, dd, J₁8.5Hz, J₂2.4Hz; |
| | 7.34, 1H, d, J8.5Hz; 7.31-7.27, 2H, m; 6.99-6.94, 3H, m; |
| | 5.86, 1H, d, J11.7Hz; 5.57, 1H, d, J11.7Hz; 3.24, 3H, s; |
| | 2.27, 3H, s; 1.24, 9H, s. |
| 112^{B} | 7.48, 1H, d, J2.3Hz; 7.45, 1H, d, J8.6Hz; 7.40, 1H, dd, |
| | J₁8.5Hz, J₂2.3Hz; 7.31-7.27, 2H, m; 6.99-6.95, 3H, m; |
| | 5.27, 1H, d, J10.4Hz; 4.96, 1H, d, J10.1Hz; 3.58, 2H, m; |
| | 3.23, 3H, s; 2.32, 3H, s; 1.19, 3H, t, J7.0Hz. |
| 136^{C} | 7.47, 1H, d, J2.4Hz; 7.34, 1H, dd, J₁8.5Hz, J₂2.5Hz; |
| | 7.29, 2H, m; 7.14, 1H, d, J8.5Hz; 7.01, 2H, d, J7.8Hz; |
| | 6.95, 1H, t, J7.3Hz; 5.30, 1H, t, J8.0Hz; 4.46, 2H, d, |
| | J8.0Hz; 3.26, 3H, s; 2.33, 3H, s; 1.68, 3H, s; 1.36, 3H, s. |
| 137^{C} | 7.56, 1H, d, J8.4Hz, 7.50; 1H, d, J2.4Hz; 7.42, 1H, dd, |
| | J₁8.5Hz, J₂2.5Hz; 7.29, 2H, m; 6.98.6.94, 3H, m, 4.74, |
| | 1H, dd, J₁8.4Hz, J₂2.3Hz and 4.57, 1H, d, J8.2Hz; 3.22, |
| | 3H, s; 2.43, 1H, t, J2.5Hz; 2.31, 3H, s. |

^{A}Made by the method described in Example 16; for compound 29 and 40, 5 equivalents of NaH and Mel were in the reaction; for compound 64, 5 equivalents of NaH and 3 equivalents of Mel were used in the reaction.
^{B}Made by the method described in Example 15 and the reactions were heated at 60° C. The reaction time was 30 min for 110, 4 hours for 111 and 1 hr for 112.
^{C}Made by the method described in Example 15 with the modification that DMF was used in place of acetone and the reaction was heated to 120° C. for 1 hr.

### Example 17

### Preparation of N-[2-[1-(1-piperidyl)imino]ethyl-4-chlorophenyl]-N-ethyl-trifluoromethanesulfonamide (Compound 135)

N-[2-[1-(1-piperidyl)imino]ethyl-4-chlorophenyl]-trifluoromethanesulfonamide (Compound 21) (250 mg, 0.65 mmol) was dissolved in dry acetone (10 mL). K₂CO₃ (450 mg, 3.25 mmol) was added followed by iodoethane (510 mg, 3.25 mmol). The mixture was stirred at RT over night and then heated at 60° C. for 1 hr. Acetone was removed and the residue partitioned between CH₂Cl₂ and water. The organic layer washed with brine and dried (MgSO₄). The solvent was removed and the residue purified by radial chromatography on silica using CH₂Cl₂/PE (30%-60%) as the eluent. Compound 135 was obtained as a yellow oil (230 mg). ¹H n.m.r. (CDCl₃), δ 7.40, 1H, d, J2.3 Hz; 7.33, 1H, dd, J₁8.5 Hz, J₂2.4 Hz; 7.18, 1H, d, J8.5 Hz; 3.99, td, 1H, J7.1 Hz and 3.82, td, 1H, J7.1 Hz; 2.88-2.81, 2H, m; 2.81-2.72, 2H, m; 2.32, 3H, s; 1.79-1.70, 4H, m; 1.54-1.48, 2H, m; 1.22, 3H, t, J7.3 Hz.

### Example 18

### Preparation of N-[2-[1-(1-piperidyl)imino]ethyl-4-chlorophenyl]-N-(3-methyl-2-butenyl)trifluoromethanesulfonamide (Compound 132)

N-[2-[1-(1-piperidyl)imino]ethyl-4-chlorophenyl]-trifluoromethanesulfonamide (Compound 21) (250 mg, 0.65 mmol), K₂CO₃ (180 mg, 1.3 mmol), 4-bromo-2-methyl-2-butene (194 mg, 1.3 mmol) and NaI (10 mg) were mixed in acetone (10 mL). The reaction was stirred at RT overnight, Acetone was removed and the residue partitioned between DCM and water. The organic layer washed with brine and dried (MgSO₄). The solvent was removed and the residue purified using radial chromatography on silica eluting with (30%-50%) DCM/PE. Compound 132 was obtained as yellow oil (210 mg). ¹H n.m.r. (CDCl₃), δ 7.37, 1H, S; 7.27, 1H, d, J8.4 Hz; 7.08, 1H, d, J8.4 Hz; 5.28, 1H, t, J7.9 Hz; 4.46, 2H, d, J7.7 Hz; 2.86, 2H, b; 2.80, 2H, b; 2.32, 3H, s; 1.73, 4H, b; 1.70, 3H, s; 1.50, 2H, b; 1.38, 3H, s.

The following trifluoromethanesulfonamide compounds, as listed by Table 10, were prepared using the method in Example 18: 134, 145 and 146.

Additional data for compounds of Examples 18 are provided by Table 10 below.

TABLE 10

| Cpd # | ¹H n.m.r.(400MHz, CDCl₃) |
|---|---|
| 134 | 7.40, 1H, s(b); 7.78-7.30, 1H, m; 7.23, 1H, m; 3.46, 3H, s; |
| | 2.82, 4H, b; 2.33, 3H, b, 1.73, 4H, b; 1, 50, 2H, b. |
| 145 | 7.39-7.32, 3H, m; 5.29, 1H, d, J10.2Hz and 4.94, 1H, dbr; |
| | 3.60, 2H, q, J7.0Hz; 2.77, 4H, br; 2.30, 3H, s; 1.71, 4H, br; |
| | 1.48, 2H, m; 1.21, 3H, t, J7.0Hz. |
| 146 | 7.39, 1H, br; 7.37-7.32, 2H, m; 5.30, 1H, br and 5.21, 1H, br; |
| | 3.42, 3H, s; 2.77, 4H, br; 2.30, 3H, s; 1.72, 4H, br; 1.49, 2H, br. |

### Example 19

### Preparation of N-[2-[1-(1-piperidyl)imino]ethyl-4-chlorophenyl]-N-propargyltrifluoromethanesulfonamide (Compound 133)

N-[2-[1-(1-piperidyl)imino]ethyl-4-chlorophenyl]-trifluoromethanesulfonamide (Compound 21) (250 mg, 0.65 mmol), K₂CO₃ (540 mg, 3.90 mmol), propargyl chloride (290 mg, 3.9 mmol) and NaI (10 mg) were mixed with dry DMF (10 mL) in a sealed tube under nitrogen. The mixture was heated at 120° C. overnight. DMF was removed and the residue partitioned between Et₂O and water. The organic layer washed with brine and dried (MgSO₄). The solvent was removed and the residue purified by filtration through a silica plug, Compound 133 was obtained as a yellow solid (118 mg). M.p. 86-90° C. ¹H n.m.r. (DMSO), δ 7.76, 1H, d, J2.5 Hz; 7.61, 1H, dd, C, 7.46, 1H, d, J8.6 Hz; 4.76, 1H, dd, J₁18.5 Hz, J₂2.3 Hz; 4.53, 1H, d, J1.82 Hz; 3.59, 1H, t, J2.4 Hz; 2.72, 4H, m; 2.24, 3H, s; 1.62, 4H, m; 1.41, 2H, m.

### Example 20

### Preparation of N-(2-acetyl-5-trifluoromethylphenyl)-trifluoromethanesulfonamide

The following compounds were prepared according to the reaction scheme illustrated by FIGS. 1 and 5.

a) To a suspension of PE washed NaH (60% in oil, 10 g) in DMSO (500 mL) was added dropwise a solution of 4-chloro-3-nitrobenzotrifluoride (7.5 mL) and nitroethane (7.2 mL) in DMSO (100 mL). The reaction was stirred at RT for 3 hrs. The reaction mixture was poured into a solution of acetic acid/water (1:1) (100 mL) and the mixture was extracted with EtOAc (×3). The organic layer washed with water and brine, and then dried over MgSO₄. Removal of the solvent gave syrup (17.43 g) which was passed through a silica plug eluting with CH₂Cl₂/PE (1:1). Compound 4-(1-nitro)ethyl-3-nitrobenzotrifluoride was obtained as a yellow syrup (12.0 g) (83% purity by GC) used for the next step.

b) A solution of compound 4-(1-nitro)ethyl-3-nitrobenzotrifluoride in tert-butanol (350 ml) was added to a suspension of NaH (60% in oil, 3.02 g, rinsed with PE) in DMSO (50 mL). The reaction was stirred at RT for 20 min and cold EtOAc (357 mL) added followed by cold mixed solutions of boric acid (2.33 g in 190 mL of water) and KMnO₄ (6.00 g in 190 mL of water). After stirring at RT for 30 min, Na₂S₂O₆ solution (14.25 g in 75 mL of water) was added. After 10 min, H₂SO₄ (1M, 151 mL) was added and the reaction stirred at RT for 30 min. The reaction mixture was extracted with EtOAc (×3) and the extract washed with water and brine, and dried over Na₂SO₄/MgSO₄, Removal of the solvent gave 11.26 g of crude product which was purified by column chromatography on silica using CH₂Cl₂/PE (1:1) as eluent. 2-Nitro-4-trifluoromethylacetophenone (7.27 g) was obtained as a pale yellow syrup.

c) Water (30 mL) was added to the solution of compound 2-nitro-4-trifluoromethylacetophenone (7.25 g) in ethanol (60 mL) followed by Fe power (8.23 g) and NH₄Cl (823 mg). The reaction was heated with an oil bath (90° C.) for 40 min. The mixture was filtered while hot. The cooled filtrate was partitioned between EtOAc and water. The organic phase washed with water and dried over Na₂SO₄/MgSO₄. Removal of the solvent gave 5.67 g of 2-amino-4-trifluoromethylacetophenone.

d) Amino-4-trifluoromethylacetophenone (6.68 g) was dissolved in CH₂Cl₂ and the solution cooled to −30° C. A solution of (CF₃SO₂)O (8.5 mL) in dry CH₂Cl₂ (90 mL) was added dropwise over 20 min. The reaction was stirred with cooling for 3 hrs and then warmed to RT and stirred over night. The reaction solution washed with water (×2) and brine (×2) and then dried over Na₂SO₄/MgSO₄. Removal of the solvent gave 9.4 g of the crude product which was purified by column chromatography on silica eluting with CH₂Cl₂/PE (1:1). N-(2-acetyl-5-trifluoromethylphenyl)-trifluoromethanesulfonamide (7.80 g) was obtained as beige crystals.

### Example 20A

### Preparation of N-[2-[1-(N′-methyl-N′-phenyl)hydrazono]-ethyl-5-trifluoromethylphenyl]-trifluoromethanesulfonamide (Compound 120)

N-(2-acetyl-5-trifluoromethylphenyl)-trifluoromethylsulfonamide (100 mg, 0.30 mmol) and 1-methyl-1-phenylhydrazine (44 mg, 0.36 mmol) were mixed in ethanol (3 mL) and the reaction was stirred at RT over night. The solvent was evaporated under vacuum and the residue purified by radial thin layer chromatography on silica using CH₂Cl₂/PE (10%) with 1% EtOAc as eluent. Compound 120 was obtained as yellow crystals (89 mg). M.p. 91-93.5° C. ¹H n.m.r. (CHCl₃), 8.06, 1H, s; 7.72, 1H, d, J8.4 Hz; 7.46, 1H, dd, J₁8.3 Hz, J₂1.0 Hz; 7.33, 2H, m; 7.07, tt, J₁7.4 Hz, J₂1.0 Hz; 6.96, 2H, m; 3.32, 3H, s; 2.35, 3H, s.

### Example 21

### Preparation of N-[2-[1-(N′-methyl-N′-phenyl)hydrazono]ethyl-phenyl]-trifluoromethanesulfonamide (Compound 114)

N-(2-acetylphenyl)-trifluoromethylsulfonamide was prepared by the method reported by Trepka, R. D.; Harrington, J. K.; McConville, J. W.; McGurran, K. T.; Mendel, A.; Pauly, D. R.; Robertson, J. E.; Waddington, J. T.; J. Agr. Food Chem., 1974, 22, 1111-1119. N-(2-acetylphenyl)-trifluoromethylsulfonamide (200 mg, 0.75 mmol) and 1-methyl-1-phenylhydrazine (110 mg, 0.90 mmol) were mixed in ethanol (5 mL) and the reaction was stirred at RT over night. The solvent was evaporated under vacuum and the residue purified by radial thin layer chromatography on silica using CH₂Cl₂/PE (3:1) as eluent. Compound 114 was obtained as an oil. ¹H n.m.r. (CDCl₃), δ 7.82, 1H, dd, J₁8.4 Hz, J₂0.9 Hz; 7.64, 1H, dd, J₁8.0 Hz, J₂1.4 Hz; 7.43, 1H, td, J₁8.6 Hz, J₂1.5 Hz; 7.34-7.30, 2H, m; 7.23, 1H, td, J₁8.1 Hz, J₂1.2 Hz; 7.03, 1H, t, J7.4 Hz; 6.97-6.95, 2H, m; 3.28, 3H, s; 2.40, 3H, s.

The following trifluoromethanesulfonamide compounds, as listed by Table 11, were prepared using the preparative methods described for Example 21 with the modifications indicated by footnotes A and B under Table 11.

Additional data for compounds of Example 21 are provided by Table 11 below.

TABLE 11

| Cpd # | ¹H n.m.r.(400MHz, CDCl₃) |
|---|---|
| 122^{A} | 12.73, 1H, s; 7.73, 1H, dd, J₁8.4Hz, J₂1.0Hz; 7.53, 1H, dd, |
| | J₁8.0Hz, J₂1.4Hz; 7.33, 1H, ddd, J₁8.4Hz, J₂7.4Hz, J₃1.5Hz; |
| | 7.30-7.26, 2H, m; 7.23, 1H, ddd, J₁8.0Hz, J₂7.5Hz, |
| | J₃1.2Hz; 7.00-6.97, 2H, m; 2.67, 3H, s |
| 124^{B} | 7.77, 1H, d, J8.4Hz; 7.67, 1H, dd, J₁8.1Hz, J₂1.4Hz; 7.43, |
| | 1H, ddd, J₁8.5Hz, J₂7.4Hz, J₃1.5Hz; 7.18, 1H, ddd, J₁8.1Hz, |
| | J₂7.5Hz, J₃1.1Hz; 2.72, 6H, s; 2.59, 3H, s. |

^{A}The reaction was performed in MeOH with K₂CO₃ (1 equivalent) because hydrazine hydrochloride was used in the reaction.
^{B}The reaction was performed in MeOH and heated at reflux over night.

### Example 22

### Preparation of N-[3-[1-(N′-methyl-N′-phenyl)hydrazono]ethylphenyl]-trifluoromethanesulfonamide (Compound 163)

N-(3-acetylphenyl)-trifluoromethylsulfonamide (prepared by the method reported by Trepka, R. D.; Harrington, J. K.; McConville, J. W.; McGurran, K. T.; Mendel, A.; Pauly, D. R.; Robertson, J. E.; Waddington, J. T.; J. Agr. Food Chem., 1974, 22, 1111-1119) (100 mg, 0.37 mmol) and 1-methyl-1-phenyl hydrazine (55 mg, 0.45 mmol) were mixed in ethanol (3 mL) and the reaction was stirred at RT over night. The solvent was removed and the residue purified by radial thin layer chromatography on silica using DCM/PE (20%) plus 1% of EtOAc as eluent to afford Compound 163 as a yellow syrup (26 mg) which was solidified on storage. M.p. 94-96.5° C.

The following trifluoromethanesulfonamide compounds, as listed by Table 12, were prepared using method of Example 22: 161, 162, and 163.

Additional data for compounds of Example 22 are provided by Table 12 below.

TABLE 12

| Cpd # | ¹H n.m.r.(400MHz, CDCl₃) |
|---|---|
| 161 | 7.47, 1H, dt, J₁7.7Hz; J₂1.2Hz; 7.35, 1H, t, J1.7Hz; 7.29, |
| | 1H, t, J7.9Hz; 7.21, 1H, ddd, J₁8.0Hz, J₂2.0Hz; |
| | J₃1.0Hz; 7.19, 1H, b; 2.84, 4H, t, J5.6Hz; 2.31, 3H, s; |
| | 1.74, 4H, tt, J₁=J₂5.8Hz; 1.50, 2H, pen, J5.8Hz. |
| 162 | 7.37, 1H, d, J8.7Hz; 7.36, 2H, dd, J₁8.6Hz, J₂7.3Hz; 7.19, |
| | 1H, d, J2.5Hz; 7.10-7.03, 4H, m; 3.30, 3H, s; 2.38, 3H, s. |
| 163 | 7.78-7.76, 2H, m; 7.43, 1H, t, J8.2Hz; 7.34, 1H, ddd, J₁8.0Hz, |
| | J₂2.1Hz, J₃1.0Hz; 7.30, 2H, m; 7.00-6.94, 3H, m; |
| | 3.21, 3H, m; 2.35, 3H, s. |

### Example 23

### Preparation of N-[4-[1-(N′-methyl-N′-phenyl)hydrazono]ethylphenyl]-trifluoromethanesulfonamide (Compound 166)

N-(4-acetyl-phenyl)-trifluoromethylsulfonamide (prepared by the method reported by Trepka, R. D.; Harrington, J. K.; McConville, J. W.; McGurran, K. T.; Mendel, A.; Pauly, D. R.; Robertson, J. E.; Waddington, J. T.; J. Agr. Food Chem., 1974, 22, 1111-1119) (200 mg, 0.75 mmol) and 1-methyl-1-phenylhydrazine (110 mg, 0.90 mmol) were mixed in ethanol (5 mL) and the reaction was stirred at RT for two days. The solvent was evaporated under vacuum and the residue purified by radial thin layer chromatography on silica using DCM/PE (50%) as the eluent. Compound 166 (174 mg) was obtained as a yellow syrup and solidified slowly. M.p. 192.5-194° C.

The following trifluoromethanesulfonamide compounds, as listed by Table 13, were prepared using the method of Example 23: 164-167.

Additional data for compounds of Example 23 are provided by Table 13 below.

TABLE 13

| Cpd # | ¹H n.m.r.(400MHz, CDCl₃) |
|---|---|
| 164 | 7.90-7.87, 2H, m; 7.32-7.27, 4H, m; 6.99-6.93, 3H, m; 3.20, |
| | 3H, s; 2.35, 3H, s. |
| 165 | 7.80, 2H, m; 7.29, 2H, m; 7.24, 2H, m; 7.10, 2H, m; 6.92, 1H, |
| | b; 2.05, 3H, s. |
| 166 | 10.81, 1H, b; 8.23, 1H, s; 7.67, 2H, d, J8.7Hz; 7.27, 2H, m; |
| | 3.82, 3H, s; 2.15, 3H, s. |
| 167 | 7.64, 2H, d, J8.7Hz; 7.23, 2H, d, J8.7Hz; 2.73, 4H, m; 2.28, |
| | 3H, s; 1.67, 4H, m; 1.44, 2H, m. |

### Example 24

### Preparation of N-(2-(3-dimethylamino)acryloyl-4-chlorophenyl)-trifluoromethanesulfonamide

The following compound was prepared according to the reaction scheme illustrated by FIG. 6.

N-(2-Acetyl-4-chlorophenyl)-trifluoromethanesulfonamide (1.505 g, 5 mmol) and N,N-dimethylformamide dimethyl acetal (3 mL) were mixed and the reaction was heated at 115° C., with stirring, for 7 hrs and then at RT over night. The reaction mixture was filtered and the yellow solid was rinsed with CH₂Cl₂/PEt and dried to afford N-(2-(3-dimethylamino)acryloyl-4-chlorophenyl-trifluoromethanesulfonamide (684 mg). The filtrate was purified by column chromatography on silica using MeOH/CH₂Cl₂ as the eluent to give more product (137 mg). M.p. 104-108° C. ¹H n.m.r. (CDCl₃), δ 7.92, 1H, d, J11.8 Hz; 7.73, 1H, d, J2.2 Hz; 7.66, 1H, d, J8.9 Hz; 7.39, 1H, dd, J₁8.9 Hz, J₂2.4 Hz; 5.65, 1H, d, J11.9 Hz; 3.25, 3H, s; 2.03, 3H, s.

### Example 24A

### Preparation of N-[2-(1-methyl-1H-pyrazol-3-yl)-4-chlorophenyl]-trifluoromethanesulfonamide (Compound 160) and N-[2-(1-methyl-1H-pyrazol-5-yl)-4-chlorophenyl]-trifluoromethanesulfonamide (Compound 93)

The following compounds were prepared according to the reaction scheme illustrated by FIG. 6.

N-(2-(3-dimethylamino)acryloyl-4-chlorophenyl)-trifluoromethanesulfonamide (59 mg) and methylhydrazine (15 mg) were mixed in ethanol (1.5 mL) and the reaction was stirred at RT for 20 hrs. The solvent was removed under vacuum and the residue partitioned with EtOAc and water. The aqueous phase was adjusted to pH 5-6 with dilute HCl and then extracted with EtOAc. The combined organic solution washed with brine and dried over MgSO₄. Removal of the solvent gave 65 mg of solid which was purified by column chromatography on silica using MeOH/CH₂Cl₂ (3%-5%) as eluent. Two isomeric products were obtained:

The first eluted product (18 mg) was recrystallized from chloroform and MeOH to afford Compound 160 (12 mg). M.p. 196-197° C. ¹H n.m.r. (CDCl₃, 500 MZ), δ 7.52, 1H, d, J1.8 Hz; 7.38-7.33, 2H, m; 7.20, 1H, d, J1.6 Hz; 6.32, 1H, d, J1.7 Hz; 3.68, 3H, s.

The second eluted product Compound 93 was obtained as a solid (30 mg). M.p. 175-186° C. ¹H n.m.r. (CDCl₃, 2 drops of DMSO), δ 747, 1H, d, J1.3 Hz; 7.41, 1H, d, J8.7 Hz; 7.33, 1H, dd, J₁8.9 Hz, J₂2.4 Hz; 7.20, 1H, d, J2.4 Hz; 6.28, 1H, d, J1.3 Hz; 3.66, 3H, s.

The following trifluoromethanesulfonamide compounds, as listed by Table 14, were prepared using the same method described in Example 24A: 94 and 95.

Additional data for compounds of Example 24 are provided by Table 14 below.

TABLE 14

| Cpd # | ¹H n.m.r.(400MHz, CDCl₃) |
|---|---|
| 94 | 7.80, 1H, d, J1.8Hz; 7.43-7.31, 5H, m; 7.27, |
| | 1H, d, J2.1Hz; 7.23, 2H, m; 6.55, 1H, d, J1.8Hz. |
| 95 | 7.71, 1H, d, J2.5Hz; 7.70, 1H, d, J8.9Hz; |
| | 7.67, 1H, d, J2.4Hz; 7.29, 1H, dd, J₁8.9Hz, |
| | J₂2.4Hz; 6.76, 1H, dbr. |

### Example 25

### Preparation of N-[2-(1-4′-chlorophenyl-1H-pyrazol-5-yl)-4-chlorophenyl]-trifluoromethanesulfonamide (Compound 108)

N-(2-(3-dimethylamino)acryloyl-4-chlorophenyl)-trifluoromethanesulfonamide (50 mg, 0.14 mmol) and 4-chlorophenylhydrazine hydrochloride (30 mg, 0.168 mmol) were mixed in methanol (3 mL) and the reaction was stirred at RT for 5 hrs. The solvent was removed under vacuum and the residue was purified by column chromatography on silica using MeOH/CH₂Cl₂ (0%-3%) as eluent. Compound 108 was obtained as a solid (44 mg). M.p. 172-174° C. ¹H n.m.r. (CDCl₃), δ 7.81, 1H, d, J1.8 Hz, 7.48, 1H, d, J8.8 Hz; 7.42, 1H, dd, J₁8.8 Hz, J₂2.4 Hz; 7.32, 2H, dt, J₁8.8 Hz, J₂2.5 Hz; 7.23, 1H, d, J2.3 Hz; 7.17, 2H, dt, J₁8.8 Hz, J₂2.5 Hz; 6.75, 1H, br; 6.56, 1H, d, J1.8 Hz.

### Example 26

### Preparation of N-[2-[1-(N′-Acetyl-N′-phenyl)hydrazono)]ethyl-4-chlorophenyl]-trifluoromethanesulfonamide (Compound 183)

2-Formyl-1-phenylhydrazine was prepared by treating phenylhydrazine with formic acid according to the method of De Vries, H. J. F. Chem. Ber. 1894, 27, 15220. Acetylation of this product by treatment with acetic anhydride at 100° C. was followed by selective cleavage of the formyl group with hydrochloric acid to give 1-acetyl-1-phenylhydrazine (Behrend, R; Reinsberg, W. Justus Liebig's Ann. Chem. 1910, 377, 189.). M.p. 124° C. (lit. 124° C.). ¹H n.m.r. δ (CDCl₃) 7.60-7.26, 5H, m; 2.19-2.19, 3H, m.

A mixture of N-(2-acetyl-4-chlorophenyl)-trifluoromethanesulfonamide (106 mg, 0.353 mmol), 1-acetyl-1-phenylhydrazine (53 mg, 0.353 mmol) and toluene (10 mL) was refluxed under Dean-Stark conditions for 22 h then evaporated. The residue was chromatographed through a column of 10 g of silica (eluting with a gradient of 8 to 20% EtOAc in PE) to give Compound 183 as a pale yellow oil (101 mg, 66%) which solidified on standing. ¹H n.m.r. δ (CDCl₃) 12.73, 1H, brs; 7.72, 1H, d, J9.0 Hz; 7.56, 1H, d, J2.5 Hz; 7.49, 2H, m; 7.43-7.34, 4H, m; 2.32, 3H, s; 2.11, 3H, s. APCl-MS 432 m/z (M-1).

### Example 27

### N-[4-Chloro-2-(1-(2(3H)-oxo-benzoxazol-3-yl)imino)ethylphenyl]-trifluoromethanesulfonamide (Compound 184)

3-Amino-2(3H)-benzoxazolone was prepared by treating 2(3H)-benzoxazolone with aqueous sodium carbonate and hydroxylamine O-sulfonic acid according to the method of Anderson, D. J.; Gilchrist, T. L.; Horwell, D. C.; Rees, C. W. J. Chem. Soc. (C), 1970, 576.

A mixture of N-(2-acetyl-4-chlorophenyl)-trifluoromethanesulfonamide (183 mg, 0.606 mmol) and 3-amino-2(3H)-benzoxazolone (100 mg, 0.666 mmol) and toluene (10 mL) was refluxed with azeotropic removal of water for 21 h then evaporated. The residue was chromatographed through a short silica column. Residual acetophenone triflamide was eluted with 1:1 CH₂Cl₂/PE to 100% CH₂Cl₂. Subsequent elution with 100% CH₂Cl₂ to 2% MeOH in CH₂Cl₂ gave Compound 184 as a colorless solid (17 mg, 6%). M.p. 133-138° C. ¹H n.m.r. (CDCl₃) δ 12.07, 1H, brs; 7.77, d, J2.2 Hz, 1H, 7.73, 1H, d, J8.7 Hz; 7.51, 1H, dd, J18.7, J12.2 Hz; 7.33-7.24, m, 3H, 7.18, m, 1H, 2.62, s, 3H. APCl-MS (−ve) 432 (M-H).

### Example 28

### N-[4-Chloro-2-(1-{4(3)-oxo-quinazolin-3-yl}imino)ethylphenyl]-trifluoromethanesulfonamide (Compound 186)

4(3H)-Quinazolone was prepared by treatment of anthranilic acid with formamide under microwave irradiation as described by Alexandre, F.-R.; Berecibar, A.; Besson, T. Tetrahedron Lett. 2002, 43, 3911. 3-Amino-4(3H)-quinazolone was prepared by treatment of 4(3H)-quinazolone with hydrazine hydrate according to the procedure of Leonard, N. J.; Ruyle, W. V. J. Org. Chem. 1948, 13, 903.

A mixture of 3-amino-4(3H)-quinazolone (75 mg, 0.465 mmol) and N-(2-acetyl-4-chlorophenyl)-trifluoromethanesulfonamide (182 mg, 0.603 mmol) and paratoluenesulfonic acid monohydrate (4.4 mg, 0.0233 mmol) was refluxed in toluene (10 mL) with azeotropic removal of water for 20 h. The mixture was cooled and evaporated and the residue was chromatographed through a short column of silica. Residual acetophenone was eluted with 1:1 CH₂Cl₂/PE in CH₂Cl₂. Subsequent elution with 100% CH₂Cl₂ to 15% EtOAc in CH₂Cl₂ gave Compound 186 (152 mg, 57%) as pale yellow crystals. M.p. 159-168° C. ¹H n.m.r. (CDCl₃) δ 11.58, 1H, brs; 8.37, 1H, d, J8.0 Hz; 8.07, 1H, s; 7.87-7.81, 3H, m; 7.79, 1H, d, J9.1 Hz; 7.73, 1H, d, J2.4 Hz; 7.59, 1H, m; 7.53, 1H, dd, J₁9.1, J₂2.4 Hz; 2.41, 3H, s. APCl-MS (−ve) 443 (M[³⁵Cl]—H) 445 (M[³⁷ Cl]—H).

The following trifluoromethanesulfonamide compounds, as described in Table 15, were prepared using the method of Example, 187, 192 and 199.

TABLE 15

| Cpd # | ¹H n.m.r.(400MHz, CDCl₃) |
|---|---|
| 187^{A} | 11.79, 1H, sbr; 7.77, 1H, d, J9.1Hz; 7.63d, J2.4Hz; 7.45, 1H, |
| | dd, J₁9.1Hz, J₂2.4Hz; 6.94, 1H, sbr; 2.39, 3H, s; 1.58, 3H, s. |
| 192^{B} | 12.04, 1H, sbr; 8.89, 1H, sbr; 7.73, 2H, mbr; 7.49, 1H, dd, |
| | J₁8.8Hz, J₂2.3Hz; 2.54, 3H, s; 2.30, 3H, s. |
| 199 | 11.20, 1H, sbr; 9.97, 1H, sbr; 7.79, d, 1H, J8.9Hz; 7.62, 1H, |
| | d, J2.5Hz; 7.48, 1H, dd, J₁8.9Hz, J₂2.5Hz; |

^{A}Made by the method of Example 26;
^{B}Made by the method of Example 28;

### Example 29

### N-[4-Chloro-2-[1-(N′-methyl-N′-pyrimidin-2-yl)hydrazono)ethyl]phenyl]-trifluoromethanesulfonamide (Compound 190)

A mixture of 2-chloropyrimidine (202 mg, 1.76 mmol), methyl hydrazine (113 μL, 2.12 mmol) and potassium carbonate (256 mg, 1.85 mmol) and ethanol (5 mL) was stirred at ambient temperature for 18 h then filtered through a pad of silica. Due to the volatility of the product, the solvent was not evaporated and the solution was treated directly with N-(2-acetyl-4-chlorophenyl)trifluoromethanesulfonamide (558 mg, 1.85 mmol) in ethanol (5 mL) for 3 h during which time a colourless precipitate formed. The mixture was evaporated and the residue recrystallised from ethanol to give Compound 190 (401 mg, 56%) as colorless needles. M.p. 115.5-116.5° C. ¹H n.m.r. (200 MHz, CDCl₃), δ 8.55, 2H, d, J4.8 Hz; 7.77, 1H, d, J8.8 Hz; 7.48, 1H, d, J2.5 Hz; 7.38, 1H, dd, J₁8.8, J₂2.5 Hz; 6.82, 1H, t, J4.8 Hz; 3.49, 3H, s; 2.42, 3H, s. ¹⁹F n.m.r. (200 MHz, CDCl₃), δ −76.25. LRMS (EI): 407(M.⁺). HRMS (EI): calc for C₁₄H₁₃ClF₃N₅O₂S.⁺, 407.0425. Found, 407.0415.

The following 1-heterocyclyl-1-methylhydrazines were prepared by treatment of the appropriate heteroaryl chlorides with methyl hydrazine under microwave heating (Biotage Initiator microwave reactor) in isopropanol for the temperatures and times indicated:

2-chloropyridine 180° C., 18 h

3,6-dichloropyridazine 180° C., 2 h

2,5-dichloropyridine 180° C., 10 h

2-chloroisoquinoline 180° C., 2 h

After evaporation of the isopropanol and excess methylhydrazine, the hydrazines were treated with 1.0 eq. of N-(2-acetyl-4-chlorophenyl)-trifluoromethanesulfonamide in ethanol at RT for 2 h and the resultant hydrazones isolated by evaporation of the solvent and trituration/crystallisation of the residue from ether/PE. The following trifluoromethanesulfonamide compounds, as listed by Table 16, were prepared by the method of Example 29: 194, 195, 196, 197 and 198.

### Example 29a

### N-[4-Chloro-2-[1-(N′-methyl-N′-pyrazin-2-yl)hydrazono)ethyl]-phenyl]-trifluoromethanesulfonamide (Compound 206)

A mixture of 2-chloropyrazine (202 mg, 1.76 mmol), methyl hydrazine (139 μL, 2.64 mmol) and potassium carbonate (365 mg, 2.64 mmol) and isopropanol (3 mL) was stirred at 150° C. for 4 h in a sealed tube, then filtered and evaporated. The product was treated with N-(2-acetyl-4-chlorophenyl)-trifluoromethanesulfonamide (557 mg, 1.85 mmol) in ethanol (5 mL) for 18 h at RT and then at 60° C. for a further 18 h. The reaction mixture was evaporated and purified by radial chromatography (gradient elution 1:9 PE/CH₂Cl₂ to 100% CH₂Cl₂) to give Compound 206 (536 mg, 75%) as a light brown syrup. ¹H n.m.r. (200 MHz, CDCl₃), δ 8.34-8.26, 2H, m; 8.16, 1H, d, J2.2 Hz; 7.78, 1H, d, J8.9 Hz; 7.54, 1H, d, J2.4 Hz; 7.41, 1H, dd, J₁8.9, J₂2.4 Hz; 3.40, 3H, s; 2.46, 3H, s. LRMS (EI): 407(M.⁺). HRMS (EI): calc for C₁₄H₁₃ClF₃N₅O₂S.⁺, 407.0425. Found, 407.0425.

Treatment of iso-propanol solutions of 1-chloroisoquinoline and 2-chloroquinoxaline with methyl hydrazine in a sealed tube at 130° C. for 4 h gave the corresponding N-(1-isoquinolinyl)-N-methyl hydrazine and N-(2-quinoxalinyl)-N-methyl hydrazine, respectively, after evaporation of the isopropanol and excess methylhydrazine. These hydrazines were then treated with 1.05 eq. of N-(2-acetyl-4-chlorophenyl)-trifluoromethanesulfonamide in EtOH at RT for 18 h and the resultant hydrazones isolated by crystallisation from the reaction mixture (Compound 209) or radial chromatography (Compound 210). The following trifluoromethanesulfonamide compounds, as listed by Table 16, were prepared by the method of Example 29a: 209 and 210.

TABLE 16

| Cpd # | ¹H n.m.r.(400MHz, CDCl₃) unless otherwise specified |
|---|---|
| 195 | 8.42, 1H, d, J5.4Hz; 7.76, 1H, d, J9.0Hz; 7.65, 1H, ddd, J₁8.5Hz, J₂7.2, |
| | J₃1.8Hz; 7.50, d, J₁2.5Hz, 1H; 7.37, 1H, dd, J₁9.0, J₁2.5Hz; 6.88, 1H, dd, |
| | J₁7.2, J₂5.4Hz; 6.83, 1H, d, J8.5Hz; 3.34, 3H, s; 2.42, 3H, s. |
| 194 | 13.10, 1H, sbr; 7.72, 1H, d, J9.0Hz; 7.69, 1H, d, J2.3Hz; 7.44, 1H, dd, |
| | J₁9.0, J₂2.3Hz; 7.38, 1Hd, J9.4Hz; 7.06, 1H, d, J9.4Hz; 3.50, 3H, s; 2.57, |
| | 3H, s. |
| 196 | 13.04, 1H, brs; 8.33, 1H, d, J2.2Hz; 7.76, 1H, d, J8.8Hz; 7.58, 1H, dd, J₁9.2, |
| | J₂2.4Hz; 7.54, 1H, d, J2.4Hz; 7.39, 1H, dd, J₁8.8, J₂2.2Hz; 6.77, 1H, d, |
| | J9.2Hz; 3.32, 3H, s; 2.45, 3H, s. |
| 197 | 13.63, 1H, sbr; 7.74, 1H, d, J8.8Hz; 7.67, 1H, d, J2.4Hz; 7.53, 1H, |
| | apparent t, spacing 7.8Hz; 7.42, 1H, d, J₁8.8, J₂2.4Hz; 6.87, 1H, d, J7.6Hz; |
| | 6.65, 1H, d, J8.0Hz; 3.39, 3H, s; 2.50, 3H, s. |
| 198 | 10.98, 1H, sbr; 8.07, 1H, d, J8.8Hz; 7.91, 1H, d, J8.4Hz; 7.72, 2H, m; 7.66-7.62, |
| | 2H, m; 7.41, 1H, dd, J₁8.8, J₂2.6Hz; 7.37, 1H, m; 7.07, 1H, d, J9.3Hz; |
| | 3.55, 3H, s; 2.50, 3H, s. |
| 205 | (200MHz) δ 12.07, 1H, brs; 7.58, 1H, d, J8.2Hz; 7.44-7.24, 3H, m; 7.11, |
| | 1H, d, J7.5Hz; 7.06-6.93, 3H, m; 3.28, 3H, s; 3.12-3.01, 2H, m; 2.86-2.75, |
| | 2H, m. |
| 209 | (200MHz) δ 8.34-8.15, 2H, m; 7.91-7.58, 4H, m; 7.49-7.30, 3H, m; 3.52, |
| | 3H, s; 2.11, 3H, s. |
| 210 | (200MHz) δ 8.64, 1H, s; 8.01, 1H, dd, J₁7.0, J₂1.5Hz; 7.91, 1H, dd, J₁7.1, |
| | J₂1.5Hz; 7.77, 1H, d, J8.9Hz; 7.73-7.49, 3H, m; 7.45, 1H, dd, J₁8.8, |
| | J₂2.2Hz; 3.57, 3H, s; 2.52, 3H, s. |

### Example 30

### Preparation of N-[2-[1-(N′-cyclopentyl-N′-ethyl)hydrazono)]ethyl-4-chloro-phenyl]-trifluoromethanesulfonamide (Compound 212)

a) tert-butyl carbazate was condensed with cyclopentanone and the resultant hydrazone reduced to N′-cyclopentyl-hydrazinecarboxylic acid tert-butyl ester with sodium cyanoborohydride in acetic acid/water according to the method of Ranatunge, R. R. et al. J. Med. Chem. 2004, 47, 2180.

b) A mixture of N′-cyclopentyl-hydrazinecarboxylic acid tert-butyl ester (274 mg, 1.37 mmol), potassium carbonate (391 mg, 2.83 mmol) and iodoethane (265 mg, 1.70 mmol) and acetonitrile (3 mL) was seated in an Emrys process vial and heated in the microwave to 120° C. for 2 h. After cooling, the mixture was filtered, evaporated and chromatographed though a short column of silica gel, eluting with 10 to 20% EtOAc in PE, to give N′-cyclopentyl-N′-ethyl-hydrazinecarboxylic acid tert-butyl ester (253 mg, 74%) as a colorless oil. ¹H n.m.r. (400 MHz, CDCl₃), δ 5.17, 1H, s br; 3.12, 1H, m br; 2.69, 2H, m br; 1.80-1.64, 5H, m; 1.58-1.41, 12H, m; 1.07, 3H, t, J7.1 Hz.

c) To a solution of IV-cyclopentyl-IV-ethyl-hydrazinecarboxylic acid tert-butyl ester (150 mg, 0.657 mmol) in tetrahydrofuran (6 mL) was added 6N aqueous HCl (6 mL) and the mixture stirred at RT for 10 min, then evaporated to give 1-cyclopentyl-1-ethylhydrazine hydrochloride (90 mg, 83%) hydrochloride as a pale yellow oil.

d) A mixture of the crude 1-cyclopentyl-1-ethylhydrazine hydrochloride (49 mg, 0.298 mmol), potassium carbonate (82 mg, 0.595 mmol) and N-(2-acetyl-4-chlorophenyl)-trifluoromethanesulfonamide (90 mg, 0.298 mmol) in ethanol (4 mL) was refluxed for 1 h. The mixture was filtered and evaporated and chromatographed through a short column of silica gel, eluting with a gradient of 5 to 10% EtOAc in PE. A mobile yellow band gave Compound 212 (60 mg, 49%) as a yellow solid m.p. 113-115° C. 1H n.m.r. (400 MHz, CDCl₃), δ 7.86, 1H, d, J9.2 Hz; 7.61, 1H, d, 42.3 Hz; 7.39, 1H, dd, J₁9.2 Hz, J₂2.3 Hz; 3.47, 1H, m; 3.01, 2H, q, J7.1 Hz; 2.72, 3H, s; 1.89-1.82, 2H, m; 1.74-1.40, 6H, m; 1.05, 3H, t, J7.1 Hz. The following trifluoromethanesulfonamide compounds, as listed by Table 17, were prepared by the method of Example 30: 211, 213-218.

TABLE 17

| Cpd # | ¹H n.m.r.(400MHz, CDCl₃) |
|---|---|
| 211 | 7.78, 1H, d, J9.0Hz; 7.58, 1H, d, J2.6Hz; 7.35, 1H, dd, J₁9.0Hz, J₂2.6Hz; |
| | 3.39, 1H, m; 2.58, s, 6H; 1.96-1.84, 2H, m; 1.76-1.44, 6H, m. |
| 213 | 7.74, 1H, d, J8.8Hz; 7.37, 1H, dd, J₁8.8Hz, J₂2.5Hz; 7.28, 1H, d, J2.5Hz; |
| | 3.59, 1H, m; 2.75, 2H, q, J7.3Hz; 2.46, 3H, s; 2.08-1.99, 2H, m, 1.91-1.80, |
| | 4H, m; 1.70-1.53, 2H, m; 1.11, 3H, t, J7.3Hz. |
| 214 | Obtained as mixture of E/Z-isomers(ratio ca. 3:2) |
| | Major isomer: |
| | 7.79, 1H, d, J9.0Hz; 7.35, 1H, dd, J₁9.0Hz, J₂2.6Hz; 7.25, 1H, d, J2.6Hz; |
| | 3.82, 1H, m; 2.88, 2H, q, J7.3Hz; 2.79, 2H, q, J7.3Hz; 2.03-1.08, 14H. |
| | Minor isomer: |
| | 7.88, 1H, d, J9.1Hz; 7.39, 1H, dd, J₁9.1Hz, J₂2.5Hz; 7.39, 1H, d, J2.5Hz; |
| | 3.46, 1H, m; 3.23, 2H, q, J7.7Hz; 3.02, 2H, q, J7.2Hz; 2.03-1.08, 14H. |
| 215 | 7.80, 1H, d, J8.9Hz; 7.57, 1H, d, J2.3Hz; 7.34, 1H, dd, J₁8.9Hz, J₂2.3Hz; |
| | 2.79, 1H, m; 2.63, 3H, s; 2.58, 3H, s; 1.98-1.78, 4H, m; 1.63, 1H, m; 1.39-1.16, |
| | 5H, m. |
| 216 | 7.88, 1H, d, J9.1Hz; 7.60, 1H, d, J2.4Hz; 7.38, 1H, dd, J₁9.1Hz, J₂2.4Hz; |
| | 3.04, 2H, q, J7.2Hz; 2.87, 1H, m; 2.71, 3H, s; 1.96-1.77, 4H; 1.63, 1H, m; |
| | 1.33-1.10, 5H, m; 1.06, 3H, t, J7.2Hz. |
| 217 | 7.71, 1H, d, J8.8Hz; 7.35, 1H, dd, J₁8.8Hz, J₂2.5Hz; 7.27, 1H, d, J2.5Hz; |
| | 3.02, 1H, m; 2.76, 2H, q, J7.4Hz; 2.48, 3H, s; 2.16, 2H, m; 1.89, 2H, m; |
| | 1.69, 1H, m; 1.54, 2H, m; 1.34-1.16, 3H, m; 1.11, 3H, t, J7.4Hz. |
| 218 | Obtained as mixture of E/Z-isomers(ratio ca. 2:1) |
| | Major isomer: |
| | 7.79, 1H, d, J9.1Hz; 7.35, 1H, dd, J₁9.1, J₂2.5Hz; 7.25, 1H, d, J2.5Hz; 3.09-2.77, |
| | 5H, m; 2.04-1.07, 16H, m. |
| | Minor isomer: |
| | 7.89, 1H, d, J9.1Hz; 7.59, 1H, d, J2.5Hz; 7.39, 1H, dd, J₁9.2, J₂2.5Hz; 3.22, |
| | 2H, q, J7.7Hz; 3.09-2.77, 3H, m; 2.04-1.07, 16H, m. |

### Example 31

### Preparation of N-[4-Chloro-2-(1-phenyl-4,5-dihydro-1H-pyrazol-3-yl)-phenyl]-trifluoromethanesulfonamide (Compound 229)

a) 1-(5-Chloro-2-nitrophenyl)-propenone was prepared by addition of vinyl magnesium bromide to 5-chloro-2-nitrobenzaldehyde and Jones oxidation of the resultant allylic alcohol according to the procedure of Danishefsky et al. J. Org. Chem. 1993, 58, 611.

b) To an ice-cooled solution of 1-(5-chloro-2-nitrophenyl)-propenone (310 mg, 1.47 mmol) in ethanol (10 mL) was added phenylhydrazine (158 mg, 1.47 mmol). An orange colour developed almost immediately. The mixture was removed from the cold bath and allowed stir at ambient temperature for 20 min, then evaporated to give a red syrup. The crude product was purified by chromatography through a short column of silica gel, eluting with a gradient of 10 to 20% EtOAc in PE. The major orange fraction yielded 3-(5-chloro-2-nitrophenyl)-1-phenyl-4,5-dihydro-1H-pyrazole (203 mg, 46%) as an orange-red solid. ¹H n.m.r. (400 MHz, CDCl₃), δ 7.65-7.62, 2H, m; 7.37, 1H, dd, J₁8.8 Hz, J₂2.3 Hz; 7.30, 2H, m; 7.07, 2H, d, J7.5 Hz; 6.91, 1H, t, J7.3 Hz; 3.97, 2H, t, J10.7 Hz; 3.16, 2H, t, J10.7 Hz. (This and other nitroarylpyrazolines were unstable in solution towards oxidation and were therefore not further characterized).

c) A mixture of 3-(5-chloro-2-nitrophenyl)-1-phenyl-4,5-dihydro-1H-pyrazole (105 mg, 0.347 mmol) and tin (11) chloride (223 mg, 1.18 mmol) in ethanol (7 mL) was refluxed for 2.5 h then the pH was adjusted to ca. 7 by addition of saturated NaHCO₃ solution. After cooling, the mixture was filtered through Celite, washing with EtOAc. The filtrate was partitioned between EtOAc and water, then washed successively with water and brine, dried and evaporated. The crude product was chromatographed through a short column of silica gel, eluting with a gradient of 25 to 50% CH₂Cl₂ in PE, to give 4-chloro-2-(1-phenyl-4,5-dihydro-1H-pyrazol-3-yl)-phenylamine (58 mg, 61%) as a yellow solid. 1H n.m.r. (400 MHz, CDCl₃) δ 7.31, 2H, t, J8.0 Hz; 7.13, 1H, d, J2.1 Hz; 7.08-7.01, 3H, m; 6.88, 1H, t br, J7.3 Hz; 6.67, 1H, d, J8.5 Hz; 5.86, 2H, s br; 3.83, 2H, t br, J10.3 Hz; 3.32, 2H, t, J10.3 Hz.

Alternatively; 3-(5-chloro-2-nitrophenyl)-1-phenyl-4,5-dihydro-1H-pyrazole 9121 mg, 0.470 mmol) was dissolved in acetic acid (8 mL) with warming and conc. HCl (3 drops) was added. This mixture was transferred to a flask containing 10% Pd—C (50 mg) under an atmosphere of argon and the mixture was hydrogenated at 1 atm. H₂ for 2 h. The mixture was filtered through a pad of Celite, and the filter pad washed successively with water, sat. NaHCO₃ and EtOAc. The filtrate was partitioned between EtOAc and sat. NaHCO₃. The organic phase washed successively with sat. NaHCO₃ and brine, dried and evaporated to give a yellow solid. Chromatography as above gave 4-chloro-2-(1-phenyl-4,5-dihydro-1H-pyrazol-3-yl)-phenylamine (50 mg, 39%) as above.

d) To an ice-cooled solution of 4-chloro-2-(1-phenyl-4,5-dihydro-1H-pyrazol-3-yl)-phenylamine (58 mg, 0.213 mmol) in CH₂Cl₂ (5 mL) was added a solution of trifluoromethanesulfonic anhydride (90 mg, 0.320 mmol) in CH₂Cl₂ (2 mL) and the mixture stirred at RT for 4 h. The mixture washed with water, then brine, dried and evaporated. The crude product was chromatographed through a short column of silica gel, eluting with a gradient 25 to 50% CH₂Cl₂ in PE to give Compound 229 (62 mg, 72%) as a yellow solid. M.p. 138-163° C. ¹H n.m.r. (400 MHz, CDCl₃), δ 11.99, 11, s br; 7.71, 1H, d, J8.9 Hz; 7.35, 2H, dd, J₁8.3 Hz, J₂7.3 Hz; 7.31-7.26, 2H, m; 7.01, 2H d, J7.7 Hz; 6.96, 1H, t, J7.3 Hz; 3.97, 2H, t, J10.8 Hz; 3.37, 2H, t, J10.8 Hz.

The following trifluoromethanesulfonamide compounds, as listed by Table 18, were prepared by the method of Example 31: 226, 228, 231, 232 and 233.

TABLE 18

| Cpd # | ¹H n.m.r.(400MHz, CDCl₃) |
|---|---|
| 226 | 12.13, 1H, sbr; 7.78, 1H, d, J8.0HZ; 7.36, 4H, m; 7.22, m, 1H; 7.03, 2H, m; |
| | 6.94, 1H, m; 3.95, 2H, t, J10.6Hz; 3.41, 2H, tJ10.6Hz. 19FNMR-76.73. |
| 228 | 11.96, 1H, sbr; 7.73, 1H, d, J9.0Hz; 7.33-7.30, 2H, m; 7.22, 1H, td, J₁8.4Hz, |
| | J₂1.6Hz; 7.15-7.08, 2H, m; 7.00-6.95, 1H, m; 4.08, 2H, td, J₁10.7Hz, |
| | J₂2.2Hz; 3.36, 2H, t, J10.7Hz. |
| 231 | 11.80, 1H, sbr; 7.71, 1H, d, J8.8Hz; 7.31, 1H, dd, J₁8.8Hz, J₂2.5Hz; 7.28-7.23, |
| | 2H, m; 6.92, 3Hm; 3.95, 2H, t, J10.6Hz; 3.40, 2H, t, J10.6Hz. |
| | ¹⁹FNMR-76.70 |
| 232 | 11.81, 1H, sbr; 7.71, 1H, d, J8.8Hz; 7.33-7.26, 3H, m; 6.80, 1H, dd, J₁8.2Hz, |
| | J₂1.4Hz; 6.68-6.62, 2Hm; 3.96, 2H, t, J10.6Hz; 3.41, 2H, t, J10.6Hz. |
| 233 | 11.91, 1H, sbr; 7.68, 1H, d, J8.8Hz; 7.30-7.25, 2H, m; 7.04, 2H, m; 6.94-6.91, |
| | 2H, m; 3.92, 2H, t, J10.6Hz; 3.36, 2H, t, J10.6Hz. |
| 234 | 11.84, 1H, sbr; 7.69, 1H, m; 7.34-7.27, 4H, m; 6.91, 2H, m; 3.94, 2H, |
| | tJ10.8Hz; 3.39, 2H, t, J10.8Hz. |

### Example 32

### Preparation of Compound 230: N-[4-Chloro-2-[1-phenyl-1H-pyrazol-3-yl]-phenyl]-trifluoromethanesulfonamide

To a solution of the Compound 229 (33 mg, 0.0817 mmol) in dry CH₂Cl₂ (5 mL) was added 2,3-dichloro-5,6-dicyano-1,4-benzoquinone (56 mg, 0.246 mmol). The mixture immediately became dark green. After 2 h the mixture was partitioned between saturated aqueous sodium bicarbonate and CH₂Cl₂. The organic phase washed with brine, dried and evaporated to give the pyrazole 229 (23 mg, 70%) as a pale yellow solid. M. p. 119-120° C. ¹H NMR 6 (400 MHz) 12.14, 1H, s br; 8.03, 1H, d, J2.5 Hz; 7.71, 1H, d, J8.9 Hz; 7.70, 1H, d, J2.2 Hz; 7.65, 1H, d, J8.3 Hz; 7.65, 2H, t, J7.6 Hz; 7.37, 2H, t, J7.5 Hz; 7.31, 1H, dd, J₁8.8 Hz, J₂2.5 Hz; 6.89, 1H, d, J2.5 Hz,

### Example 33

N-[8-(N′-methyl-N′-phenyl)hydrazono-5,6,7,8-tetrahydro-naphthalen-1-yl]-trifluoromethanesulfonamide (Compound 219)

a) 8-Amino-3,4-dihydro-2H-naphthalen-1-one was prepared in three steps from 5,6,7,8-tetrahydro-A-naphthylamine, according to the procedure of Nguyen, P.; Corpuz, E.; Heidelbaugh, T. M.; Chow, K. and Garst, M. E., J. Org. Chem. 2003, 68, 10195-10198.

b) A solution of 8-amino-3,4-dihydro-2H-naphthalen-1-one (400 mg, 2.48 mmol) in dry CH₂Cl₂ (30 mL) was cooled to −10° C. and a solution of trifluoromethanesulfonic anhydride (421 μL, 2.50 mmol) in dry CH₂Cl₂ (20 mL) was added dropwise, maintaining the temperature below 0° C. The reaction mixture was allowed to warm to RT and stirred for 18 h, then partitioned between water and CH₂Cl₂. The combined organic extracts were washed with water (×2) and brine (×1) then dried and concentrated. The residue was purified by radial chromatography (eluting with 1:1 CH₂Cl₂/PE to 100% CH₂Cl₂) to afford N-(8-oxo-5,6,7,8-tetrahydro-naphthalen-1-yl)-trifluoromethanesulfonamide (543 mg, 75%) as a yellow oil. ¹H n.m.r (400 MHz, CDCl₃), δ 12.81, 1H, s br; 7.62, 1H, d, J8.4 Hz; 7.48, 1H, app t, spacing 8.0 Hz; 7.07, 1H, d br, J7.6 Hz; 3.04-2.98, 2H, m; 2.78-2.72, 2H, m; 2.17-2.09, 2H, m. ¹⁹F n.m.r. (200 MHz, CDCl₃), 6-76.87. LRMS (EI): 293(M.⁺). HRMS (EI): calc for C₁₁H₁₀F₃NO₃S.⁺, 293.0328. Found, 293.0324.

c) A mixture of N-(8-oxo-5,6,7,8-tetrahydro-naphthalen-1-yl)-trifluoromethanesulfonamide (111 mg, 0.38 mmol), 1-methyl-1-phenylhydrazine (49 μL, 0.42 mmol) and ethanol (5 mL) was stirred at RT for 18 h. The reaction mixture was concentrated and purified by radial chromatography (1:1 EtOAc/PE) to give Compound 219 (120 mg, 79%) as a bright yellow oil. ¹H n.m.r. (200 MHz, CDCl₃), δ 9.81, 1H, s br; 7.68, 1H, d, J8.3 Hz; 7.38-7.23, 3H, m; 7.09-6.89, 4H, m; 3.28, 3H, s; 2.92-2.81, 2H, m; 2.80-2.68, 2H, m; 1.94-1.78, 2H, m. ¹⁹F n.m.r. (200 MHz, CDCl₃), δ −77.26. LRMS (EI). 397(M.⁺).

The following trifluoromethanesulfonamide compound, as listed by Table 19, was prepared by the method of Example 33: 205.

TABLE 19

| Cpd # | ¹H n.m.r.(200MHz, CDCl₃) |
|---|---|
| 205 | δ 12.07, 1H, brs; 7.58, 1H, d, J8.2Hz; 7.44-7.24, 3H, m; 7.11, |
| | 1H, d, J7.5Hz; 7.06-6.93, 3H, m; 3.28, 3H, s; 3.12-3.01, 2H, m; |
| | 2.86-2.75, 2H, m. |

### Example 34

### Listing of Exemplified Compounds

A total of 234 compounds have been prepared according to the methods of Examples 1-33, as described above. These are summarized by Table 20, hereinbelow, as follows.

### Abbreviations for Table 20

“C#” is the compound number, “[M⁺]” is the mass reading by high resolution mass spectroscopy; and “MP” is the melting point of the compound, in ° C., where available. For convenience, all compounds have been drawn as single anti(E)-isomers about the C═N bond.

Table 20 provides compounds 1-234, based on Formula Ia, Formula 1b and Formula 1c, supra.

TABLE 20

| Cpd | | | |
|---|---|---|---|
| # | Compound Structure | Mp(° C.) | [M⁺] |
| 1 | 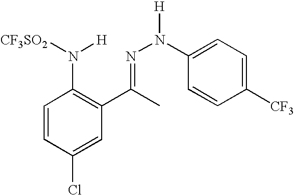 | 205-207.5 | |
| 2 | 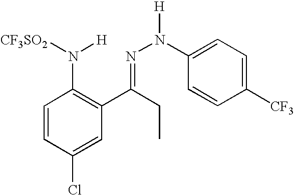 | 165 | |
| 3 | 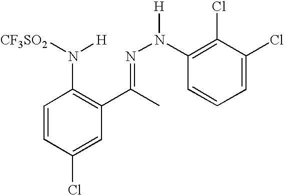 | 144-146.5 | |
| 4 | 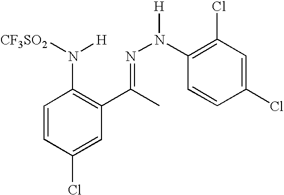 | 163-165 | |
| 5 | 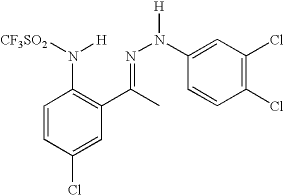 | 186-188 | |
| 6 | 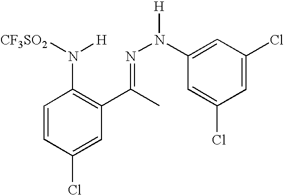 | 174.5-176.5 | |
| 7 | 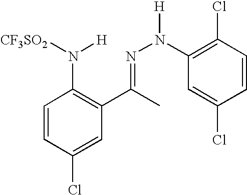 | 146-148 | |
| 8 | 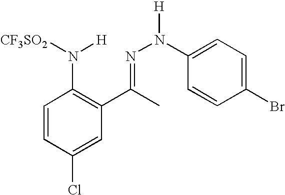 | 209-211 | |
| 9 | 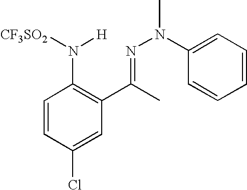 | 75-76 | |
| 10 | 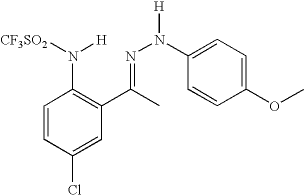 | 151-153 | |
| 11 | 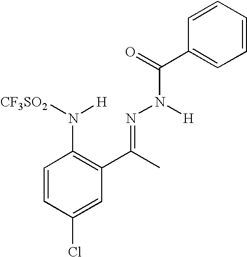 | 181.5-183 | |
| 12 | 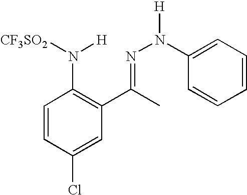 | 159.5-160 | |
| 13 | 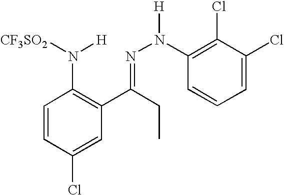 | 153-155 | |
| 14 | 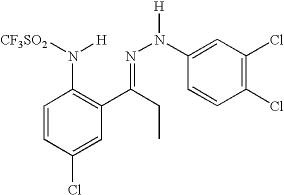 | 158-160 | |
| 15 | 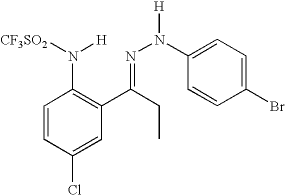 | 159-160 | |
| 16 | 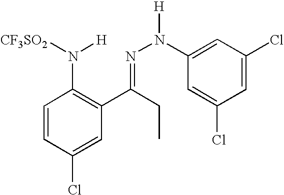 | 172-174 | |
| 17 | 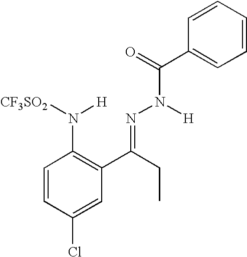 | 158-159.5 | |
| 18 | 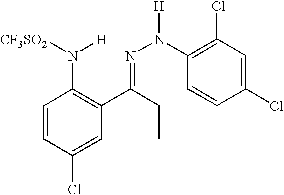 | 127.5-129 | |
| 19 | 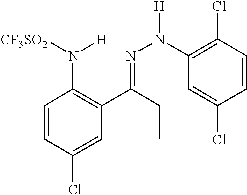 | 135.5-138 | |
| 20 | 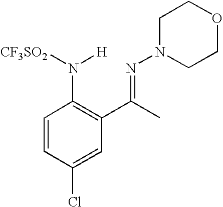 | 115-115.5 | |
| 21 | 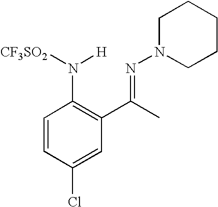 | 124-125 | |
| 22 | 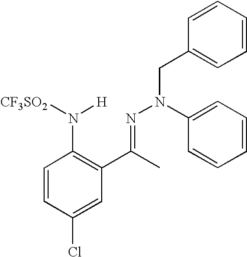 | | |
| 23 | 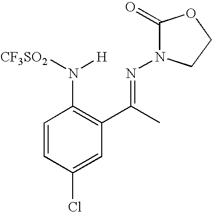 | 145-146.5 | |
| 24 | 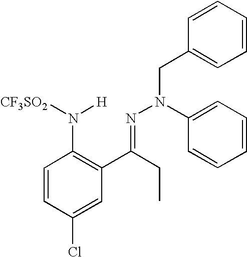 | 132-135 | |
| 25 | 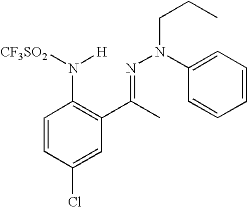 | | |
| 26 | 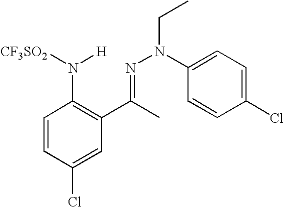 | 118-120 | |
| 27 | 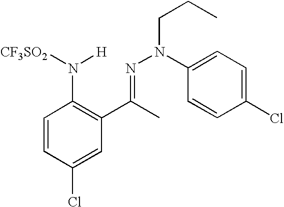 | 115-117 | |
| 28 | 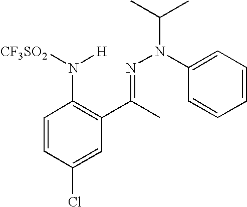 | 106-108 | |
| 29 | 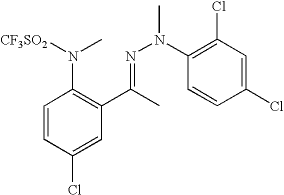 | 90-94 | |
| 30 | 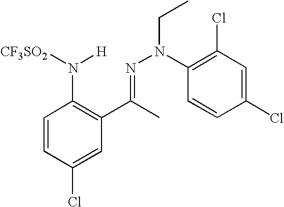 | 78-81 | |
| 31 | 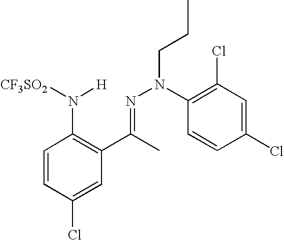 | 96-98 | |
| 32 | 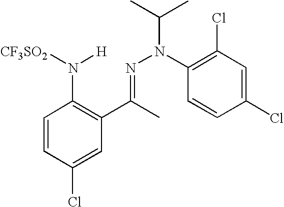 | | |
| 33 | 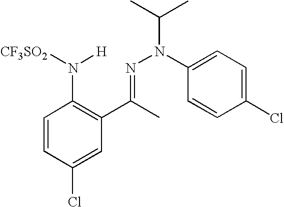 | 134.5-136 | |
| 34 | 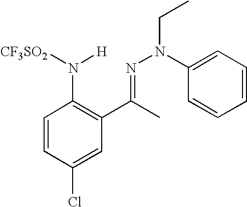 | 111-114 | |
| 35 | 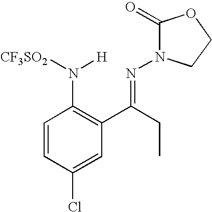 | 115-117 | |
| 36 | 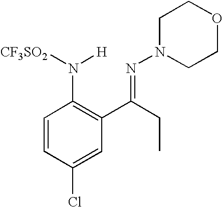 | 78-80 | |
| 37 | 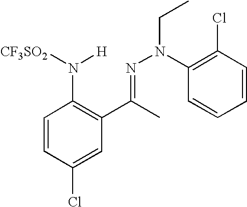 | 70-71.5 | |
| 38 | 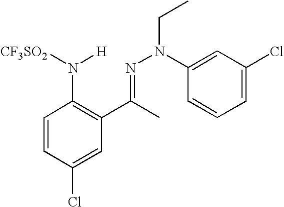 | 78-80 | |
| 39 | 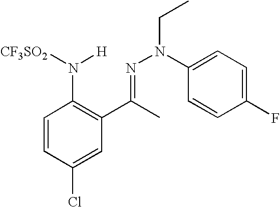 | 113-114 | |
| 40 | 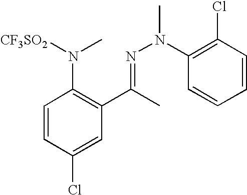 | 119-121 | |
| 41 | 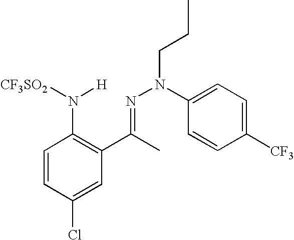 | 105.5-106.5 | |
| 42 | 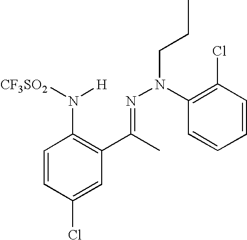 | 92-94 | |
| 43 | 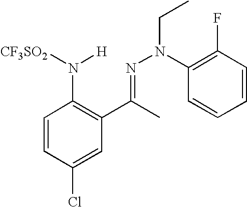 | 89.5-90.5 | |
| 44 | 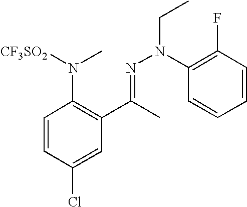 | 55-65 | |
| 45 | 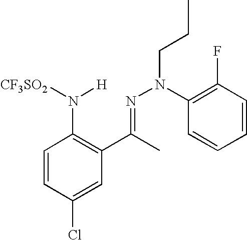 | | Found: 451.0734 Requires: 451.0744 |
| 46 | 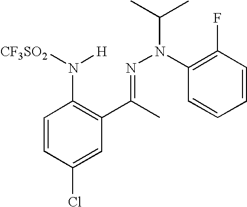 | 78-85 | |
| 47 | 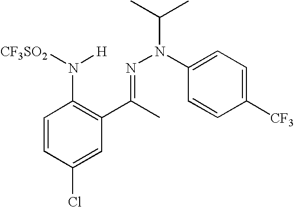 | 103.5-104.5 | |
| 48 | 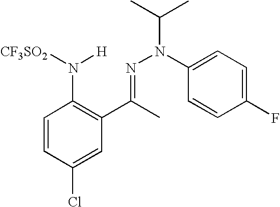 | 112-120 | |
| 49 | 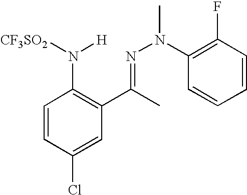 | 70.6-71.2 | |
| 50 | 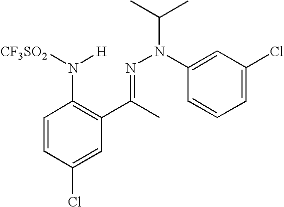 | | |
| 51 | 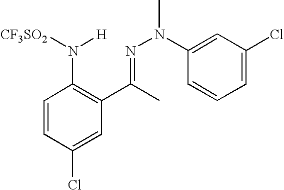 | 81-82 | |
| 52 | 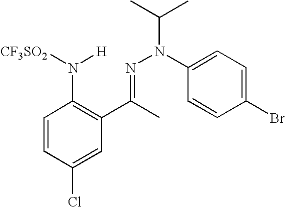 | 143-145 | |
| 53 | 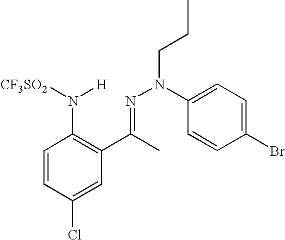 | 132-133.5 | |
| 54 | 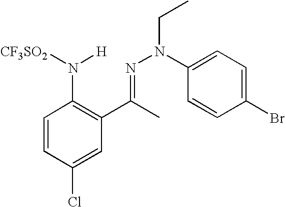 | 79-90 | |
| 55 | 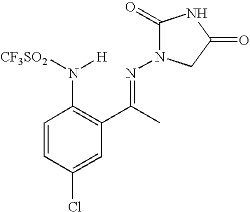 | 184-185 | |
| 56 | 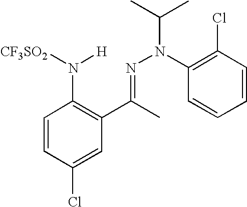 | 71-73 | Found: 467.0418 Requires: 467.0449 |
| 57 | 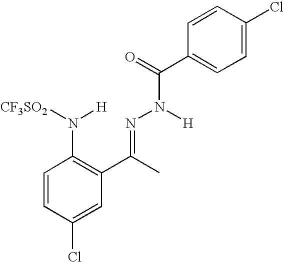 | 121.5-122.5 | |
| 58 | 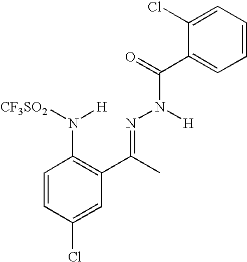 | 156-156.5 | |
| 59 | 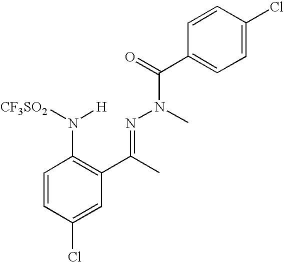 | | |
| 60 | 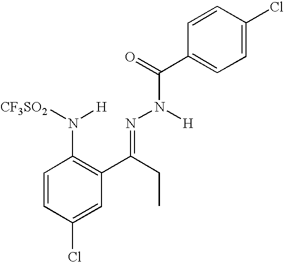 | 177.5-178.5 | |
| 61 | 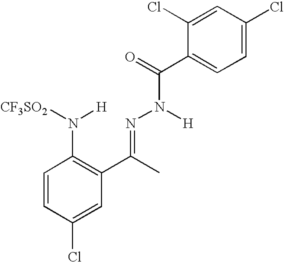 | 86-87 | |
| 62 | 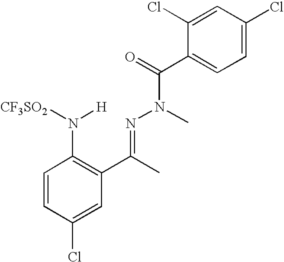 | | |
| 63 | 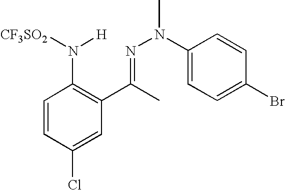 | 84-92 | |
| 64 | 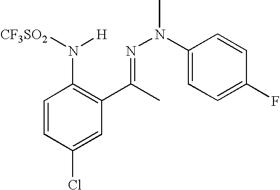 | 80-93 | |
| 65 | 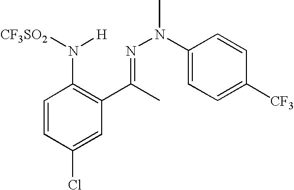 | 111-113 | |
| 66 | 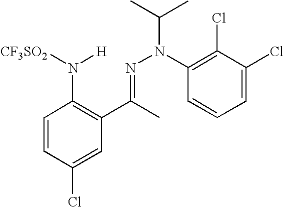 | 131-132.5 | |
| 67 | 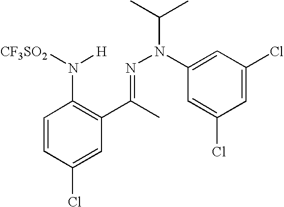 | 87.5-89 | |
| 68 | 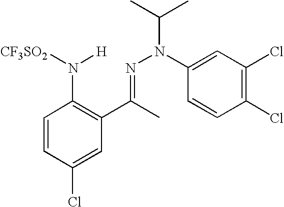 | 103.5-105 | |
| 69 | 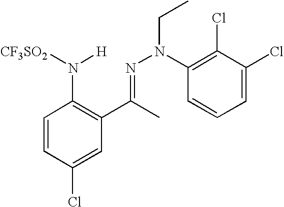 | 96.5-98.5 | |
| 70 | 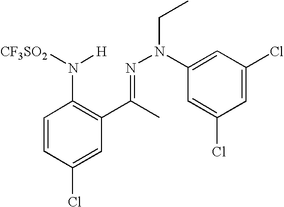 | 119-121 | |
| 71 | 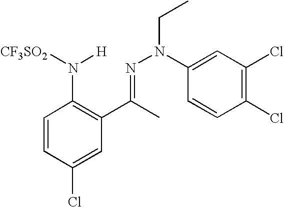 | 101-101.5 | |
| 72 | 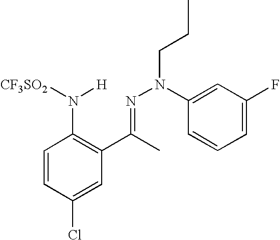 | 48 | Found: 451.0735 Requires: 451.0739 |
| 73 | 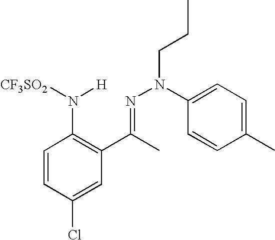 | 108.5-111 | |
| 74 | 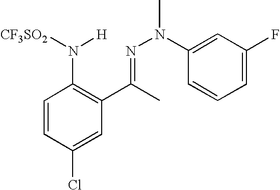 | 90-91.5 | |
| 75 | 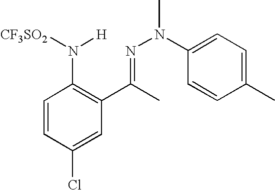 | 78-88 | |
| 76 | 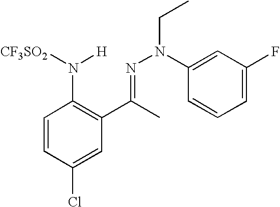 | 93-94.5 | |
| 77 | 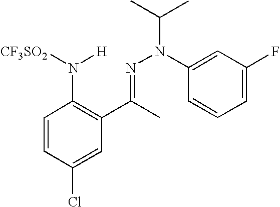 | 90.5-92.5 | |
| 78 | 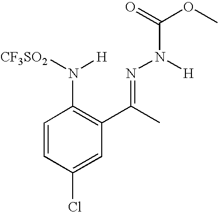 | 211.2-214.3 | |
| 79 | 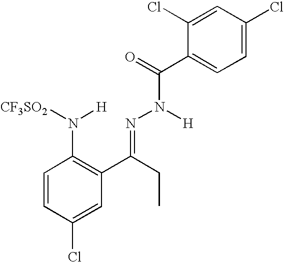 | 184.5-186 | |
| 80 | 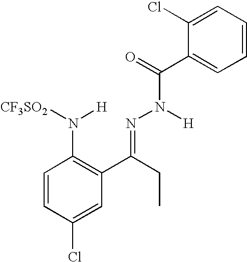 | 147.8-148.3 | |
| 81 | 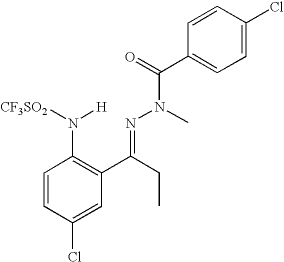 | | |
| 82 | 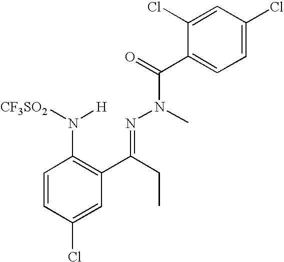 | | |
| 83 | 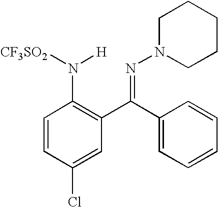 | 192-195 | |
| 84 | 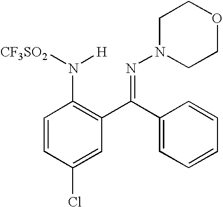 | 155-157 | |
| 85 | 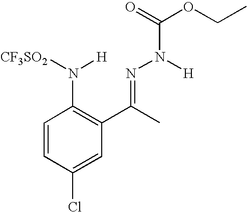 | 175.3-176.4 | |
| 86 | 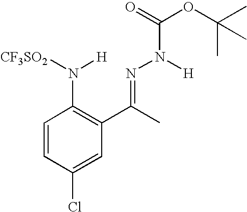 | 183.5-186.0 | |
| 87 | 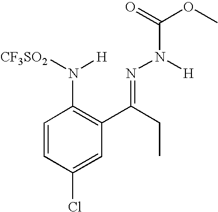 | 177.0-179.0 | |
| 88 | 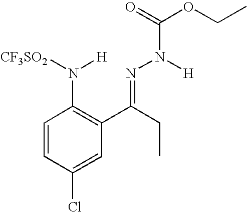 | 190.5-192.2 | |
| 89 | 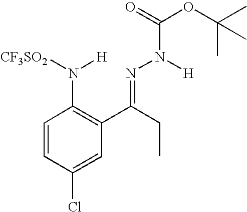 | 158.2-159.8 | |
| 90 | 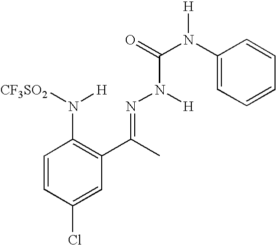 | 225.6-228.0 | |
| 91 | 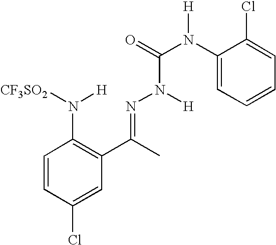 | 204.2-205.6 | |
| 92 | 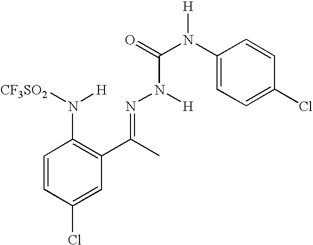 | 209.0-211.9 | |
| 93 | 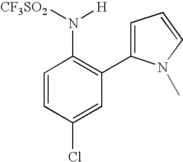 | (Crystal transition at 175) 186 | |
| 94 | 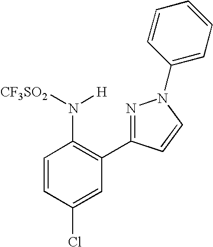 | 158-163 | |
| 95 | 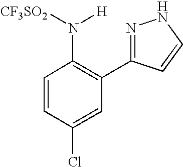 | 146-148 | |
| 96 | 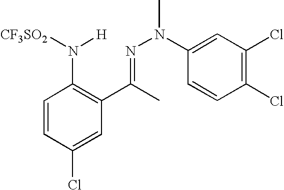 | 128-130 | |
| 97 | 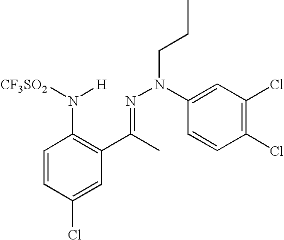 | 78.5-80 | |
| 98 | 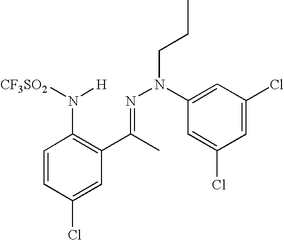 | | |
| 99 | 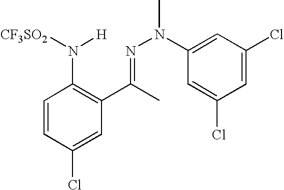 | 139.5-141 | |
| 100 | 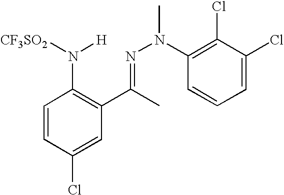 | 108-110 | |
| 101 | 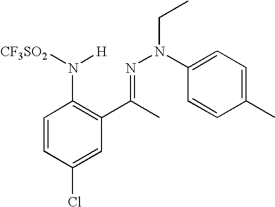 | 91-92 | |
| 102 | 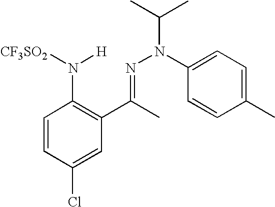 | 85.5-87 | |
| 103 | 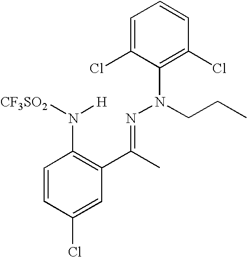 | 57-59 | |
| 104 | 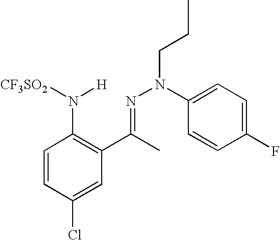 | 67-68.5 | |
| 105 | 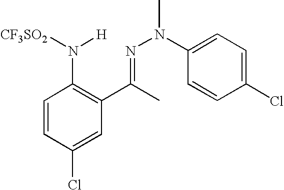 | 80-82.5 | |
| 106 | 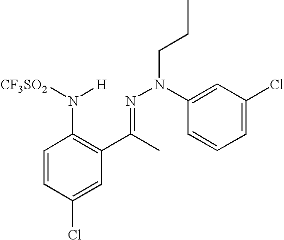 | | |
| 107 | 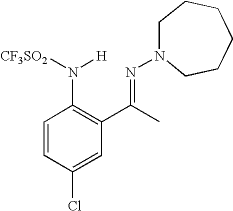 | 89.5-91.5 | |
| 108 | 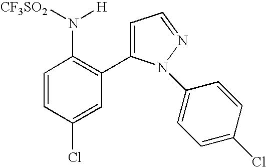 | 172-174 | |
| 109 | 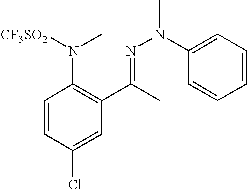 | 100-102 | |
| 110 | 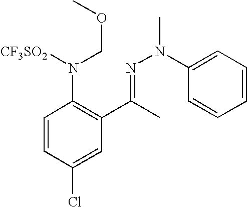 | 94-96 | |
| 111 | 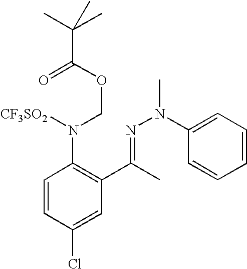 | | Found: 519.1190 Requires: 519.1206 |
| 112 | 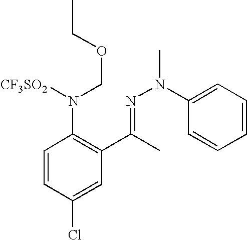 | | Found: 463.0934 Requires: 463.0944 |
| 113 | 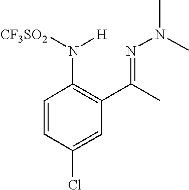 | 108-110 | |
| 114 | 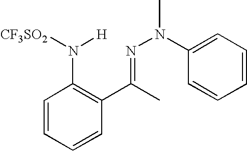 | | Found: 371.0920 Requires: 371.0910 |
| 115 | 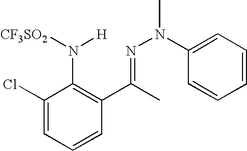 | 119-120.5 | Found: 405.0524 Requires: 405.0520 |
| 116 | 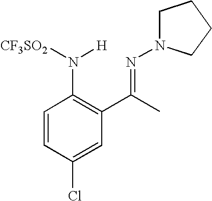 | 103.5-105 | |
| 117* | 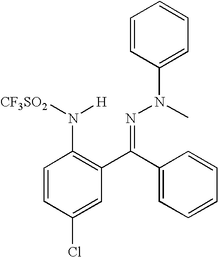 | | Found: 467.0678 Requires: 467.0677 |

*Compound 117 exists as either a single syn (Z) or anti (E) isomer

| | | | |
|---|---|---|---|
| 118* | 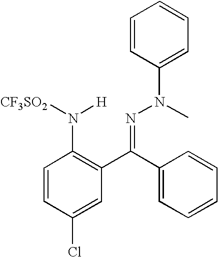 | 96-98 | Found: 467.0678 Requires: 467.0677 |

*Compound 118 exists as either a single syn (Z) or anti (E) isomer

| | | | |
|---|---|---|---|
| 119 | 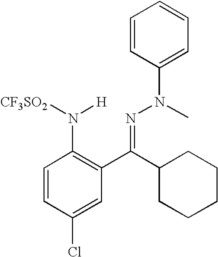 | 182-185 | |
| 120 | 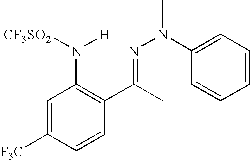 | 91-93.5 | Found: 339.0788 Requires: 439.0784 |
| 121 | 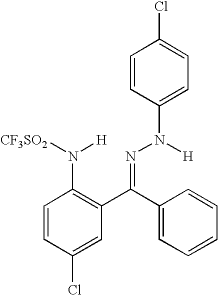 | 158-160 | Found: 487.0144 Requires: 487.0130 |
| 122 | 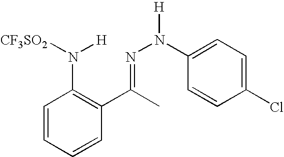 | 153-155 | Found: 391.0360 Requires: 391.0364 |
| 123 | 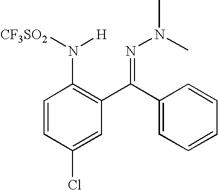 | 152-154 | Found: 405.0528 Requires: 405.0520 |
| 124 | 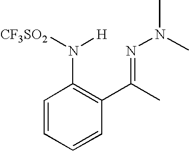 | 84-86 | Found: 309.0748 Requires: 309.0753 |
| 125 | 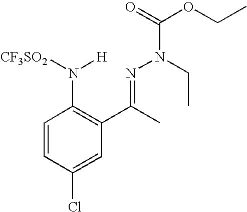 | | |
| 126 | 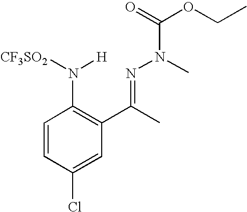 | | |
| 127 | 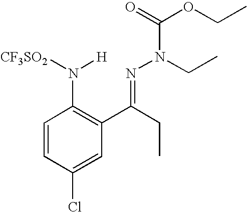 | | |
| 128 | 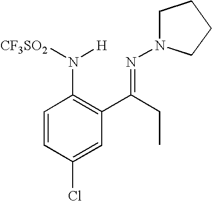 | 113-115 | |
| 129 | 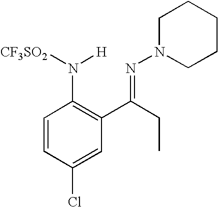 | 118-120 | |
| 130 | 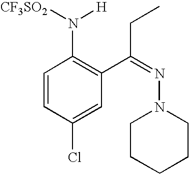 | 123-125 | |
| 131 | 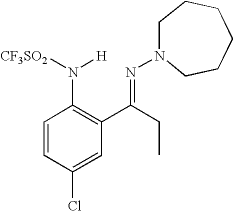 | 119-121 | |
| 132 | 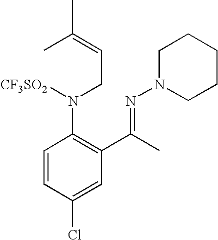 | | Found: 451.1298 Requires: 451.1303 |
| 133 | 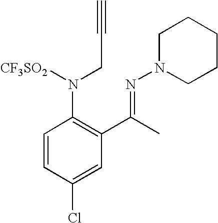 | 86-90 | |
| 134 | 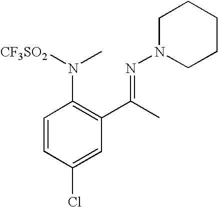 | 100-102 | |
| 135 | 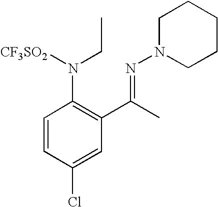 | 70-72.5 | |
| 136 | 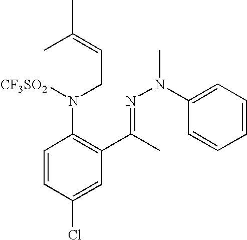 | | |
| 137 | 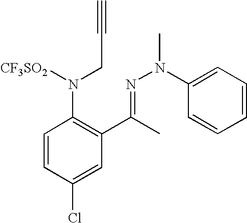 | 69-70 | |
| 138 | 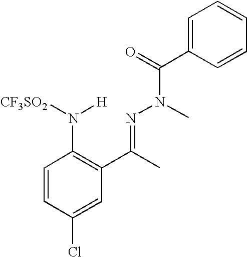 | | Found: 433.0461 Requires: 433.0475 |
| 139 | 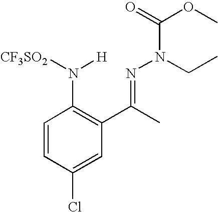 | | |
| 140 | 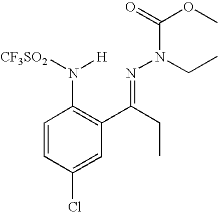 | | |
| 141 | 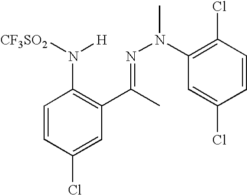 | 89-92 | |
| 142 | 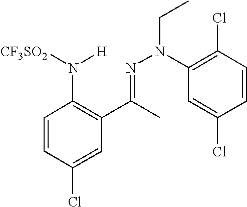 | 110-112 | |
| 143 | 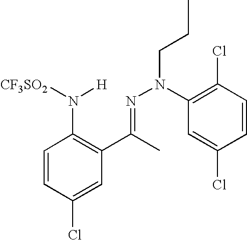 | 102-105 | |
| 144 | 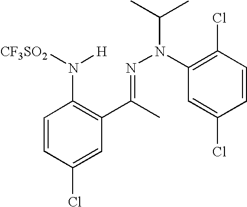 | 123-125 | |
| 145 | 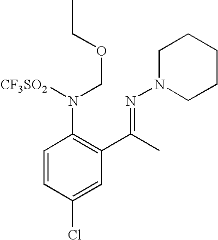 | 65-67 | |
| 146 | 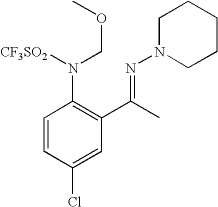 | 82-85 | |
| 147 | 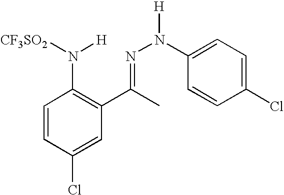 | | |
| 148 | 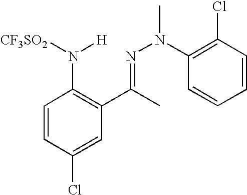 | 90-93 | |
| 149 | 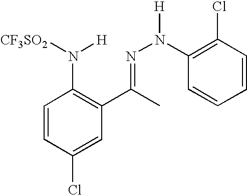 | 137.5-139 | |
| 150 | 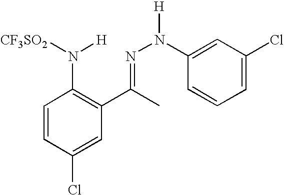 | | |
| 151 | 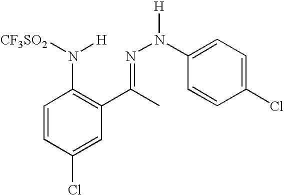 | | |
| 152 | 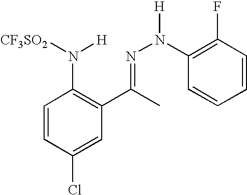 | | |
| 153 | 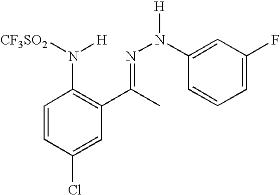 | | |
| 154 | 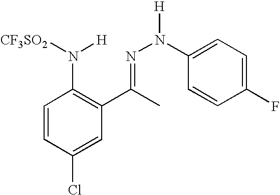 | | |
| 155 | 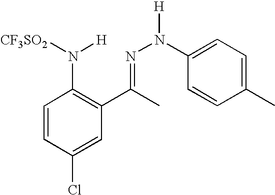 | 195-200 | |
| 156 | 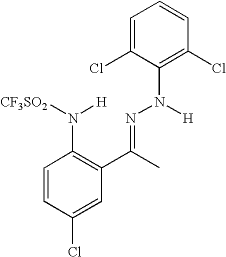 | | |
| 157 | 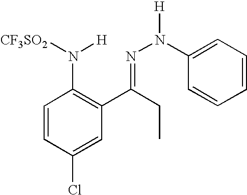 | 128-129 | |
| 158 | 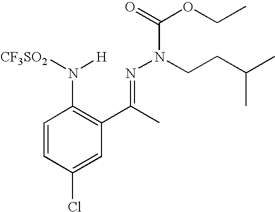 | | Found: 457.1032 Requires: 457.1044 |
| 159 | 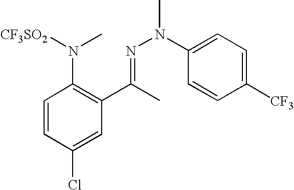 | | |
| 160 | 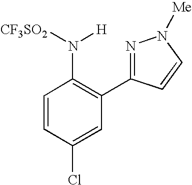 | 196-197 | |
| 161 | 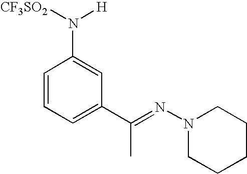 | | |
| 162 | 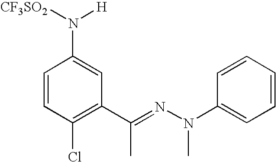 | 198-198.5 | |
| 163 | 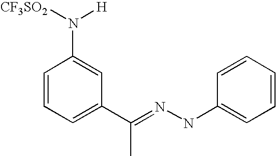 | 94-96.5 | Found: 371.090 Requires: 371.0910 |
| 164 | 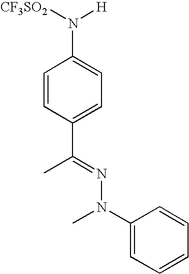 | | Found: 371.0920 Requires: 371.0910 |
| 165 | 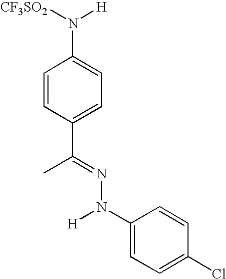 | | Found: 391.0356 Requires: 391.0364 |
| 166 | 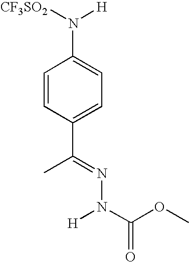 | 192.5-194 | Found: 339.0493 Requires: 339.0495 |
| 167 | 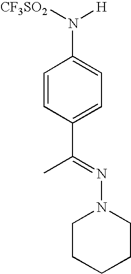 | 168-171 | Found: 349.1068 Requires: 349.1066 |
| 168 | 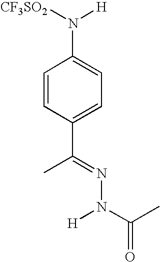 | 177-179 | |
| 169 | 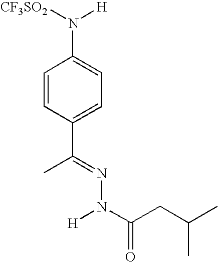 | 133.5-135.5 | |
| 170 | 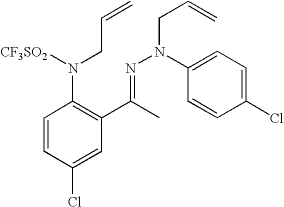 | | |
| 171 | 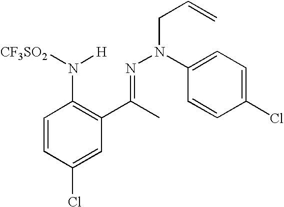 | | |
| 172 | 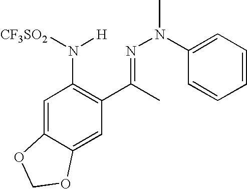 | | |
| 173 | 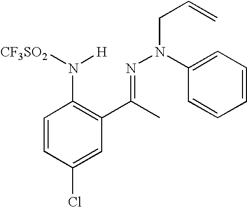 | | |
| 174 | 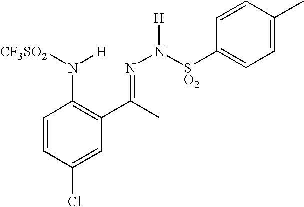 | 196-198 | |
| 175 | 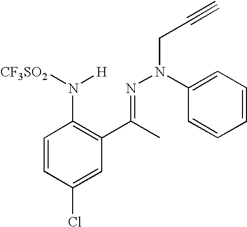 | | |
| 176 | 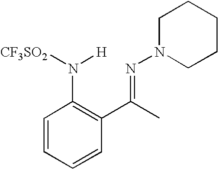 | 118-121 | Found: 349.1062 Requires: 349.1066 |
| 177 | 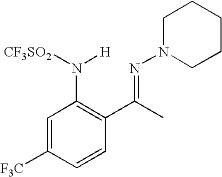 | 116-117.8 | Found: 417.0939 Requires: 417.0940 |
| 178 | 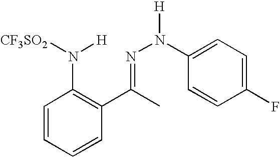 | 154-155.5 | Found: 375.0655 Requires: 375.0659 |
| 179 | 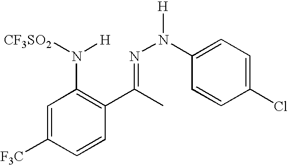 | 176-178 | Found: 459.0235 Requires: 459.0237 |
| 180 | 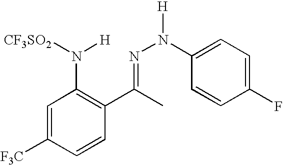 | 196.8-198.8 | Found: 443.0530 Requires: 443.0533 |
| 181 | 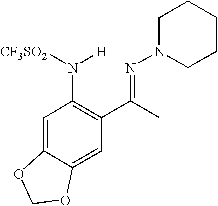 | | |
| 182 | 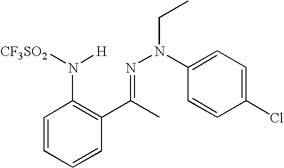 | | Found: 419.0672 Requires: 419.0677 |
| 183 | 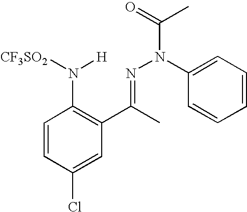 | | Found: 433.0468 Requires: 433.0469 |
| 184 | 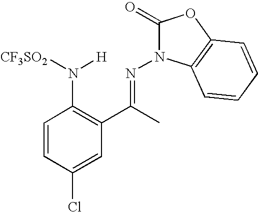 | 133-138 | Found: 433.0105 Requires: 433.0105 |
| 185 | 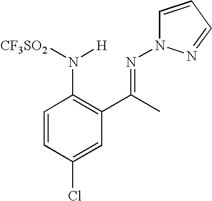 | 64-66 | |
| 186 | 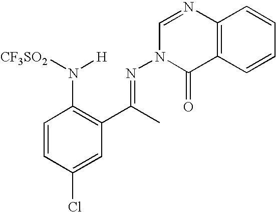 | 159-168 | Found: 444.0270 Requires: 444.0265 |
| 187 | 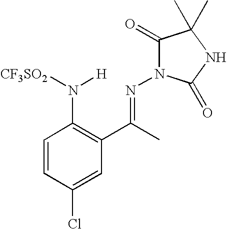 | 213-214 | Found: 426.0364 Requires: 426.0371 |
| 188 | 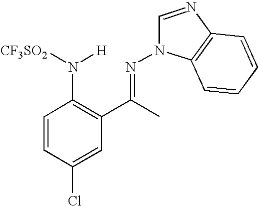 | 195-198 | Found: 416.0309 Requires: 416.0316 |
| 189* | 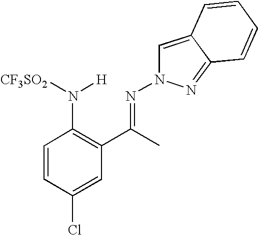 | | Found: 416.0304 Requires: 416.0316 |
| 190 | 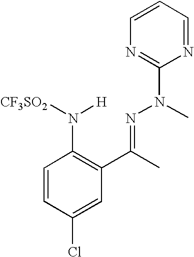 | 115.5-116.5 | Found: 407.0415 Requires: 407.0425 |
| 191 | 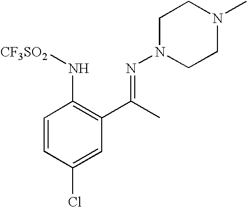 | 185.5-186.3 | |
| 192 | 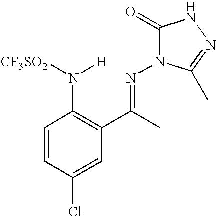 | | Found: 397.0232 Requires: 397.0218 |
| 193 | 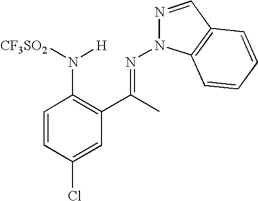 | | Found: 416.0319 Requires: 416.0316 |
| 194 | 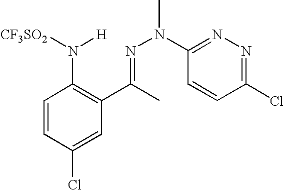 | 142-143 | |
| 195 | 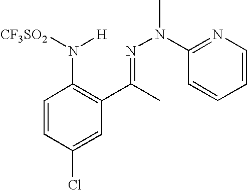 | 181-184 | |
| 196 | 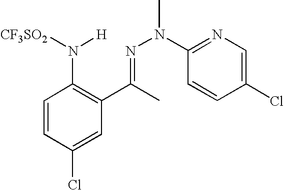 | 115-120 | |
| 197 | 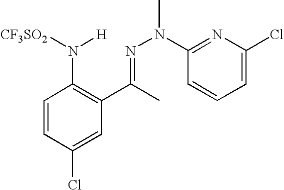 | 98-99 | |
| 198 | 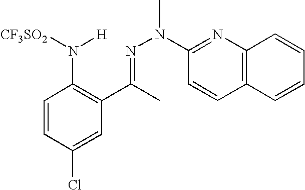 | 180-183 | |
| 199 | 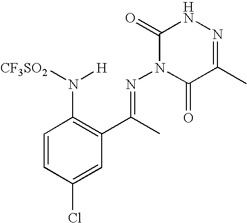 | | |
| 200 | 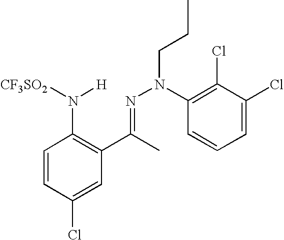 | 82.6-83.2 | |
| 201 | 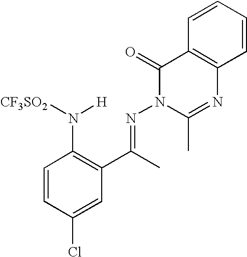 | 179-180 | |
| 202 | 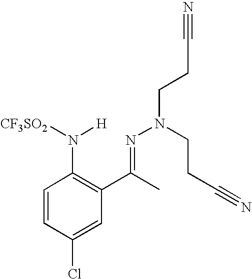 | | |
| 203 | 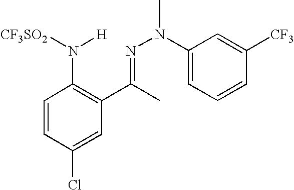 | 89-90 | |
| 204 | 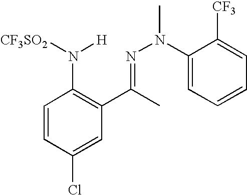 | 115-116 | |
| 205 | 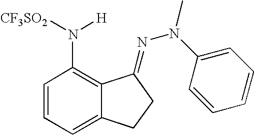 | | |
| 206 | 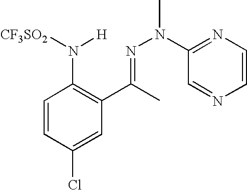 | | Found: 407.0425 Requires: 407.0425 |
| 207 | 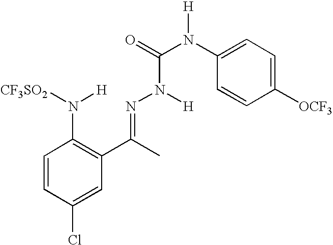 | | Found: 518.0232 Requires: 518.0245 |
| 208 | 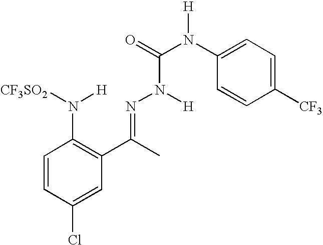 | | Found: 502.0296 Requires: 502.0296 |
| 209 | 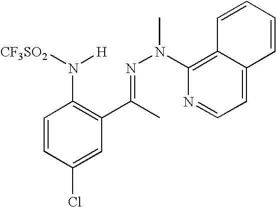 | | Found: 456.0635 Requires: 456.0629 |
| 210 | 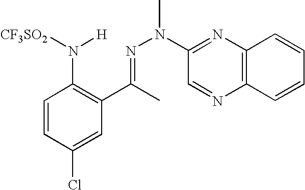 | | Found: 457.0582 Requires: 457.0582 |
| 211 | 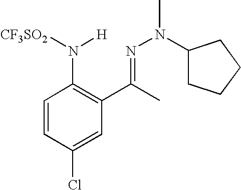 | 89-90 | Found: 397.0836 Requires: 397.0833 |
| 212 | 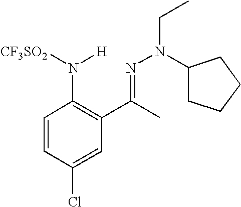 | 113-115 | |
| 213 | 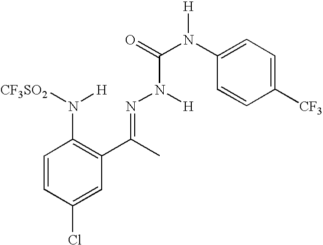 | 114-119 | |
| 214 | 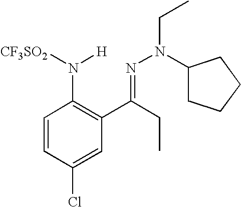 | | |
| 215 | 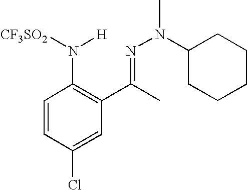 | | Found: 411.0980 Requires: 411.0990 |
| 216 | 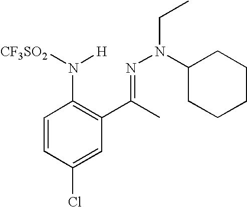 | | |
| 217 | 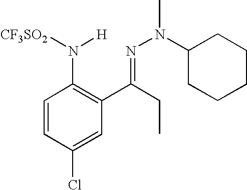 | 105-108 | Found: 425.1133 Requires: 425.1146 |
| 218 | 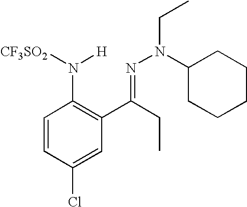 | | |
| 219 | 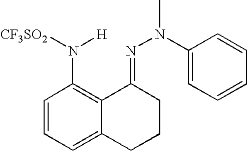 | | Found: 397.1060 Requires: 397.1066 |
| 220 | 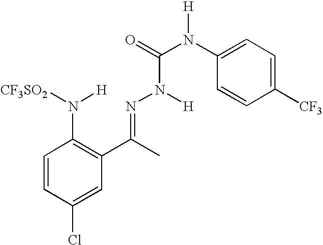 | | Found: 516.0457 Requires: 516.0452 |
| 221 | 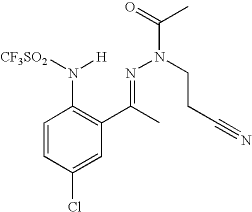 | 119-121 | |
| 222 | 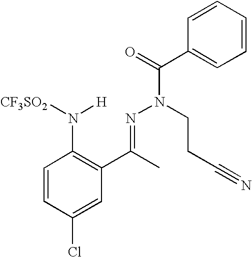 | 146.5-147.5 | |
| 223 | 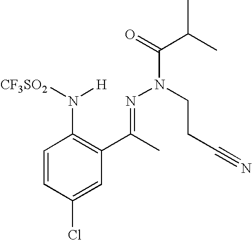 | 74-76 | |
| 224 | 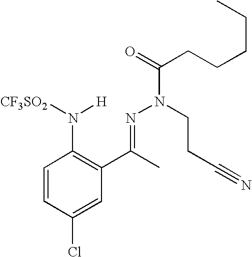 | 127-128.5 | |
| 225 | 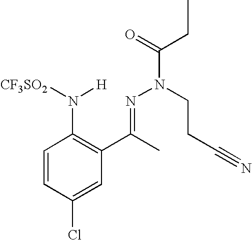 | 78-79.5 | |
| 226 | 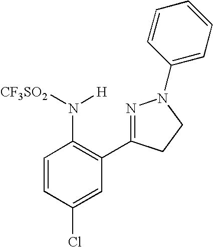 | 121-125 | |
| 227 | 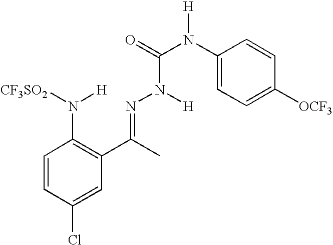 | | Found: 532.0397 Requires: 532.0401 |
| 228 | 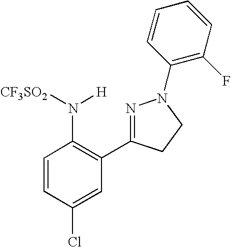 | | |
| 229 | 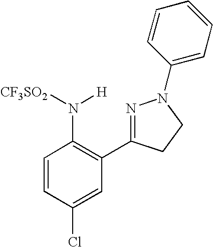 | 138-163 | |
| 230 | 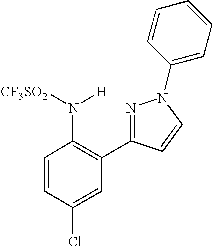 | 119-120 | |
| 231 | 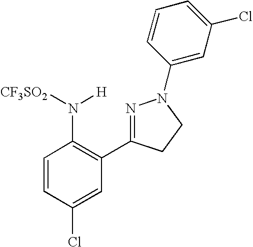 | 151-156 | Found: 436.9948 Requires: 436.99746 |
| 232 | 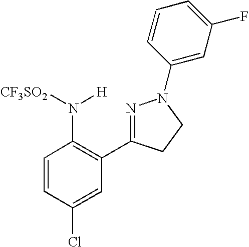 | 151-155 | Found: 421.0256 Requires: 421.0269 |
| 233 | 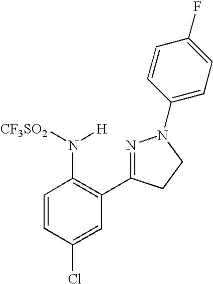 | 175-177 | |
| 234 | 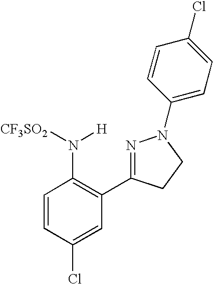 | | |

Note:
every compound in Table 20, above, gave a ¹H NMR spectra consistant with the proposed structure.

### Example 35

The following assays were used to determine the parasiticidal activity of the compounds of the invention. The compounds tested were prepared according to Examples 1-33, above.

a) Haemonchus Contortus Larvacidal Assay:

The effect of compounds on larval development was determined in the assay described by Gill et al., (1995, International Journal of Parasitology 25:463-470). Briefly, in this assay, nematode eggs were applied to the surface of an agar matrix containing the test compound and then allowed to develop through to the L3, infective stage (6 days). The wells for each dilution of every compound (from highest to lowest concentration) were inspected to determine the well number corresponding to the lowest concentration at which development was inhibited in 99% of the nematode larvae present (LD₉₉). Because well numbers correspond to a two-fold serial dilution of each compound, a titre (dilution factor) is generated as 2n⁻¹, where n is the well number. By dividing the highest concentration tested by the titre an LD₉₉ value can be obtained, representing the concentration required to inhibit development in 99% of the nematode larvae present. The compounds supplied as solid and viscous liquids were dissolved in DMSO. Twelve serial one-half dilutions in DMSO solution were prepared from the stock solution, each of which was then diluted ⅕ with water. Aliquots (10 μl) of each dilution were transferred to the bioassay plates to give a final concentration range of 0.024 to 50 μg/ml.

b) Ctenocephalides felis Adulticide Assay: C. felis Single Dose Screen

The purpose of this example was to confirm that sample compounds or formulations exhibit significant insecticidal activity against cat fleas contacted with a treated glass surface. Mortality of fleas was the primary endpoint in the assay. Fleas were considered dead if they didn't move or were on their sides and unable to walk or right themselves. In the screening assay a single concentration of a test compound was selected to demonstrate insecticidal activity. The concentration chosen (1.26 μg/cm²) was higher than that known to kill 90% of cat fleas (LC₉₀) using the reference compound, permethrin.

The test species was the cat flea (Ctenocephalides felis). The strain used was obtained from external suppliers as pupae and held in the laboratory under testing conditions until the adults had emerged. Fifteen (15) fleas were used in a minimum of four replicates against a single concentration level (approximately 60 fleas). The insects were selected to be in the adult life stage, aged between 3 and 7 days post emergence.

The compounds to be tested were supplied as solids and were prepared in acetone as described below prior to testing. Samples were stored in a refrigerator (5±1° C.) unless otherwise specified.

During the mortality testing, the temperature was maintained at 25±1° C. Humidity was maintained at 75±5%. The base (area=159 mm²) of a 100 mL glass Erlenmeyer (conical) flask provided the treatment surface. Flasks were pretreated with Coatasil™ glass treatment to maximise bio-availability of test compounds by preventing them from binding to glass the surface. The base of the 100 mL Erlenmeyer flask was treated with 0.5 mL of test sample in acetone and gently swirled. This volume was sufficient to cover the base of the flask. Flasks were left to dry for 24 hours before flea exposure.

Adult cat fleas were placed into a sorting chamber, which allowed fleas to jump into the Erlenmeyer flasks. Fifteen (15) adult cat fleas were collected in each flask. The top of the flasks were then covered in Parafilm™ and small holes were made to allow gas exchange. A 0.5 mL volume of acetone as a solvent control was applied to the base of an Erlenmeyer flask and the testing proceeded in the same manner described above. Cat fleas in the treatment containers were held under testing conditions for 8, 24 and/or 48 hours. Mortality was recorded at 8, 24, 8 and 24, or 24 and 48 hours Pooled 8, 24, 8 and 24, and 24 and 48 hour mortality data were converted to percentages and are summarized by Table 21, below.

c) Ctenocephalides felis Adulticide Assay: C. felis Dose Response

The purpose of this example was to determine the LC₅₀ when cat fleas were contacted with a glass surface treated with sample compounds or formulations prepared as described above. Mortality of fleas was defined as follows: fleas were considered dead if they did not move or were on their sides and unable to walk or right themselves. LC₅₀: Lethal Concentration 50-concentration of glass surface treatment at which 50% of the cat fleas were killed. The test species was the cat flea (Ctenocephalides felis). The strain used was obtained from external suppliers as pupae and held in the laboratory under testing conditions until the adults had emerged. Fifteen (15) fleas were used in a minimum of four replicates for each dose level (total of 60 fleas per dose level). The insects were selected to be in the adult life stage, aged between 3 and 7 days post emergence.

The compounds to be tested were dissolved in acetone just prior to testing. Samples of compounds were stored in a refrigerator (5±1° C.) unless otherwise specified. During the mortality testing, the temperature was maintained at 25±1° C. Humidity was maintained at 75±5%. The base (area=159 mm²) of a 100 mL glass Erlenmeyer (conical) flask provided the treatment surface. Flasks were pretreated with Coatasil™ glass treatment to maximise bio-availability of test compounds by preventing them from binding to the glass surface.

Six dose levels (concentrations) of test sample, in the form of a serial dilution, were derived from a pilot study and covered a range that produced very low to very high mortality. The base of the 100 mL Erlenmeyer flask was treated with 0.5 mL of test sample in acetone and gently swirled. This volume was sufficient to cover the base of the flask. Flasks were left to dry for 24 hours before flea exposure. Adult cat fleas were lightly anaesthetised by cooling and then placed into a sorting chamber, which allowed fleas to revive and jump into the Erlenmeyer flasks. Fifteen (15) adult cat fleas were collected in each flask. The top of the flasks were then covered in Parafilm™ and small holes made to allow gas exchange. A 0.5 mL volume of acetone was applied to the base of an Erlenmeyer flask and the testing proceeded in the same manner described above. Cat fleas in the treatment containers were held under testing conditions for 24 hours. Mortality resulting from the treatments was recorded at 8 and 24 hours. Pooled 24 hour mortality data were subjected to probit analysis to obtain concentration response data (LC₅₀) (Finney, D. J., 1971. Probit Analysis. 3rd ed. Cambridge Univ. Press, London).

d) Rapid Screening Protocol for Topical Application on Brown Dog Ticks (Rhipicephalus sanguineus)

The aim of the test was to determine the presence of significant acaricidal activity in sample compounds or formulations when applied topically on brown dog ticks. A tick was defined as dead if it gave no apparent response when touched lightly and observed for 1 minute. To assess the experimental compound for acaricidal activity, a single dose level was chosen based on known results from previous experiments with a commercially available active reference compound. Both permethrin and fipronil were employed as reference compounds. The insect species tested was the Brown Dog Tick (Rhipicephalus sanguineus). Mixed sex adult ticks were used for tests. The strain used was cultured by von Berky Veterinary Services, Woody Point, QLD, AU and supplied as unfed adult ticks (mixed sex). Ticks were maintained in controlled conditions (temp. 18°±2° C., humidity 75±5% RH).

Test compounds (formulations or active ingredients) were stored in a refrigerator (5±1° C.) unless otherwise specified. Temperature was maintained at 25±1° C. and the humidity was ambient. The screening dose chosen was higher than that known to kill 90% of insects (LD₉₀) using the reference compound. In the case of topical application of active compounds on adult ticks, the reference compound was fipronil and the dose chosen was 10 μg of active per tick (=10 μg of fipronil/1 μl of acetone). Ticks were each treated on the abdomen with 1 μL of a single dose level of test sample in acetone; ten ticks were treated with solvent only (acetone) in each test. Tests were replicated 4 times (total of 40 ticks treated). Ticks were held in recovery containers maintained under appropriate rearing conditions for 24 hours. Mortality resulting from the treatments was recorded at 24 hours. Pooled 24 hour mortality data were converted to percentages.

e) Dose response protocol for topical application on brown dog ticks (Rhipicephalus sanguineus): The test determines the level of insecticidal activity of sample compounds or formulations when applied topically on brown dog ticks. Sample compounds were stored prior to use in a freezer (−5±1° C.), unless otherwise specified.

Definitions:

Mortality: A tick is defined as dead after it gives no apparent response when touched lightly or gently breathed upon, while observed for 30 seconds.
LD₅₀ (Lethal Dose 50): The dose of a topically applied treatment at which 50% of the dog ticks are killed.
Reference compound: To assess an experimental compound for significant acaricidal activity a single dose level is chosen, which is based upon known results from previous experiments using a commercially available active i.e., a reference compound. The reference compound selected is one in common use, and one that has a similar mode of action against the Brown Dog Tick (i.e., the test species),
Recovery container: A recovery container consists of a 500 ml round plastic container measuring 115 mm diameter and 70 mm height, with a tight fitting lid that has 10 small (˜1 mm) holes inserted for air exchange. A 90 mm diameter piece of filter paper was placed on the bottom of the container and moistened with 1 mL of distilled water.

Adult, mixed sex, Brown Dog Ticks (Rhipicephalus sanguineus) were reared as follows: (i) cultured, (ii) transferred unfed, to a testing laboratory, and (iii) then maintained under controlled conditions (i.e., temp. 18°±2° C., humidity 75±5% RH). The ticks used were selected for vigor prior to testing, i.e., capable of actively walking and responsive to being touched or gently breathed upon.

During the testing, the temperature was maintained at 25±1° C. and the humidity was ambient. Seven dose levels (concentrations) of sample compound, in the form of serial dilutions in acetone, were derived from a pilot study and covered a range that produced very low to very high mortality. Groups of ten ticks were treated topically (on the abdomen) with 1 μL of a single dose level of the sample compound. Each test was replicated four times, i.e., employing a total of 40 ticks per dose level of each sample compound. As a control, ten ticks were treated with solvent only (acetone) for each test. Following the treatment, the ticks were held in recovery containers maintained under appropriate rearing conditions for 24 hours. Mortality resulting from the treatments was recorded at 24 hours. Pooled 24 hour mortality data were subjected to probit analysis to obtain concentration response data (LC₅₀) [see, Finney, D. J., Probit Analysis 3^{rd} ed., Cambridge Univ. Press, London (1971).]

All equipment that was not disposed of was decontaminated by soaking overnight in a 1% (minimum) solution of PYRONEG™ detergent. PYRONEG™ is a pyrogenically negative cleaner containing 60% alkaline salts. Surfaces were lightly scrubbed after soaking and double rinsed before re-use.

In Table 21, provided below, are listed the Haemonchus contortus LD₉₉ values (measured in ppm), the Ctenocephalides felis rapid screening values (measured in % mortality), the Ctenocephalides felis LC₅₀ values (measured in ppm), the Rhipicephalus sanguineus rapid screening values (measured in % mortality) and the Rhipicephalus sanguineus LD₅₀ values (measured in micrograms/tick) for selected compounds in accordance with the present invention. The tabulated data confirm that the inventive compounds have significant antiparasite activity for both endo and ectoparasites, as shown.

TABLE 21

| | C. felis | C. felis | C. felis | | R. sanguineus | | |
|---|---|---|---|---|---|---|---|
| Cpd | Mortality (%) | Mortality (%) | Mortality (%) | C. felis | Mortality (%) | R. sanguineus | H. contortus |
| # | 8 h^{A} | 24 h^{A} | 48 h^{A} | LC₅₀ ppm^{A} | 24 h^{B} | LD₅₀ (μg/tick) | LD₉₉ ppm |
| 1 | | | | | | | 3.8 |
| 2 | | | | | | | 6 |
| 3 | | | | | | | 1.5 |
| 4 | | | | | | | 0.63 |
| 5 | | | | | | | 3.3 |
| 6 | | | | | | | 3.5 |
| 7 | | | | | | | 0.94 |
| 8 | 12^{B} | | | | | | 7.5 |
| 9 | | 100^{B} | | 0.86 | 98, 88^{A} | | |
| 10 | | | | | | | >15 |
| 11 | | | | | | | >15 |
| 12 | 20^{B} | | | | | | |
| 13 | | | | | | | 3 |
| 14 | | | | | | | 3.8 |
| 15 | | | | | | | 3.8 |
| 16 | | | | | | | 2.8 |
| 17 | | | | | | | |
| 18 | 5^{B} | | | | | | 0.47 |
| 19 | | | | | | | 0.94 |
| 20 | 100 | 100 | | 0.86 | 95^{A} | 0.75 | |
| 21 | 100 | 100 | | 0.90 | 78^{A} | 0.64 | |
| 22 | 98 | 100 | | | 33^{A} | | |
| 23 | 100 | 100 | | 2.0 | 95^{A} | 0.99 | |
| 24 | 100 | 100 | | | 28^{A} | | |
| 25 | 100 | 100 | | 1.8 | 75^{A} | 1.2 | |
| 26 | | 100 | 100 | 0.12 | 97 | 5.4 | |
| 27 | | 100 | 100 | 0.23 | 95 | 5.5 | |
| 28 | | 100 | 100 | | 68 | | |
| 29 | | 0 | 58 | | | | |
| 30 | | 100 | 100 | 5.2 | 90 | 8.5 | |
| 31 | | 85 | 100 | | | | |
| 32 | | 41 | 100 | | | | |
| 33 | | 86 | 100 | | 88 | | |
| 34 | | 100 | 100 | 0.97 | 100 | 3.6 | |
| 35 | | 100 | 100 | 4.3 | 100 | 1.5 | |
| 36 | | 100 | 100 | 2.5 | 100 | 1.8 | |
| 37 | | 89 | 100 | | 83 | | |
| 38 | | 100 | 100 | 2.5 | 98 | 3.6 | |
| 39 | | 100 | 100 | 0.14 | 100 | 3.6 | |
| 40 | | 0 | 13 | | | | |
| 41 | | 94 | 100 | 0.44 | 100 | 3.8 | |
| 42 | | 67 | 100 | | | | |
| 43 | | 90 | 100 | 0.35 | 100 | 3.0 | |
| 44 | | 3 | 22 | | 3 | | |
| 45 | | 27 | 100 | | | | |
| 46 | 44 | 100 | | | | | |
| 47 | 14 | 100 | | | 58 | | |
| 48 | 95 | 100 | | 0.64 | 80 | 6.3 | |
| 49 | 100 | 100 | | 0.31 | 100 | 1.6 | |
| 50 | 61 | 100 | | | 68 | | |
| 51 | 100 | 100 | | 0.82 | 100 | 2.6 | |
| 52 | 51 | 100 | | | | | |
| 53 | 71 | 100 | | | 50 | | |
| 54 | 95 | 100 | | 1.6 | 95 | 5.6 | |
| 55 | 100 | 100 | | 2.5 | 100 | 1.7 | |
| 56 | 51 | 99 | | | 45 | | |
| 57 | 6 | 70 | | | | | |
| 58 | 2 | 13 | | | | | |
| 59 | 100 | 100 | | 2.9 | 100 | 1.8 | |
| 60 | 60 | 100 | | 4.1 | 75 | 7.1 | |
| 61 | 12 | 45 | | | | | |
| 62 | 100 | 100 | | 2.2 | 100 | 1.6 | |
| 63 | 100 | 100 | | 2.4 | 100 | | |
| 64 | 1 | 50 | | | | | |
| 65 | 100 | 100 | | | 100 | | |
| 66 | 18 | 100 | | | 48 | | |
| 67 | 20 | 85 | | | | | |
| 68 | 18 | 73 | | | | | |
| 69 | 39 | 92 | | | | | |
| 70 | 95 | 100 | | 1.8 | 100 | 4.1 | |
| 71 | 94 | 100 | | 2.5 | 98 | 4.2 | |
| 72 | 100 | 100 | | 1.5 | 100 | 3.1 | |
| 73 | 96 | 100 | | 2.1 | 88 | 5.3 | |
| 74 | 100 | 100 | | 0.76 | 100 | 2.0 | |
| 75 | 100 | 100 | | 1.4 | 100 | | |
| 76 | 100 | 100 | | 0.42 | 98 | 2.1 | |
| 77 | 91 | 100 | | | 73 | | |
| 78 | 16 | 16 | | | | | |
| 79 | 14 | 92 | | | | | |
| 80 | 17 | 88 | | | | | |
| 81 | 100 | 100 | | 2.2 | 100 | 1.49 | |
| 82 | 98 | 100 | | 2.4 | 100 | 2.0 | |
| 83 | 15 | 17 | | | | | |
| 84 | 9 | 76 | | | | | |
| 85 | 3 | 12 | | | | | |
| 86 | 4 | 26 | | | | | |
| 87 | 7 | 12 | | | | | |
| 88 | 6 | 25 | | | | | |
| 89 | 6 | 43 | | | | | |
| 90 | 3 | 18 | | | | | |
| 91 | 10 | 10 | | | | | |
| 92 | 8 | 8 | | | | | |
| 93 | 5 | 9 | | | | | |
| 94 | 6 | 8 | | | | | |
| 95 | 25 | 83 | | | | | |
| 96 | 19 | 99 | | 2.0 | 78 | 3.0 | |
| 97 | 52 | 100 | | | 73 | | |
| 98 | 19 | 98 | | | 60 | | |
| 99 | 57 | 100 | | 1.9 | 95 | 3.1 | |
| 100 | 55 | 100 | | 1.7 | 70 | 4.0 | |
| 101 | 11 | 90 | | | | | |
| 102 | 3 | 90 | | | | | |
| 103 | 56 | 100 | | | 40 | | |
| 104 | 16 | 100 | | | 75 | | |
| 105 | 42 | 100 | | 3.0 | 95 | 1.4 | |
| 106 | 0 | 25 | | | | | |
| 107 | 2 | 23 | | | | | |
| 108 | 0 | 64 | | | | | |
| 109 | 73 | 100 | | | 8 | | |
| 110 | 6 | 52 | | | | | |
| 111 | 14 | 32 | | | | | |
| 112 | 99 | 100 | | | 5 | | |
| 113 | 3 | 66 | | | | | |
| 114 | 56 | 86 | | | | | |
| 115 | 10 | 63 | | | | | |
| 116 | 98 | 100 | | 2.66 | 93 | 0.74 | |
| 117 | 12 | 59 | | | | | |
| 118 | 6 | 27 | | | | | |
| 119 | 7 | 14 | | | | | |
| 120 | 28 | 83 | | | 58 | | |
| 121 | 12 | 41 | | | | | |
| 122 | 23 | 26 | | | | | |
| 123 | 9 | 45 | | | | | |
| 124 | 59 | 94 | | | 88 | | |
| 125 | 82 | 100 | | 3.62 | 95 | 0.64 | |
| 126 | 55 | 97 | | 1.84 | 100 | 0.69 | |
| 127 | 100 | 100 | | 1.22 | 100 | 0.54 | |
| 128 | 12 | 36 | | | | | |
| 129 | 27 | 98 | | 2.82 | 98 | 0.52 | |
| 130 | 34 | 91 | | 2.36 | 98 | 1.08 | |
| 131 | 43 | 100 | | | 98 | | |
| 132 | | | | | | | |
| 133 | 5 | 66 | | | | | |
| 134 | 7 | 14 | | | | | |
| 135 | 8 | 41 | | | | | |
| 136 | 7 | 13 | | | | | |
| 137 | 6 | 19 | | | | | |
| 138 | 20 | 66 | | | | | |
| 139 | 97 | 100 | | 5.14 | 100 | 0.39 | |
| 140 | 89 | 100 | | 3.70 | 100 | 0.28 | |
| 141 | 13 | 75 | | | | | |
| 142 | 12 | 46 | | | | | |
| 143 | 13 | 53 | | | | | |
| 144 | 7 | 42 | | | | | |
| 145 | 8 | 35 | | | | | |
| 146 | 12 | 24 | | | | | |
| 155 | 7 | 28 | | | | | |
| 158 | 5 | 28 | | | | | |
| 161 | 7 | 16 | | | | | |
| 162 | 8 | 58 | | | | | |
| 163 | 8 | 18 | | | | | |
| 164 | 8 | 72 | | | | | |
| 165 | 6 | 7 | | | | | |
| 166 | 2 | 8 | | | | | |
| 167 | 2 | 5 | | | | | |
| 170 | 2 | 24 | | | | | |
| 171 | 7 | 54 | | | | | |
| 172 | 5 | 31 | | | | | |
| 173 | 17 | 59 | | | | | |
| 174 | 5 | 27 | | | | | |
| 175 | 5 | 38 | | | | | |
| 176 | 7 | 31 | | | | | |
| 177 | 3 | 22 | | | | | |
| 178 | 4 | 29 | | | | | |
| 179 | 3 | 25 | | | | | |
| 180 | 0 | 16 | | | | | |
| 181 | 7 | 16 | | | | | |
| 182 | 5 | 29 | | | | | |
| 183 | 2 | 22 | | | | | |
| 184 | 2 | 12 | | | | | |
| 185 | 2 | 11 | | | | | |
| 186 | 2 | 12 | | | | | |
| 187 | 5 | 19 | | | | | |
| 188 | 2 | 7 | | | | | |
| 189 | 0 | 2 | | | | | |
| 190 | 2 | 15 | | | | | |
| 191 | 2 | 48 | | | | | |
| 192 | 3 | 5 | | | | | |
| 193 | 2 | 9 | | | | | |
| 194 | 0 | 5 | | | | | |
| 195 | 2 | 30 | | | | | |
| 196 | 3 | 32 | | | | | |
| 197 | 7 | 23 | | | | | |
| 198 | 2 | 25 | | | | | |
| 199 | 3 | 3 | | | | | |
| 200 | 2 | 58 | | | | | |
| 201 | 2 | 10 | | | | | |
| 202 | 3 | 24 | | | | | |
| 203 | 11 | 98 | | 1.30 | 95 | 0.68 | |
| 204 | 6 | 11 | | | | | |
| 205 | 12 | 13 | | | | | |
| 206 | 7 | 12 | | | | | |
| 207 | 5 | 8 | | | | | |
| 208 | 8 | 18 | | | | | |
| 209 | 7 | 18 | | | | | |
| 210 | 4 | 17 | | | | | |
| 211 | 12 | 85 | | 1.9 | 98 | 1.01 | |
| 212 | 7 | 59 | | | | | |
| 213 | 5 | 66 | | | | | |
| 214 | 7 | 61 | | | | | |
| 215 | 8 | 100 | | 2.54 | 73 | 1.29 | |
| 216 | 0 | 52 | | | | | |
| 217 | 3 | 48 | | | | | |
| 218 | 5 | 62 | | | | | |
| 219 | 0 | 2 | | | | | |
| 220 | 0 | 0 | | | | | |
| 221 | 15 | 100 | | 2.2 | 90 | 0.53 | |
| 222 | 5 | 89 | | 2.64 | 88 | 0.56 | |
| 223 | 45 | 100 | | | 100 | | |
| 224 | 3 | 100 | | 3.54 | 100 | 0.71 | |
| 225 | 2 | 73 | | | | | |
| 226 | 0 | 28 | | | | | |
| 227 | 4 | 0 | | | | | |
| 228 | 14 | 59 | | | | | |
| 229 | 18 | 37 | | | | | |
| 230 | 10 | 43 | | | | | |
| 231 | 12 | 42 | | | | | |
| 232 | 7 | 27 | | | | | |
| 233 | 9 | 28 | | | | | |
| 234 | 14 | 41 | | | | | |

^{A}Data from laboratory 1;
^{B}Data from laboratory 2

### CONCLUSION

A substantial number of the tested compounds exhibited effective killing of most or all of the test organisms.

While the present invention has been described in conjunction with the specific embodiments set forth above, many alternatives, modifications and variations thereof will be apparent to those of ordinary skill in the art. All such alternatives, modifications and variations are intended to fall within the spirit and scope of the present invention.

Numerous references are mentioned herein, all of which are hereby incorporated by reference in their entireties.

We claim:

1. A N-phenyl-1,1,1-trifluoromethanesulfonamide compound selected from the group consisting of 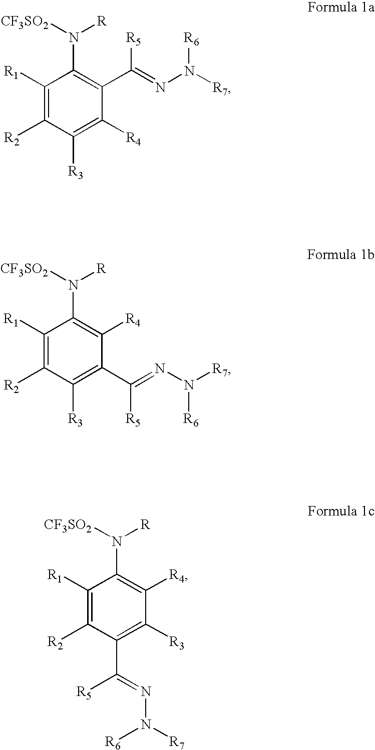
and combinations thereof, or a pharmaceutically acceptable salt thereof or a solvate thereof, wherein,
R for Formulas 1a, 1b and 1c is independently selected from the group consisting of hydrogen, alkyl, alkenyl, alkynyl, arylalkyl, cycloalkylalkyl, heterocyclylalkyl, heteroarylalkyl, hydroxyalkyl, alkoxyalkyl, aryloxyalkyl, cyanoalkyl, alkylcarbonylalkyl, cycloalkylcarbonylalkyl, arylcarbonylalkyl, heterocyclylcarbonylalkyl, heteroarylcarbonylalkyl, alkoxycarbonylalkyl, alkylaminocarbonylalkyl, trialkylsilylalkyl, trialkoxysilylalkyl, dialkoxyphosphonatoalkyl, heterocyclyloxyalkyl, heteroaryloxyalkyl, alkylcarbonyloxyalkyl, arylcarbonyloxyalkyl, heterocyclylcarbonyloxyalkyl, heteroarylcarbonyloxyalkyl, alkoxycarbonyloxyalkyl, aryloxycarbonyloxyalkyl, heterocyclyloxycarbonyloxyalkyl, heteroaryloxycarbonyloxyalkyl, alkylaminocarbonyloxyalkyl, arylaminocarbonyloxyalkyl, heterocyclylaminocarbonyloxyalkyl, heteroarylaminocarbonyloxyalkyl, alkylcarbonylaminoalkyl, arylcarbonylaminoalkyl, heterocyclycarbonylaminoalkyl, heteroarylcarbonylaminoalkyl, alkylsulfonylalkyl, arylsulfonylalkyl, heterocyclylsulfonylalkyl, heteroarylsulfonylalkyl, alkanoyl, aroyl, heterocycloyl, heteroaroyl, alkoxycarbonyl, aryloxycarbonyl, heterocyclyloxycarbonyl, heteroaryloxycarbonyl, N-alkyl carbamoyl, N-aryl carbamoyl, N-heterocyclyl carbamoyl, N-heteroaryl carbamoyl, N-alkyl thiocarbamoyl, N-aryl thiocarbamoyl, N-heterocyclyl thiocarbamoyl, N-heteroaryl thiocarbamoyl, alkylsulfonyl, arylsulfonyl, heterocyclylsulfonyl and heteroarylsulfonyl; and wherein,
R₁-R₄ are independently selected from the group consisting of hydrogen, cyano, nitro, halo and the following optionally substituted moieties: alkyl, cycloalkyl, aryl, heterocyclyl, heteroaryl, alkoxy, cycloalkoxy, aryloxy, heteroaryloxy, heterocyclyloxy, haloalkyl, and haloalkoxy; and wherein,
R₅ is selected from the group consisting of hydrogen, halogen, cyano and the following optionally substituted moieties: alkyl, alkenyl, alkynyl, cycloalkyl, cycloalkenyl, cycloalkylalkyl, cycloalkenylalkyl, aryl, heteroaryl, arylalkyl, heterocyclyl, haloalkyl, haloalkenyl and haloalkynyl, with the proviso that, when the compound is according to Formula 1a, the heteroaryl substitutent is not 4,6-dimethoxypyrimidin-2-yl; and wherein,
R₆ and R₇ are independently selected from hydrogen and the following optionally substituted moieties: alkyl, q-alkenyl, alkynyl, cycloalkyl, cycloalkenyl, cycloalkylalkyl, cycloalkenylalkyl, aryl, arylalkyl, arylalkenyl, heterocyclyl, heterocyclylalkyl, heteroaryl, heteroarylalkyl, heteroarylalkenyl, alkanoyl, aroyl, heterocycloyl, heteroaroyl, cyanoalkyl, alkoxyalkyl, cycloalkoxyalkyl, aryloxyalkyl, alkylthioalkyl, cycloalkylthioalkyl, arylthioalkyl, alkylsulfinylalkyl, cycloalkylsulfinylalkyl, arylsulfinylalkyl, alkylsulfonylalkyl, cycloalkylsulfonylalkyl, arylsulfonylalkyl, haloalkyl, haloalkenyl, haloalkynyl, alkanoyl, aroyl, heterocycloyl, heteroaroyl, alkoxycarbonyl, aryloxycarbonyl, heterocyclyloxycarbonyl, heteroaryloxycarbonyl, N-alkyl carbamoyl, N-aryl carbamoyl, N-heterocyclyl carbamoyl, N-heteroaryl carbamoyl, N-alkyl thiocarbamoyl, N-aryl thiocarbamoyl, N-heterocyclyl thiocarbamoyl, N-heteroaryl thiocarbamoyl, alkylsulfonyl, arylsulfonyl, heterocyclylsulfonyl and heteroarylsulfonyl, with the proviso that, when at least one of R₆ and R₇ is q-alkenyl, that q is an integer greater than 1.

2. A N-phenyl-1,1,1-trifluoromethanesulfonamide compound of Formula 1a of claim 1 wherein, R is selected from the group consisting of hydrogen and the following optionally substituted moieties: alkyl, alkenyl, alkynyl, arylalkyl, cycloalkylalkyl, heterocyclylalkyl, heteroarylalkyl, hydroxyalkyl, alkoxyalkyl, aryloxyalkyl, cyanoalkyl, alkylcarbonylalkyl, cycloalkylcarbonylalkyl, arylcarbonylalkyl, heterocyclylcarbonylalkyl, heteroarylcarbonylalkyl, alkoxycarbonylalkyl;
R₁, R₂ and R₄ are hydrogen;
R₃ is chlorine or hydrogen;
R₅ is methyl;
R₆ is alkyl;
R₇ is 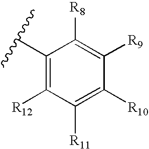
wherein R₈-R₁₂ are independently selected from the group consisting of following: hydrogen, cyano, halo and the following optionally substituted moieties: alkyl, cycloalkyl, aryl, heterocyclyl, heteroaryl, alkoxy, cycloalkoxy, aryloxy, heteroaryloxy, heterocyclyloxy, haloalkyl, and haloalkoxy.

3. A N-phenyl-1,1,1-trifluoromethanesulfonamide compound of Formula 1a, Formula 1b or Formula 1c of claim 1 wherein R₅ and R₆ together are part of the same fused heterocyclic or heteroaryl ring, that is substituted or unsubstituted, with the proviso that the heterocyclic or heteroaryl ring is not any of the following substituents: a heterocyclic or heteroaryl substituent consisting of 4H-1,2,4-triazol-2-yl, 3,5(2H,4H)-dioxo-1,2,4-triazin-6-yl, 5(4H)-oxo-3(2H)-thioxo-1,2,4-triazin-6-yl, 4-halo-1H-pyrazol-3-yl and 4-halo-2H-pyrazol-3-yl.

4. A N-phenyl-1,1,1-trifluoromethanesulfonamide compound selected from the group consisting of 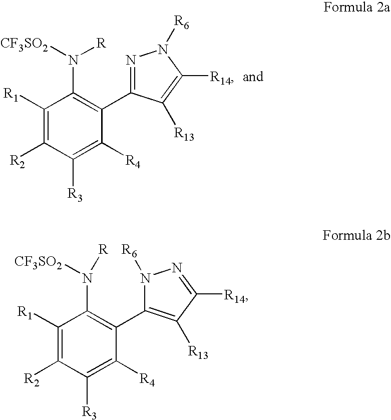
wherein R for Formulas 2a and 2b is independently selected from the group consisting of hydrogen, alkyl, alkenyl, alkynyl, arylalkyl, cycloalkylalkyl, heterocyclylalkyl, heteroarylalkyl, hydroxyalkyl, alkoxyalkyl, aryloxyalkyl, cyanoalkyl, alkylcarbonylalkyl, cycloalkylcarbonylalkyl, arylcarbonylalkyl, heterocyclylcarbonylalkyl, heteroarylcarbonylalkyl, alkoxycarbonylalkyl, alkylaminocarbonylalkyl, trialkylsilylalkyl, trialkoxysilylalkyl, dialkoxyphosphonatoalkyl, heterocyclyloxyalkyl, heteroaryloxyalkyl, alkylcarbonyloxyalkyl, arylcarbonyloxyalkyl, heterocyclylcarbonyloxyalkyl, heteroarylcarbonyloxyalkyl, alkoxycarbonyloxyalkyl, aryloxycarbonyloxyalkyl, heterocyclyloxycarbonyloxyalkyl, heteroaryloxycarbonyloxyalkyl, alkylaminocarbonyloxyalkyl, arylaminocarbonyloxyalkyl, heterocyclylaminocarbonyloxyalkyl, heteroarylaminocarbonyloxyalkyl, alkylcarbonylaminoalkyl, arylcarbonylaminoalkyl, heterocyclycarbonylaminoalkyl, heteroarylcarbonylaminoalkyl, alkylsulfonylalkyl, arylsulfonylalkyl, heterocyclylsulfonylalkyl, heteroarylsulfonylalkyl, alkanoyl, aroyl, heterocycloyl, heteroaroyl, alkoxycarbonyl, aryloxycarbonyl, heterocyclyloxycarbonyl, heteroaryloxycarbonyl, N-alkyl carbamoyl, N-aryl carbamoyl, N-heterocyclyl carbamoyl, N-heteroaryl carbamoyl, N-alkyl thiocarbamoyl, N-aryl thiocarbamoyl, N-heterocyclyl thiocarbamoyl, N-heteroaryl thiocarbamoyl, alkylsulfonyl, arylsulfonyl, heterocyclylsulfonyl and heteroarylsulfonyl; and wherein,
R₁-R₄ are independently selected from the group consisting of hydrogen, cyano, nitro, halo and the following optionally substituted moieties: alkyl, cycloalkyl, aryl, heterocyclyl, heteroaryl, alkoxy, cycloalkoxy, aryloxy, heteroaryloxy, heterocyclyloxy, haloalkyl, and haloalkoxy; and wherein,
R₆ is selected from hydrogen and the following optionally substituted moieties: alkyl, q-alkenyl, alkynyl, cycloalkyl, cycloalkenyl, cycloalkylalkyl, cycloalkenylalkyl, aryl, arylalkyl, arylalkenyl, heterocyclyl, heterocyclylalkyl, heteroaryl, heteroarylalkyl, heteroarylalkenyl, alkanoyl, aroyl, heterocycloyl, heteroaroyl, cyanoalkyl, alkoxyalkyl, cycloalkoxyalkyl, aryloxyalkyl, alkylthioalkyl, cycloalkylthioalkyl, arylthioalkyl, alkylsulfinylalkyl, cycloalkylsulfinylalkyl, arylsulfinylalkyl, alkylsulfonylalkyl, cycloalkylsulfonylalkyl, arylsulfonylalkyl, haloalkyl, haloalkenyl, haloalkynyl, alkanoyl, aroyl, heterocycloyl, heteroaroyl, alkoxycarbonyl, aryloxycarbonyl, heterocyclyloxycarbonyl, heteroaryloxycarbonyl, N-alkyl carbamoyl, N-aryl carbamoyl, N-heterocyclyl carbamoyl, N-heteroaryl carbamoyl, N-alkyl thiocarbamoyl, N-aryl thiocarbamoyl, N-heterocyclyl thiocarbamoyl, N-heteroaryl thiocarbamoyl, alkylsulfonyl, arylsulfonyl, heterocyclylsulfonyl and heteroarylsulfonyl;
and R₁₃ and R₁₄ are independently selected from the group consisting of following: hydrogen, formyl, carboxyl, cyano, hydroxy, amino, nitro, thiol, halo and the following optionally substituted moieties: alkyl, alkenyl, alkynyl, cycloalkyl, cycloalkenyl, aryl, heterocyclyl heteroaryl, alkanoyl, aroyl, heterocycloyl, heteroaroyl, alkoxycarbonyl, aryloxycarbonyl, heterocyclyloxycarbonyl, heteroaryloxycarbonyl, alkylaminocarbonyl, arylaminocarbonyl, heterocyclylaminocarbonyl, heteroarylaminocarbonyl, alkoxy, alkenyloxy, cycloalkoxy, cycloalkenyloxy, alkoxyalkoxy, aryloxy, heterocyclyloxy, alkanoate, aryloate, heterocyclyloate, heteroaryloate, alkylsulfonate, arylsulfonate, heterocyclylsulfonate, heteroarylsulfonate, alkylamino, alkenylamino, arylamino, heterocyclylamino, heteroarylamino, alkylcarbonylamino, arylcarbonylamino, heterocyclylcarbonylamino, heteroarylcarbonylamino, alkylthio, alkenylthio, cycloalkylthio, cycloalkenylthio, arylthio, heterocyclylthio, heteroarylthio, alkylsulfinyl, alkenylsulfinyl, cycloalkylsulfinyl, cycloalkenylsulfinyl, arylsulfinyl, heterocyclylsulfinyl, heteroarylsulfinyl, alkylsulfonyl, alkenylsulfonyl, cycloalkylsulfonyl, cycloalkenylsulfonyl, arylsulfonyl, heterocyclylsulfonyl, heteroarylsulfonyl haloalkyl, haloalkenyl, haloalkynyl, haloalkoxy, haloalkenyloxy, haloalkylsulfonate haloalkylcarbonylamino, haloalkylthio, haloalkylsulfinyl, and haloalkylsulfonyl.

5. A N-phenyl-1,1,1-trifluoromethanesulfonamide compound of claim 1 wherein R₆ and R₇ together are part of the same heterocyclic ring that is substituted or unsubstituted.

6. A N-phenyl-1,1,1-trifluoromethanesulfonamide compound of claim 5 selected from the group consisting of 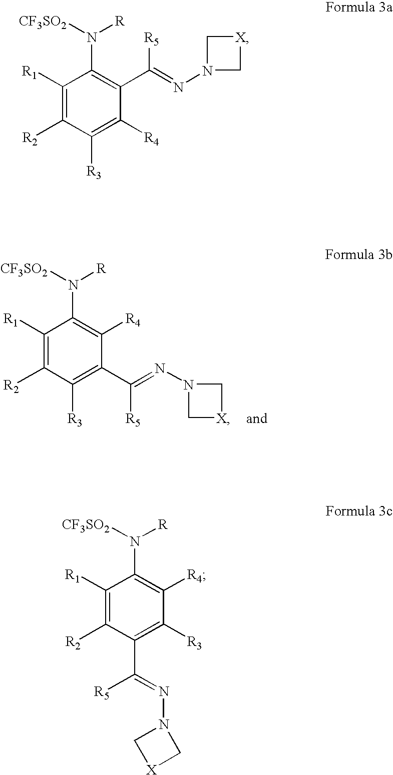
Wherein:
R for Formulas 3a, 3b and 3c is independently selected from the group consisting of hydrogen, alkyl, alkenyl, alkynyl, arylalkyl, cycloalkylalkyl, heterocyclylalkyl, heteroarylalkyl, hydroxyalkyl, alkoxyalkyl, aryloxyalkyl, cyanoalkyl, alkylcarbonylalkyl, cycloalkylcarbonylalkyl, arylcarbonylalkyl, heterocyclylcarbonylalkyl, heteroarylcarbonylalkyl, alkoxycarbonylalkyl, alkylaminocarbonylalkyl, trialkylsilylakyl, trialkoxysilylalkyl, dialkoxyphosphonatoalkyl, heterocyclyloxyalkyl, heteroaryloxyalkyl, alkylcarbonyloxyalkyl, arylcarbonyloxyalkyl, heterocyclylcarbonyloxyalkyl, heteroarylcarbonyloxyalkyl, alkoxycarbonyloxyalkyl, aryloxycarbonyloxyalkyl, heterocyclyloxycarbonyloxyalkyl, heteroaryloxycarbonyloxyalkyl, alkylaminocarbonyloxyalkyl, arylaminocarbonyloxyalkyl, heterocyclylaminocarbonyloxyalkyl, heteroarylaminocarbonyloxyalkyl, alkylcarbonylaminoalkyl, arylcarbonylaminoalkyl, heterocyclycarbonylaminoalkyl, heteroarylcarbonylaminoalkyl, alkylsulfonylalkyl, arylsulfonylalkyl, heterocyclylsulfonylalkyl, heteroarylsulfonylalkyl, alkanoyl, aroyl, heterocycloyl, heteroaroyl, alkoxycarbonyl, aryloxycarbonyl, heterocyclyloxycarbonyl, heteroaryloxycarbonyl, N-alkyl carbamoyl, N-aryl carbamoyl, N-heterocyclyl carbamoyl, N-heteroaryl carbamoyl, N-alkyl thiocarbamoyl, N-aryl thiocarbamoyl, N-heterocyclyl thiocarbamoyl, N-heteroaryl thiocarbamoyl, alkylsulfonyl, arylsulfonyl, heterocyclylsulfonyl and heteroarylsulfonyl; and wherein,
R₁-R₄ are independently selected from the group consisting of hydrogen, cyano, nitro, halo and the following optionally substituted moieties: alkyl, cycloalkyl, aryl, heterocyclyl, heteroaryl, alkoxy, cycloalkoxy, aryloxy, heteroaryloxy, heterocyclyloxy, haloalkyl, and haloalkoxy; and wherein,
R₅ is selected from the group consisting of hydrogen, halogen, cyano and the following optionally substituted moieties: alkyl, alkenyl, alkynyl, cycloalkyl, cycloalkenyl, cycloalkylalkyl, cycloalkenylalkyl, aryl, heteroaryl, arylalkyl, heterocyclyl, haloalkyl, haloalkenyl and haloalkynyl, with the proviso that, when the compound is according to Formula 1a, the heteroaryl substitutent is not 4,6-dimethoxypyrimidin-2-yl; and wherein,
X is selected from the group consisting of CH₂CH₂, CH₂CH₂CH₂, CH₂OCH₂ and CH₂CH₂CH₂CH₂.

7. A N-phenyl-1,1,1-trifluoromethanesulfonamide compound of claim 5 selected from the group consisting of 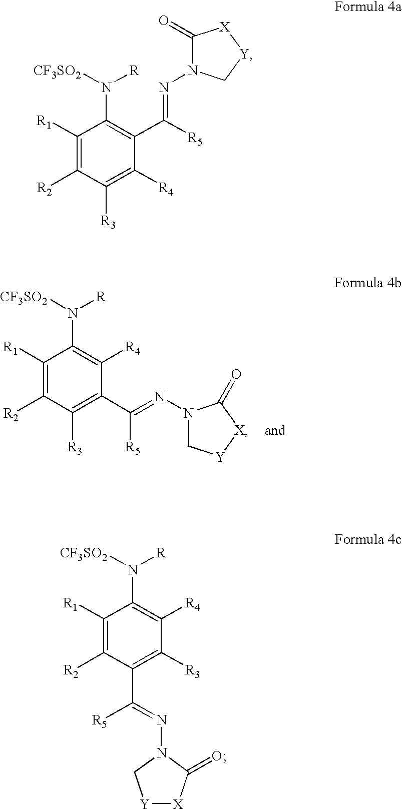
and wherein,
R for Formulas 4a, 4b and 4c is independently selected from the group consisting of hydrogen, alkyl, alkenyl, alkynyl, arylalkyl, cycloalkylalkyl, heterocyclylalkyl, heteroarylalkyl, hydroxyalkyl, alkoxyalkyl, aryloxyalkyl, cyanoalkyl, alkylcarbonylalkyl, cycloalkylcarbonylalkyl, arylcarbonylalkyl, heterocyclylcarbonylalkyl, heteroarylcarbonylalkyl, alkoxycarbonylalkyl, alkylaminocarbonylalkyl, trialkylsilylalkyl, trialkoxysilylalkyl, dialkoxyphosphonatoalkyl, heterocyclyloxyalkyl, heteroaryloxyalkyl, alkylcarbonyloxyalkyl, arylcarbonyloxyalkyl, heterocyclylcarbonyloxyalkyl, heteroarylcarbonyloxyalkyl, alkoxycarbonyloxyalkyl, aryloxycarbonyloxyalkyl, heterocyclyloxycarbonyloxyalkyl, heteroaryloxycarbonyloxyalkyl, alkylaminocarbonyloxyalkyl, arylaminocarbonyloxyalkyl, heterocyclylaminocarbonyloxyalkyl, heteroarylaminocarbonyloxyalkyl, alkylcarbonylaminoalkyl, arylcarbonylaminoalkyl, heterocyclycarbonylaminoalkyl, heteroarylcarbonylaminoalkyl, alkylsulfonylalkyl, arylsulfonylalkyl, heterocyclylsulfonylalkyl, heteroarylsulfonylalkyl, alkanoyl, aroyl, heterocycloyl, heteroaroyl, alkoxycarbonyl, aryloxycarbonyl, heterocyclyloxycarbonyl, heteroaryloxycarbonyl, N-alkyl carbamoyl, N-aryl carbamoyl, N-heterocyclyl carbamoyl, N-heteroaryl carbamoyl, N-alkyl thiocarbamoyl, N-aryl thiocarbamoyl, N-heterocyclyl thiocarbamoyl, N-heteroaryl thiocarbamoyl, alkylsulfonyl, arylsulfonyl, heterocyclylsulfonyl and heteroarylsulfonyl; and wherein,
R₁-R₄ are independently selected from the group consisting of hydrogen, cyano, nitro, halo and the following optionally substituted moieties: alkyl, cycloalkyl, aryl, heterocyclyl, heteroaryl, alkoxy, cycloalkoxy, aryloxy, heteroaryloxy, heterocyclyloxy, haloalkyl, and haloalkoxy; and wherein,
R₅ is selected from the group consisting of hydrogen, halogen, cyano and the following optionally substituted moieties: alkyl, alkenyl, alkynyl, cycloalkyl, cycloalkenyl, cycloalkylalkyl, cycloalkenylalkyl, aryl, heteroaryl, arylalkyl, heterocyclyl, haloalkyl, haloalkenyl and haloalkynyl, with the proviso that, when the compound is according to Formula 1a, the heteroaryl substitutent is not 4,6-dimethoxypyrimidin-2-yl; and wherein,
X is chosen from the group consisting of oxygen, NR₁₅, CH₂, and C═O;
Y is chosen from the group consisting of CH₂, CH₂CH₂ and C═O; and
R₁₅ selected from the group consisting of following: hydrogen, and the following optionally substituted moieties: alkyl, alkenyl, alkynyl, cycloalkyl, cycloalkenyl, aryl, heterocyclyl, and heteroaryl.

8. The N-phenyl-1,1,1-trifluoromethanesulfonamide compound of claim 1 that is selected from the compounds 1 through 234 as identified by Table 20.

9. A pharmaceutical composition for treatment of animals infected with parasites that comprises a therapeutically effective dosage amount of the N-phenyl-1,1,1-trifluoromethanesulfonamide compound of claim 1, and a pharmaceutically acceptable excipient.

10. The pharmaceutical composition of claim 9 wherein the N-phenyl-1,1,1-trifluoromethanesulfonamide compound is selected from the compounds 1 through 234 as identified by Table 20, and combinations thereof.

11. A pharmaceutical composition for treatment of animals infected with parasites that comprises a therapeutically effective dosage amount of the N-phenyl-1,1,1-trifluoromethanesulfonamide compound of claim 2, and a pharmaceutically acceptable excipient.

12. A pharmaceutical composition for treatment of animals infected with parasites that comprises a therapeutically effective dosage amount of the compound of claim 4 and a pharmaceutically acceptable excipient.

13. A pharmaceutical composition for treatment of animals infected with parasites that comprises a therapeutically effective dosage amount of the N-phenyl-1,1,1-trifluoromethanesulfonamide compound of claim 6, and a pharmaceutically acceptable excipient.

14. A pharmaceutical composition for treatment of animals infected with parasites that comprises a therapeutically effective dosage amount of the N-phenyl-1,1,1-trifluoromethanesulfonamide compound of claim 7, and a pharmaceutically acceptable excipient.

15. A method of treating or protecting an animal from a parasite infestation, comprising administering to an animal an effective amount of the N-phenyl-1,1,1-trifluoromethanesulfonamide compound of claim 1.

16. A method of treating or protecting an animal from a parasite infestation, comprising administering to an animal an effective amount of the N-phenyl-1,1,1-trifluoromethanesulfonamide compound of claim 2.

17. A method of treating or protecting an animal from a parasite infestation, comprising administering to an animal an effective amount of the compound of claim 4.

18. A method of treating or protecting an animal from a parasite infestation, comprising administering to an animal an effective amount of the N-phenyl-1,1,1-trifluoromethanesulfonamide compound of claim 6.

19. A method of treating or protecting an animal from a parasite infestation, comprising administering to an animal an effective amount of the N-phenyl-1,1,1-trifluoromethanesulfonamide compound of claim 7.

20. The method of claim 15 wherein the parasite is selected from the group consisting of an arthropod, a helminth, a cestode, a trematode and a protozoan, and the animal is selected from the group consisting of a mammal, an avian, a reptile, an amphibian, a fish, and a crustacean.

21. The method of claim 16 wherein the parasite is selected from the group consisting of an arthropod, a helminth, a cestode, a trematode and a protozoan, and the animal is selected from the group consisting of a mammal, an avian, a reptile, an amphibian, a fish, and a crustacean.

22. The method of claim 17 wherein the parasite is selected from the group consisting of an arthropod, a helminth, a cestode, a trematode and a protozoan, and the animal is selected from the group consisting of a mammal, an avian, a reptile, an amphibian, a fish, and a crustacean.

23. The method of claim 18 wherein the parasite is selected from the group consisting of an arthropod, a helminth, a cestode, a trematode and a protozoan, and the animal is selected from the group consisting of a mammal, an avian, a reptile, an amphibian, a fish, and a crustacean.

24. The method of claim 19 wherein the parasite is selected from the group consisting of an arthropod, a helminth, a cestode, a trematode and a protozoan, and the animal is selected from the group consisting of a mammal, an avian, a reptile, an amphibian, a fish, and a crustacean.

25. A method of killing or inhibiting the growth of an arthropod or helminth comprising contacting the arthropod or helminth with an effective amount of the compound of claim 1.

26. A method of killing or inhibiting the growth of an arthropod or helminth comprising contacting the arthropod or helminth with an effective amount of the compound of claim 2.

27. A method of killing or inhibiting the growth of an arthropod or helminth comprising contacting the arthropod or helminth with an effective amount of the compound of claim 4.

28. A method of killing or inhibiting the growth of an arthropod or helminth comprising contacting the arthropod or helminth with an effective amount of the compound of claim 6.

29. A method of killing or inhibiting the growth of an arthropod or helminth comprising contacting the arthropod or helminth with an effective amount of the compound of claim 7.

30. The pharmaceutical composition of claim 9 that further comprises an additional active agent.

31. The pharmaceutical composition of claim 30 wherein the additional agent is a parasiticide selected from the group consisting of a cyclodiene, KT-199, an avermectin, a benzimidazole, a salicylanilide, a substituted phenol, a pyrimidine, an imidazothiazole, a praziquantel, an organic phosphate, and a combination thereof.

32. The pharmaceutical composition of claim 30 wherein the additional agent is an antibiotic.

33. The pharmaceutical composition of claim 30 wherein the additional agent is an animal nutritional supplement.

34. The pharmaceutical composition of claim 30 wherein the additional agent is a plant nutritional supplement.

35. The pharmaceutical composition of claim 30 wherein the additional agent is a herbicide.

36. A method of treating or protecting a plant from a parasite infestation, comprising administering an effective amount of the N-phenyl-1,1,1-trifluoromethanesulfonamide compound of claim 1.

37. The method of claim 36 wherein the plant is selected from the group consisting of crops for producing fruits, vegetables, grains, non-grain grasses, flowers, orchids, trees, hedges, and other protective or ornamental plants.
